(19) United States
(12) Patent Application Publication
(10) Pub. No.: US 2014/0236753 A1
(43) Pub. Date: Aug. 21, 2014

(54) NEIGHBORHOOD COMMERCE IN A GEO-SPATIAL ENVIRONMENT

(71) Applicant: Raj Abhyanker, Cupertino, CA (US)

(72) Inventor: Raj Abhyanker, Cupertino, CA (US)

(21) Appl. No.: 14/260,308

(22) Filed: Apr. 24, 2014

Related U.S. Application Data
(63) Continuation-in-part of application No. 11/603,442, filed on Nov. 22, 2006, now abandoned.
Application No. 11/603,442 is a continuation-in-part of application No. 11/709,575, filed on Feb. 21, 2007, now abandoned.
Application No. 11/709,575 is a continuation-in-part of application No. 14/089,779, filed on Nov. 26, 2013.
Application No. 14/089,779 is a continuation-in-part of application No. 14/144,612, filed on Dec. 31, 2013, now Pat. No. 8,738,545.

(51) Int. Cl. G06Q 30/06; G06Q 30/08; G06Q 30/02; G06Q 10/08

(52) U.S. Cl. CPC G06Q 30/0639; G06Q 10/087; G06Q 30/08; G06Q 30/0259
USPC 705/26.3; 705/28; 705/14.57; 705/26.9

(57) ABSTRACT

A method of neighborhood commerce in a geo-spatial environment is disclosed. In one embodiment method includes associating a verified registered user with a user profile in a constrained online neighborhood community network that verifies all addresses of users, permitting the verified registered user to mark their profile as private, associating the user profile with a specific geographic location, marking a status of specific ones of the item data as being at least one of an on-sale status, a for-loan status, a free status, a donation status and a not-for-sale status based on responses of the user in populating an inventory database, and publishing the inventory database based on a request of the user during a duration of a specific day and time when an inventory is marketable.

### CLAIMS OF PRIORITY

This patent application is a continuation and continuation in part, claims priority from, and hereby incorporates by reference and claims priority from the entirety of the disclosures of the following cases and each of the cases on which they depend and further claim priority or incorporate by reference:
(1) U.S. Provisional patent application No. 60/783,226, titled ‘TRADE IDENTITY LICENSING IN A PROFESSIONAL SERVICES ENVIRONMENT WITH CONFLICT’ filed on Mar. 17, 2006.
(2) U.S. Provisional patent application No. 60/817,470, titled ‘SEGMENTED SERVICES HAVING A GLOBAL STRUCTURE OF NETWORKED INDEPENDENT ENTITIES’, filed Jun. 28, 2006.
(3) U.S. Provisional patent application No. 60/853,499, titled ‘METHOD AND APPARATUS OF NEIGHBORHOOD EXPRESSION AND USER CONTRIBUTION SYSTEM’ filed on Oct. 19, 2006.
(4) U.S. Provisional patent application No. 60/854,230, titled ‘METHOD AND APPARATUS OF NEIGHBORHOOD EXPRESSION AND USER CONTRIBUTION SYSTEM’ filed on Oct. 25, 2006.
(5) U.S. Utility patent application Ser. No. 11/603,442, titled ‘MAP BASED NEIGHBORHOOD SEARCH AND COMMUNITY CONTRIBUTION’ filed on Nov. 22, 2006.
(6) U.S. Utility patent application Ser. No. 11/709,575, titled ‘NEIGHBORHOOD COMMERCE IN A GEO-SPATIAL ENVIRONMENT’ filed on Feb. 21, 2007.
(7) U.S. Utility patent application number 14/089,779, titled ‘EMERGENCY INCLUDING CRIME BROADCAST IN A NEIGHBORHOOD SOCIAL NETWORK’ filed on Nov. 26, 2013.
(8) U.S. Utility patent application number 14/144,612, titled ‘MAP BASED NEIGHBORHOOD SEARCH AND COMMUNITY CONTRIBUTION’ filed on Dec. 31, 2013.

### FIELD OF TECHNOLOGY

This disclosure relates generally to the technical fields of communications and, in one example embodiment, to a method of neighborhood commerce in a geo-spatial environment.

### BACKGROUND

A garage sale (e.g., a yard sale, a tag sale, etc.) may be an informal, irregularly scheduled marketplace of new and/or used household goods (e.g., sold by one or more families). In some communities, there may be days every year in which numerous garage sales may be conducted at the same time (e.g., block sales, citywide garage sales, flea markets). Goods marketed in the garage sale may be unwanted and/or surplus items from a household conducting the garage sale. The goods may be sometimes new, like-new, broken, and/or just usable. Goods may be offered for sale (e.g., and/or for rent or loan) as the household may not want and/or need the item, to minimize their possessions, and/or to raise funds (e.g., for charity, school, etc.). Residents may hold garage sales for “spring cleaning” and/or because of a desire to move to a new residence. A sales venue may be a garage, a driveway, a front yard, a back yard, and/or a porch. Things sold at garage sales may include old clothing, books, toys, household knickknacks, furniture, bedding, appliances, computers and/or board games.

A seller may not get enough visitors (e.g., customers) to their garage sale without advertising the garage sale. As such, the seller may place advertisements on street poles, front yards, on sidewalks, in newspapers, etc. before and/or during their garage sale. The seller may find it painstaking, difficult, and/or tiresome to place, pick up, and/or remove advertisements placed throughout a neighborhood. In addition, the seller may forget exactly which street corners advertisements were placed. Some advertisements may be vandalized, torn off, and/or may litter the neighborhood when not removed by the seller (e.g., because of wind, horseplay, etc.). In addition, sometimes, visitors may grow weary of driving and/or getting out of their cars to look at items in each garage sale. If signs are not strategically placed, potential buyers may never find the garage sale. When the seller forgets to remove the signs on a street pole after a garage sale ends, the visitor may be upset that the garage sale is no longer in progress. In addition, a city may fine the seller (an owner of a home hosting the garage sale) for littering when unwanted trash and/or marketing flyer are left and/or displayed on public property.

### SUMMARY

Disclosed are a method, a device and/or a system for neighborhood commerce in a geo-spatial environment, according to one embodiment.

In one aspect, a method includes associating a verified registered user with a user profile in a constrained online neighborhood community network that verifies all addresses of users, permitting the verified registered user to mark their profile as private, associating the user profile with a specific geographic location, marking a status of specific ones of the item data as being at least one of an on-sale status, a for-loan status, a free status, a donation status and a not-for-sale status based on responses of the user in populating an inventory database, and publishing the inventory database based on a request of the user during a duration of a specific day and time when an inventory is marketable.

The method may be in a form of a machine-readable medium embodying a set of instructions that, when executed by a machine, causes the machine to perform the method.

### BRIEF DESCRIPTION OF THE DRAWINGS

Example embodiments are illustrated by way of example and not limitation in the figures of the accompanying drawings, in which like references indicate similar elements and in which:

FIG. 1 is a user interface view of a garage sale builder algorithm, according to one embodiment.

FIG. 2 is a user interface view of a map algorithm, according to one embodiment.

FIG. 3 is a user interface view of an orientation of markets in geospatial environment, according to one embodiment.

FIG. 4 is a system view of a global neighborhood environment communicating with neighborhood(s) through a network, according to one embodiment.

FIG. 5 is a user interface view of the global neighborhood environment of FIG. 4, according to one embodiment.

FIG. 6 is a system view of a global neighborhood environment communicating with the neighborhood(s) through a network, an advertiser(s), a global map data and an occupant data, according to one embodiment.

FIG. 7 is an exploded view of a social community algorithm of FIG. 6, according to one embodiment.

FIG. 8 is an exploded view of a search algorithm of FIG. 6, according to one embodiment.

FIG. 9 is an exploded view of a claimable algorithm of FIG. 6, according to one embodiment.

FIG. 10 is an exploded view of a commerce algorithm of FIG. 6, according to one embodiment.

FIG. 11 is an exploded view of a map algorithm of FIG. 6, according to one embodiment.

FIG. 12 is a table view of user address details, according to one embodiment.

FIG. 13 is a social community view of a social community algorithm, according to one embodiment.

FIG. 14 is a profile view of a profile algorithm, according to one embodiment.

FIG. 15 is a contribute view of a neighborhood network algorithm, according to one embodiment.

FIG. 16 is a diagrammatic system view of a data processing system in which any of the embodiments disclosed herein may be performed, according to one embodiment.

FIG. 17A is a user interface view of mapping user profile of the geographical location, according to one embodiment.

FIG. 17B is a user interface view of mapping of the claimable profile, according to one embodiment.

FIG. 18A is a user interface view of mapping of a claimable profile of the commercial user, according to one embodiment.

FIG. 18B is a user interface view of mapping of customizable business profile of the commercial user, according to one embodiment.

FIG. 19 is a user interface view of a group view associated with particular geographical location, according to one embodiment.

FIG. 20 is a user interface view of claim view, according to one embodiment.

FIG. 21 is a user interface view of a building builder, according to one embodiment.

FIG. 22 is a systematic view of communication of claimable data, according to one embodiment.

FIG. 23 is a systematic view of a network view, according to one embodiment.

FIG. 24 is a block diagram of a database, according to one embodiment.

FIG. 25 is an exemplary graphical user interface view for data collection, according to one embodiment.

FIG. 26 is an exemplary graphical user interface view of image collection, according to one embodiment.

FIG. 27 is an exemplary graphical user interface view of an invitation, according to one embodiment.

FIG. 28 is a flowchart of inviting the invitee(s) by the registered user, notifying the registered user upon the acceptance of the invitation by the invitee(s) and, processing and storing the input data associated with the user in the database, according to one embodiment.

FIG. 29 is a flowchart of adding the neighbor to the queue, according to one embodiment.

FIG. 30 is a flowchart of communicating brief profiles of the registered users, processing a hyperlink selection from the verified registered user and calculating and ensuring the Nmax degree of separation of the registered users away from verified registered users, according to one embodiment.

FIG. 31 is an N degree separation view, according to one embodiment.

FIG. 32 is a user interface view showing a map, according to one embodiment.

FIG. 33A is a process flow of searching a map based community and neighborhood contribution, according to one embodiment.

FIG. 33B is a continuation of process flow of FIG. 33A showing additional processes, according to one embodiment.

FIG. 33C is a continuation of process flow of FIG. 33B showing additional processes, according to one embodiment.

FIG. 33D is a continuation of process flow of FIG. 33C showing additional processes, according to one embodiment.

FIG. 33E is a continuation of process flow of FIG. 33D showing additional processes, according to one embodiment.

FIG. 34A is a process flow of a garage sale and flea market in the geo-spatial environment, according to one embodiment.

FIG. 34B is a continuation of process flow of FIG. 34A showing additional processes, according to one embodiment.

Other features of the present embodiments will be apparent from the accompanying drawings and from the detailed description that follows.

### DETAILED DESCRIPTION

A method, apparatus, and system of neighborhood commerce in a geo-spatial environment are disclosed. In the following description, for the purposes of explanation, numerous specific details are set forth in order to provide a thorough understanding of the various embodiments. It will be evident, however, to one skilled in the art that the various embodiments may be practiced without these specific details.

In one embodiment method includes associating a verified registered user with a user profile in a constrained online neighborhood community network that verifies all addresses of users, permitting the verified registered user to mark their profile as private, associating the user profile with a specific geographic location, marking a status of specific ones of the item data as being at least one of an on-sale status, a for-loan status, a free status, a donation status and a not-for-sale status based on responses of the user in populating an inventory database, and publishing the inventory database based on a request of the user during a duration of a specific day and time when an inventory is marketable.

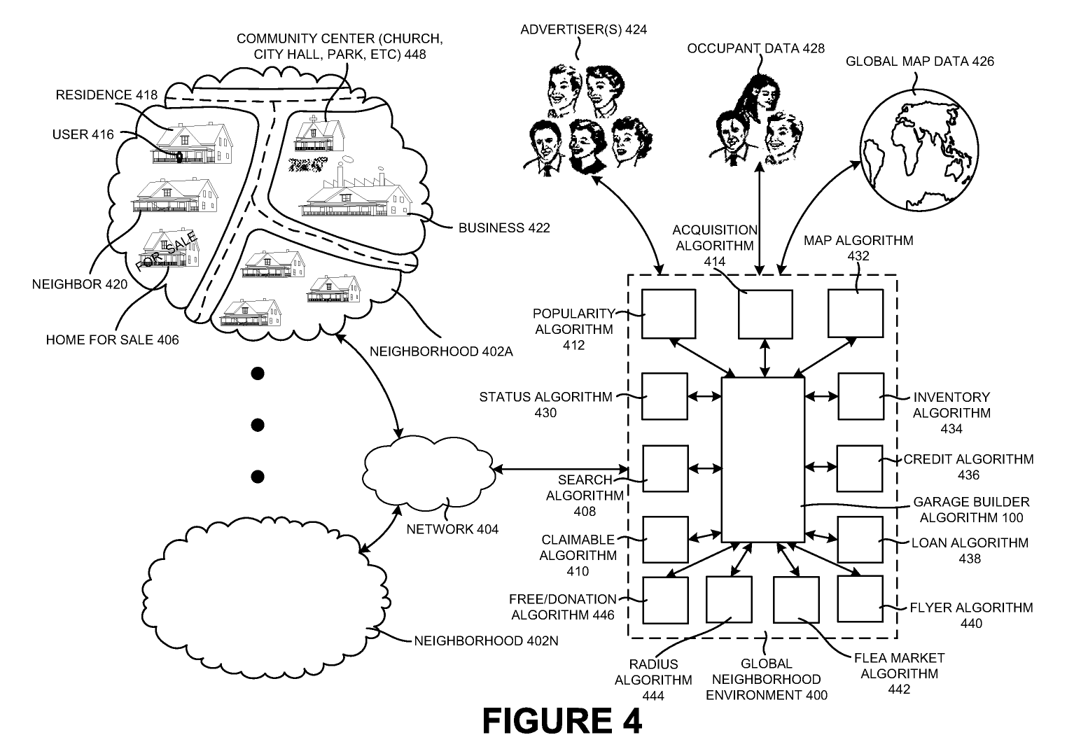

In one embodiment, a method includes associating a verified registered user (e.g., users 416 of FIG. 4) with a user profile, associating the user profile with a specific geographic location, generating a map concurrently displaying the user profile and the specific geographic location, simultaneously generating, in the map, claimable profiles associated with different geographic locations surrounding the specific geographic location associated with the user profile, populating an item data of a verified user with specific items in a physical location of a user when the verified user populates an inventory algorithm (e.g., the inventory algorithm 434 of FIG. 4) associated with the user profile.

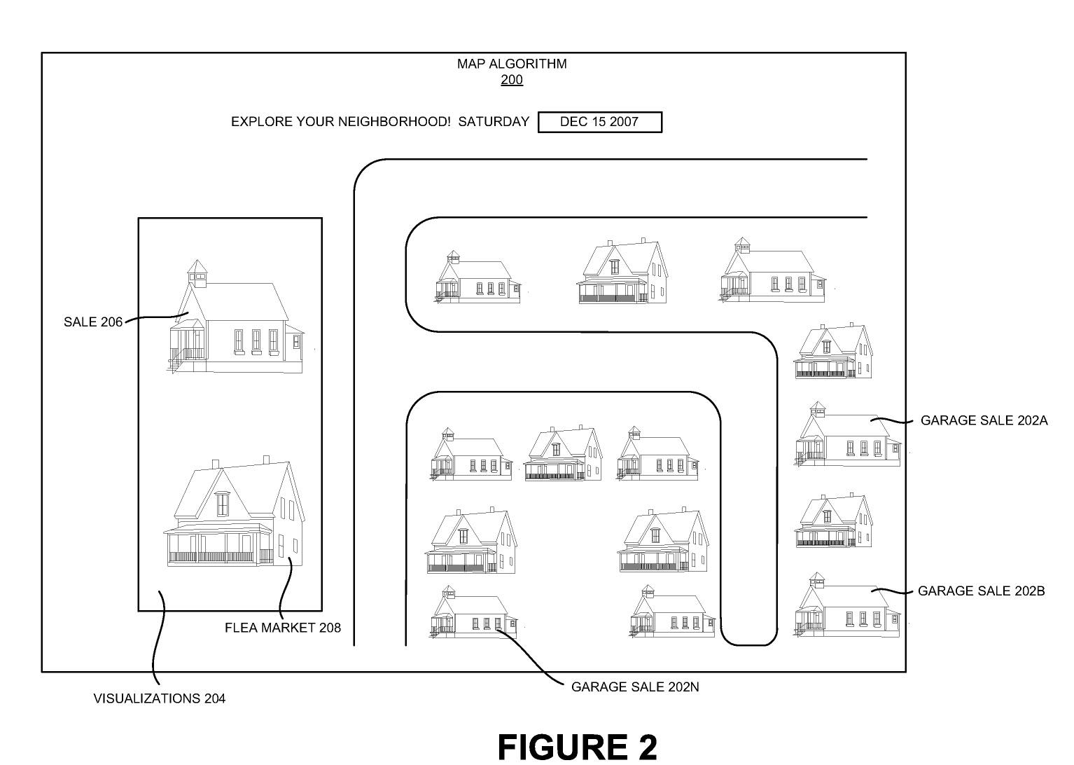

The method further includes marking a status of specific ones of the item data as being an on-sale status, a for-loan status, a free status, a donation status and/or a not-for-sale status based on responses of the user in populating the inventory algorithm and/or publishing the inventory algorithm as a garage sale (e.g., the garage sale 202A-N of FIG. 2) and/or a flea market (e.g., the flea market 208 of FIG. 2) based on a request of the user during a duration of a specific day and time when an inventory in a physical garage of a registered user will be available for public view.

In another embodiment, a system includes a number of neighborhoods (e.g., neighborhood 402A-N of FIG. 4) having registered users and/or unregistered users of a global neighborhood environment (e.g., the global neighborhood environment 400 of FIG. 4), a claimable algorithm (e.g., the claimable algorithm 410 of FIG. 4) of the global neighborhood environment to enable the registered users to create a social network page of themselves, and/or to edit information associated with the unregistered users identifiable through a viewing of physical properties in which the unregistered users reside when the registered users have knowledge of characteristics associated with the unregistered users.

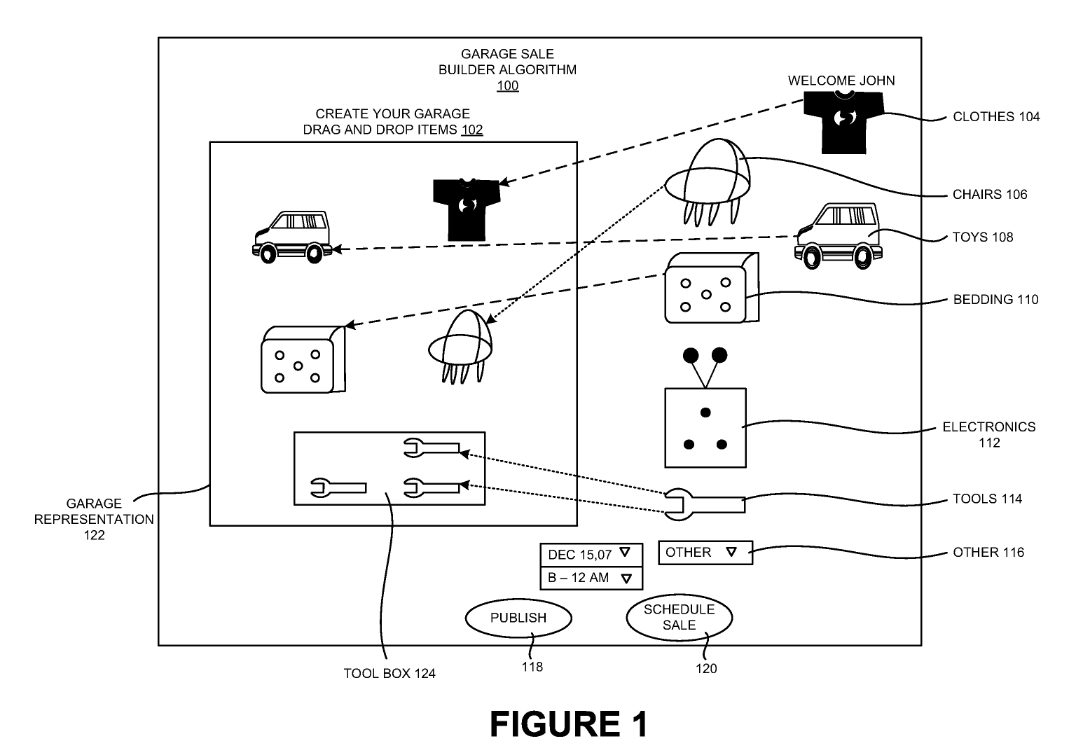

The system further includes a garage builder algorithm (e.g., a garage sale builder algorithm 100 of FIG. 1-4) of the global neighborhood environment to enable the registered users to drag and drop representations of items in a home as being divestible in a representation of a garage representing an inventory algorithm, and/or to enable the registered users to tag and/or describe the items in the home as being available as a sale status and/or a loan status, a radius algorithm of the global neighborhood environment to publish items as being sellable, viewable, and/or transactable to a set of neighbors (e.g., neighbors 420 of FIG. 4) within a distance away from each of the registered users and a map algorithm of the global neighborhood environment to include a map data associated with a satellite data which serves as a basis of rendering the map in the global neighborhood environment (e.g., the global neighborhood environment 400 of FIG. 4) and/or which simultaneously renders the garages in an explorable view of the global neighborhood environment.

In yet another embodiment, a global neighborhood environment includes a first instruction set to enable a social network to reside above a map data, in which the social network is associated with specific geographical locations identifiable in the map data, a second instruction set integrated with the first instruction set to enable users of the social network to create profiles of other people through a forum which provides a free form of expression of the users sharing information about any entities and/or people residing in any geographical location identifiable in a satellite map data, and/or to provide a technique of each of the users to claim a geographic location to control content in their respective claimed geographic locations and a third instruction set integrated with the first instruction set and the second instruction set to enable searching of homes having garage sales (e.g., the garage sale 202A-N of FIG. 2) in the global neighborhood environment (e.g., the global neighborhood environment 400 of FIG. 4) by indexing each of an inventory data in the garage sales as represented and/or offered by each registered user publishing the inventory data in the global neighborhood environment.

FIG. 1 is a user interface view of a garage sale builder algorithm 100, according to one embodiment. Particularly, FIG. 1 illustrates the garage sale builder algorithm 100, a create your garage drag and drop items option 102, a clothes option 104, a chairs option 106, a toys option 108, a bedding option 110, an electronics option 112, a tools option 114, an other option 116,′ a publish link 118, a schedule a sale option 120, a garage representation 122 and a toolbox option 124, according to one embodiment.

The garage sale builder algorithm 100 may enable registered users to drag and/or drop representations of items in a home as being divestible in a representation of a garage and/or to enable the registered users to tag and/or describe the items in the home as being available as a sale status and/or a loan status. The create your garage drag and drop items option 102 may enable the registered users to create the garage in which they may represent the items and/or drag and/or drop the selected items from a list to the garage created by the verified user of the global neighborhood environment. The clothes option 104 may enable the user to view used and/or unused clothes that may be listed by the registered user of the garage for sale in the garage representation.

The chairs option 106 may enable the user to view any chairs which may be listed by the registered user of the garage for sale in the garage representation 122. The toys option 108 may enable the user to view any toys which may be listed by the registered user of the garage for sale in the garage representation 122. The bedding option 110 may enable the user to view any bedding which may be listed by the registered user of the garage for sale in the garage representation 122.

The electronics option 112 may enable the user to view any electronics which may be listed by the registered user of the garage for sale in the garage representation 122. The tools option 114 may enable the user to view any tools which may be listed by the registered user of the garage for sale in the garage representation 122. The other option 116 may enable the user to view any other item which the registered user of the garage may list in the garage for the sale in the garage representation 122.

The publish link 118 may enable the registered user to publish items as being sellable, viewable, and/or transactable to a set of neighbors within a distance away from each of the registered users. The schedule the sale option 120 may enable the registered user to schedule the date and/or time of the next sale associated with a created garage. The garage representation 122 may represent the items listed in the garage for sale by the registered user.

In the example embodiment as illustrated in FIG. 1, the user interface view of the garage sale builder algorithm 100 may enable the user to view the items listed therein. The items listed in the garage sale builder algorithm 100 may be the clothes, the chairs, the toys, the bedding, the electronics, the tools and/or the other items. The registered user may schedule the next garage sale and/or publish the items for sale in the created garage.

FIG. 2 is a user interface view of a map algorithm 200, according to one embodiment. Particularly, FIG. 2 illustrates the map algorithm 200, a garage sale 202AN, visualization 204, a sale 206 and a flea market 208, according to one embodiment. The map algorithm 200 of the global neighborhood environment may provide information related to the map data associated with a satellite data that may serve as a basis of rendering the location of the garage sale and/or the flea market in the global neighborhood environment.

The garage sale 202A-N may be a location presentation of the garage sale in the map within the neighborhood. The visualization 204 may display the garage sale and/or the flea market as tables visually placed adjacent to each other in the neighborhood environment enabling the user to participate. The sales option 206 may provide the user with map based information associated with the location of a garage sale event in the neighborhood. The flea market 208 may provide the user to associate with the location of the garage sale in accordance with the based information.

In the example embodiment as illustrated in FIG. 2, the user interface view of the map algorithm 200 may enable the user to explore the garage sale and/or the flea market in accordance with the map based information. The map based representation of the garage sales and/or the flea markets may be displayed on selection of the sales option 206 and/or the flea market 208.

For example, the inventory algorithm (e.g., the inventory algorithm 434 of FIG. 4) may be published as the garage sale 202A-N and/or the flea market 208 based on a request of the user during a duration of a specific day and/or time when an inventory in a physical garage of the registered user will be available for public view.

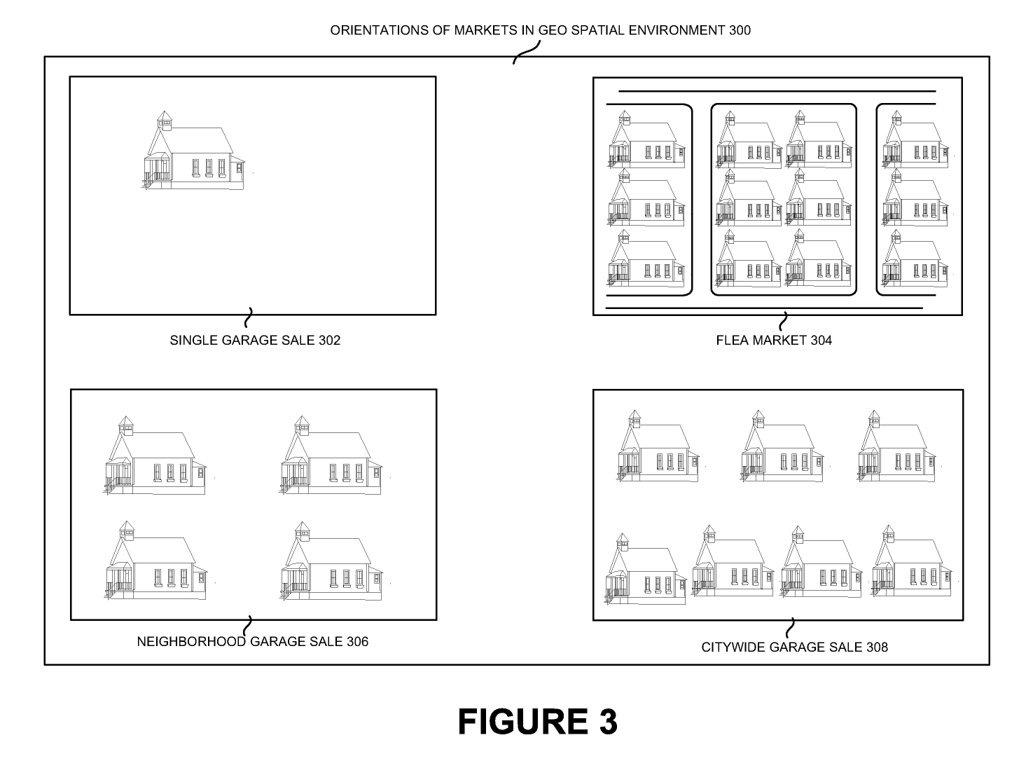

FIG. 3 is a user interface view of an orientation of markets in a geospatial environment 300, according to one embodiment. Particularly, FIG. 3 illustrates orientation of markets in the geospatial environment 300, a single garage sale option 302, a flea market option 304, a neighborhood garage sale option 306, and a citywide garage sale 308, according to one embodiment. The orientation of markets in the geospatial environment 300 may provide the user with the information of the garage sales and/or the flea markets listed.

The single garage sale option 302 may provide information of a particular garage sale to the user may be on the request. The flea market option 304 may provide the user with the information with the list of flea markets where the sale may be in progress. The neighborhood garage sale option 306 may provide the user with the information of list of garage sales in the neighborhood. The citywide garage sale 308 may provide the user with the information of garage sale taking place throughout the city in the geo-spatial environment.

In the example embodiment as illustrated in FIG. 3, the user interface view of orientation of markets in the geospatial environment 300 may enable the user to view the single garage sale option, flea market option, the neighborhood garage sale option, the citywide garage sale option. The registered user may click on the option to see the details of various sales schedules listed in the garage sale.

FIG. 4 is a system view of the global neighborhood environment 400 communicating with the neighborhood 402A-N through a network 404, according to one embodiment. Particularly, FIG. 4 illustrates a global neighborhood environment 400, a neighborhood 402A-N, a network 404, a home for sale 406, a user 416, a residence 418, a neighbor(s) 420, a business 422, an advertiser(s) 424, a global map data 426, a occupant data 428, and a community center (e.g., a church, a hall, a park, etc.) 448, according to one embodiment. The global neighborhood environment 400 may include the garage sale builder algorithm 100, a search algorithm 408, a claimable algorithm 410, a popularity algorithm 412, a acquisition algorithm 414, a status algorithm 430, a map algorithm 432, an inventory algorithm 434, a credit algorithm 436, a loan algorithm 438, a flyer algorithm 440, a flea market algorithm 442, a radius algorithm 444 and a free/donation algorithm 446, according to embodiment.

The global neighborhood environment 400 may include set of instructions that may facilitate the registered and/or unregistered user of the global neighborhood environment to communicate information associated with the garage sale and/or flea market in the geo-spatial environment. The neighborhood 402A-N may be a geographically localized community associated with the garage sale and/or the flea market in the geospatial environment.

A network 404 may facilitate the global neighborhood environment to communicate the information associated with the neighborhood 402A-N. The home for sale 406 may be any a real property in the neighborhood(s) 402A-N of the global neighborhood environment offered for sale by the user (e.g., an owner, a real estate agent, an occupant, etc.) of the global neighborhood environment. The search algorithm 408 may enable a search (e.g., the garage sale search, a people search, a business search, a category search, etc.) of any data and/or may enable embedding of any content (e.g., in search engines, blogs, social networks, professional networks, professional networks, etc.) in the global neighborhood environment.

The claimable algorithm 410 may enable the registered users to create and/or update their information associated with the garage market and/or flea market in the geo-spatial environment. The popularity algorithm 412 may represent a likeability of a neighbor based on a feedback rating provided on a conduct of the neighbor in hosting and/or marketing items in an inventory algorithm 434. The acquisition algorithm 414 may generate an acquisition request of particular user of a particular item in the inventory algorithm 434. The user 416 may be the registered and/or unregistered users who may be interested to buy, sell, list and/or bid in the garage market and/or the flea market in the geo-spatial environment.

The residence 418 may be a residence associated with the garage sale existing in the neighborhood(s) 402A-N. The business 422 may be a customer service, finance, sales, production, communications/public relations and/or marketing organization that may be located in the neighborhood(s) 402. The advertiser(s) 424 may be the individual and/or a firm who may be involved in encouraging the user's attention to the garage sale and/or flea market in the geo-spatial environment through a variety of media. The global map data 426 may contain details/maps of any area, region and/or neighborhood of the garage sale and/or the flea market in the geo-spatial environment.

The occupant data 428 may be the information associated with the registered and/or unregistered users of the global neighborhood environment residing in the neighborhood(s) 402. The status algorithm 430 may alter a status of the particular item to a sold status, a reserved status, and/or a loaned status in a global neighborhood environment 400. The map algorithm 432 may automatically set a new latitude and longitude location when the user relocates a pointer in the geo-spatial environment indicating the physical location of the garage sale and/or flea market in the geo-spatial environment, and may render a three dimensional neighborhood view in which specific items in a neighborhood commerce environment are displayed in a claimable editable until claimed social network above a global mapping environment (e.g., Microsoft Virtual Earth, Google Earth).

The inventory algorithm 434 may publish the garage sale and/or the flea market based on the request of the user during duration of the specific day and/or time when the inventory in a physical garage of the registered user may be available for public view. The credit algorithm 436 may apply a financial amount and/or a goodwill point to the registered user based on the acquisition request. The loan algorithm 438 may provide loans on responses of the user in populating the inventory algorithm and/or a loaned status may be alerted by a status algorithm 430.

The flyer algorithm 440 may announce the garage sale and/or the flea market to each resident within a threshold radius away from the garage sale and/or the flea market through the electronic communications and/or through the direct postal mail communication automatically generated based on the content, day, and/or time of the garage sale and/or the flea market.

The flea market algorithm 442 may aggregate the garages in an explorable flea market such that the garages are rendered as tables visually placed adjacent to each other and/or the entities outside any particular neighborhood may be able to simultaneously participate in the explorable flea market. The radius algorithm 444 may facilitate a sale of second hand goods by an institution such as a local group, the church as a fundraising effort in the global neighborhood environment and may specify a specific geographic distance away (e.g., 5 miles away) from the garage sale in which items are viewable. The free/donation algorithm 446 may facilitate a free basis and/or some times a small charge may be made providing a free form of expression in the garage sale and/or the flea market. The community center 448 (e.g., a church, a hall, a park, etc.) may be social organizations in the neighborhood 402.

For example, a verified registered user (e.g., the user 416 of FIG. 4) may be associated with a user profile. Also, the user profile may be associated with a specific geographic location. Furthermore, the map concurrently displaying the user profile and/or the specific geographic location may be generated (e.g., the map algorithm 200 of FIG. 2). The claimable profiles associated with different geographic locations may be generated simultaneously in the map surrounding the specific geographic location associated with the user profile. In addition, an item data of the verified user with specific items in the physical location of the user may be populated when the verified user populates the inventory algorithm 434 associated with the user profile.

Also, the status of specific ones of the item data may be marked as being the on-sale status, the for-loan status, the free status, the donation status and/or the not-for-sale status based on responses of the user in populating the inventory algorithm 434. The acquisition request of the particular user of the particular item may be processed in the inventory algorithm that may be the bid to purchase and/or the fixed amount. In addition, the financial amount and/or the goodwill point may be credited to the registered user based on the acquisition request.

The status of the particular item may be alerted to the sold status, the reserved status, and/or the loaned status. Moreover, an auction interface may be provided so that other bidders to simultaneously and competitively participate in an auction and/or bidding process when the acquisition request is the bid to purchase. A searchable database of each item being exposed in the garage sale (e.g., a garage sale 202A-N of FIG. 2) and/or the flea market (e.g., a flea market 208 of FIG. 2) may be generated based on a category, a type, a location and/or description criteria.

Furthermore, the flyer announcing the garage sale and/or the flea market may be distributed (e.g., the distributing the flyer may be conducted through the electronic communications and/or through a direct postal mail communication automatically generated based on a content, day and/or time of the garage sale and/or the flea market) to each resident within the threshold radius away from the garage sale and/or the flea market. In addition, the popularity marking of a neighbor 420 may be improved based on the feedback rating provided on a conduct of the neighbor in hosting and/or marketing items in the inventory algorithm 434.

A system includes the plurality of neighborhoods 402 having registered users and/or unregistered users of the global neighborhood environment 400. The system includes the claimable algorithm 410 of the global neighborhood environment 400 to enable the registered users (e.g., the user 416 of FIG. 4) to create the social network page of themselves, and/or to edit information associated with the unregistered users identifiable through a viewing of physical properties in which the unregistered users reside when the registered users have knowledge of characteristics associated with the unregistered users.

Furthermore, the system includes the garage sale builder algorithm 100 of the global neighborhood environment 400 to enable the registered users to drag and drop representations of items in the home as being divestible in the representation of the garage representing the inventory algorithm 434, and/or to enable the registered users to tag and/or describe the items in the home as being available as on the sale status and/or the loan status.

In addition, the radius algorithm of the global neighborhood environment 400 may publish items as being sellable, viewable, and/or transactable to the set of neighbors 420 within the distance away from each of the registered users (e.g., the user 416 of FIG. 4). The system also includes the map algorithm 200 of the global neighborhood environment 400 may include the map data associated with the satellite data which may serve as a basis of rendering the map in the global neighborhood environment 400 and which simultaneously may render any number of the garages in an explorable view of the global neighborhood environment 400.

The system may further include the acquisition algorithm 414 to generate the acquisition request of a particular user of the particular item in the inventory algorithm 434. Also, the system may include the credit algorithm 436 to apply the financial amount and/or the goodwill point to the registered user based on the acquisition request. In addition, the status algorithm 430 may alter the status of the particular item to the sold status, the reserved status, and/or the loaned status.

Furthermore, the system may include the flea market algorithm 442 to aggregate any number of the garages in the explorable flea market, such that the garages are rendered as tables visually placed adjacent to each other (e.g., as illustrated in FIG. 2) and such that entities outside any particular neighborhood 402A-N are able to simultaneously participate in the explorable flea market (e.g., a flea market 208 of FIG. 2).

The system may further include the map algorithm 432 to simultaneously display, in the geo-spatial environment, the series of pushpins each indicating the garage sale (e.g., the garage sale 202A-N of FIG. 2) and/or the flea market (e.g., the flea market 208 of FIG. 2) for each physical location contemporaneously having the garage sale and/or the flea market. The system may also include the search algorithm 408 to generate a database of each item being exposed in the garage sale and/or the flea market based on a category, a type, a location and a description criteria.

The system may include the flyer algorithm 440 to announce the garage sale and/or the flea market to each resident within the threshold radius away from the garage sale and/or the flea market through the electronic communications and/or through the direct postal mail communication automatically generated based on the content, day, and/or time of the garage sale and/or the flea market. Moreover, the system may also include the popularity algorithm 412 to represent the likeability of the neighbor based on the feedback rating provided on the conduct of the neighbor 420 in hosting and/or marketing items in the inventory algorithm 434.

Furthermore, a global neighborhood environment 400 includes a first instruction set to enable the social network to reside above the map data, in which the social network is associated with specific geographical locations identifiable in the map data (e.g., as illustrated in FIG. 2). The global neighborhood environment 400 also includes a second instruction set integrated with the first instruction set to enable users of the social network to create profiles of other people through a forum which provides a free form of expression of the users sharing information about any entities and people residing in any geographical location identifiable in a satellite map data, and/or to provide a technique of each of the users to claim a geographic location (e.g., the claimed geographic locations can mask at least a portion of data from other users based on the request of a claimant of the claimed geographic location) to control content in their respective claimed geographic locations.

In addition, the global neighborhood environment 400 includes a third instruction set integrated with the first instruction set and the second instruction set to enable searching of homes having garage sales in the global neighborhood environment 400 by indexing each of an inventory data in the garage sales as represented and offered by each registered user publishing the inventory data (e.g., through publish link 118 of FIG. 1) in the global neighborhood environment 400.

Also, the global neighborhood environment 400 may include a fourth instruction set to enable other users in the global neighborhood environment 400 to submit the bid of specific ones of the inventory data, and/or to mark the specific ones of the inventory data as being reserved when mutually agreed between parties having an agreement to transact the specific ones of the inventory data.

Furthermore, the global neighborhood environment 400 may include a fifth instruction set to distribute the notice advertising the garage sales to the set of residents within the adjustable geographic proximity from each of the garage sale. The global neighborhood environment 400 may also include a sixth instruction set to generate the database of each item being exposed in the garage sale and/or the flea market based on the category, the type, the location and/or the description criteria.

In addition, the global neighborhood environment 400 may include a seventh instruction set to improve the popularity marking of the neighbor 420 based on the feedback rating provided on the conduct of the neighbor 420 in hosting and/or marketing items in the inventory algorithm 434. Moreover, the global neighborhood environment 400 may include a seventh instruction set to publish the inventory algorithm 434 as the garage sale and/or the flea market based on the request of the user (e-g., the user 416 of FIG. 4) during the duration of the specific day and/or time when the inventory in the physical garage of the registered user will be available for public view.

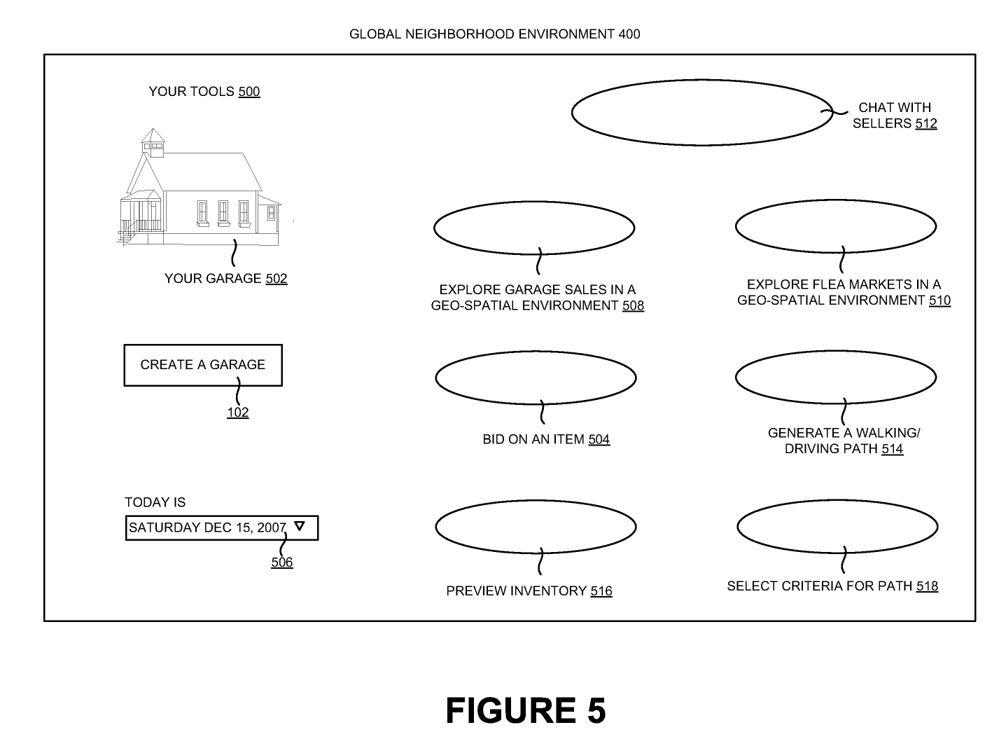

FIG. 5 is a user interface view of global neighborhood environment 400, according to one embodiment. Particularly, the FIG. 5 illustrates your tools option 500, a your garage option 502, a bid on an item option 504, a today is option 506, according to one embodiment. The create your garage drag and drop items option 102 may enable the registered user to create the garage sale in which the used, unused and/or new items for sale may be listed for the other user. The your tools option 500 may enable the user to interact and/or share information associated with the garage sale and/or flea markets with the other user of the global neighborhood environment through various options.

The your garage 502 may be the garage associated with the registered user in which the items for sale may be listed. The bid on an item option 504 may provide the users with the facility to bid on any item listed in the garage sale and/or the flea market. The today is option 506 may display the date, day, month and/or other information associated to the present day details. The explore garage sale in the geo spatial environment option 508 may provide the registered user with the map based information associated with the garage sale.

The explore flea markets in a geo spatial environment 510 may provide the user with map based information associated to flea markets. The chat with sellers option 512 may provide the users to exchange information and/or communicate with the sellers. The generate a walking/driving path option 5 14 may provide the user with map based location users to walking and/or driving lane. The preview inventory 5 16 may provide preview of the inventory to the users. The select criteria for path option 5 18 may enable the users with decisive factors for exploring the lane.

For example, a walkable and drivable map may be automatically generated based on a physical distance between each of the garage sale (e.g., the garage sale 202AN of FIG. 2) in the geo-spatial environment based on a preference of items selected by the user to preview prior to a scheduled event.

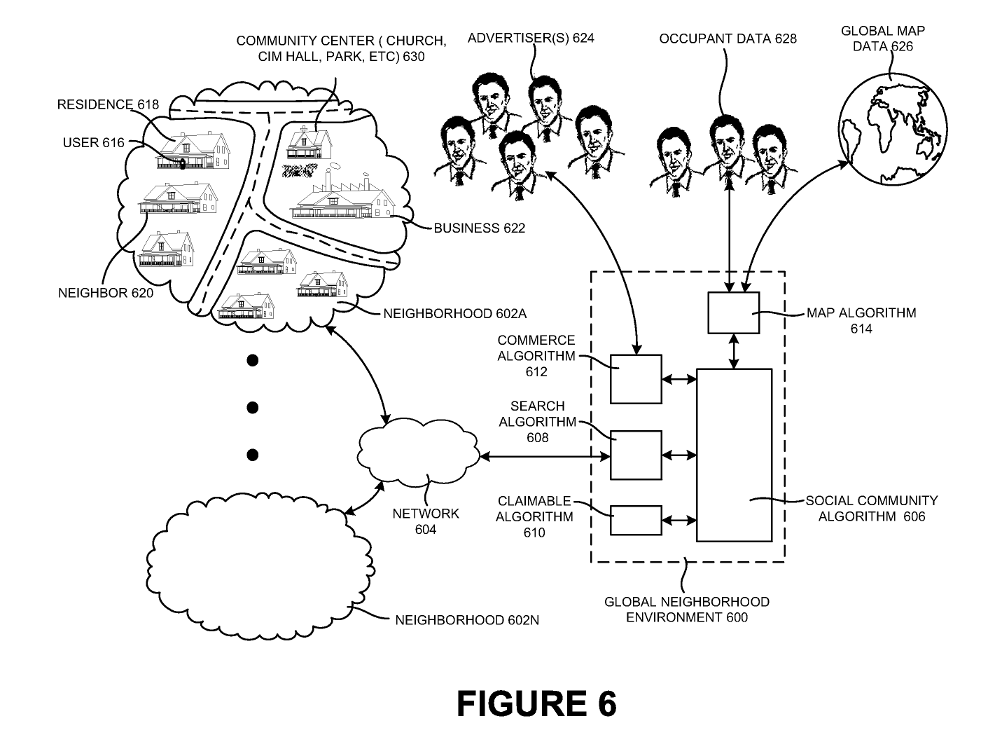

FIG. 6 is a system view of a global neighborhood environment 600 communicating with neighborhood(s) 602A-N through a network 604, an advertiser(s) 624, a global map data 626, an occupant data 628, according to one embodiment. Particularly FIG. 6 illustrates the global neighborhood environment 600, the neighborhood 602A-N, the network 604, advertiser(s) 624, global map data 626, and the occupant data 628, according to one embodiment. The global neighborhood environment 600 may contain a social community algorithm 606, a search algorithm 608, a claimable algorithm 610, a commerce algorithm 612 and a map algorithm 614. The neighborhood may include a user 616, a residence 618, a neighbor 620 and a business 622, a community center 630, according to one embodiment.

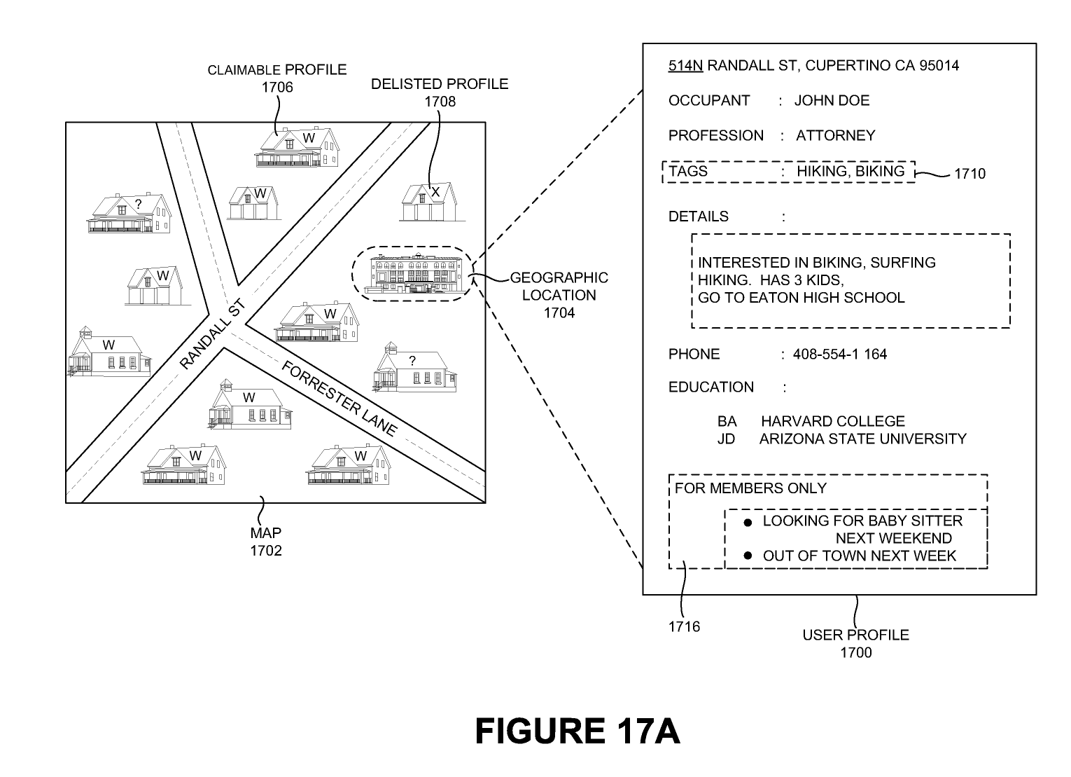

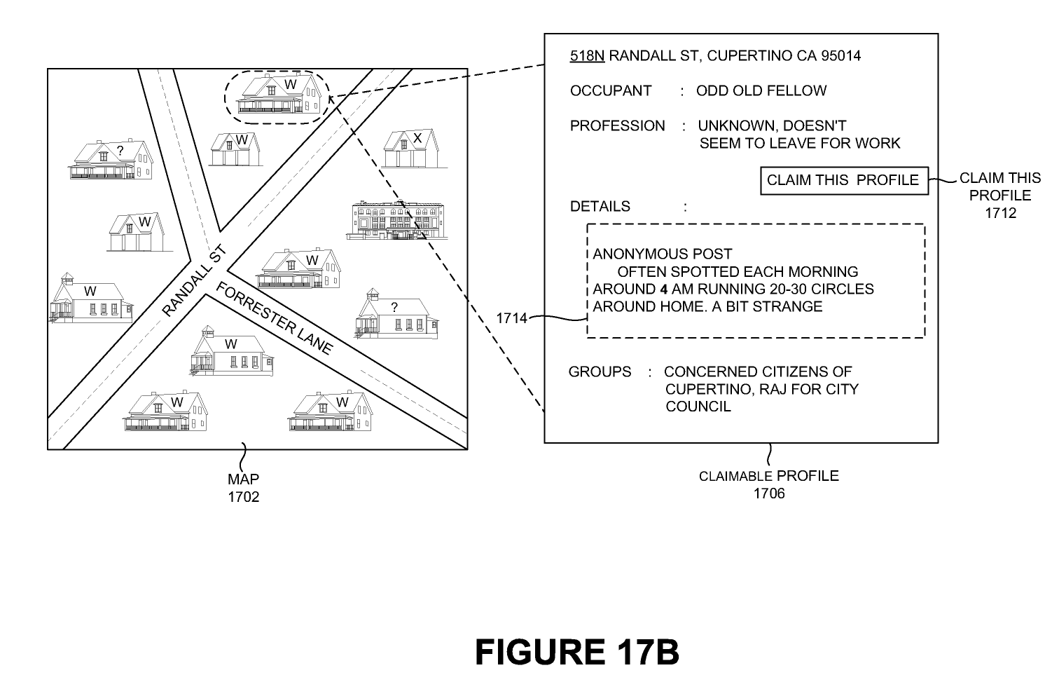

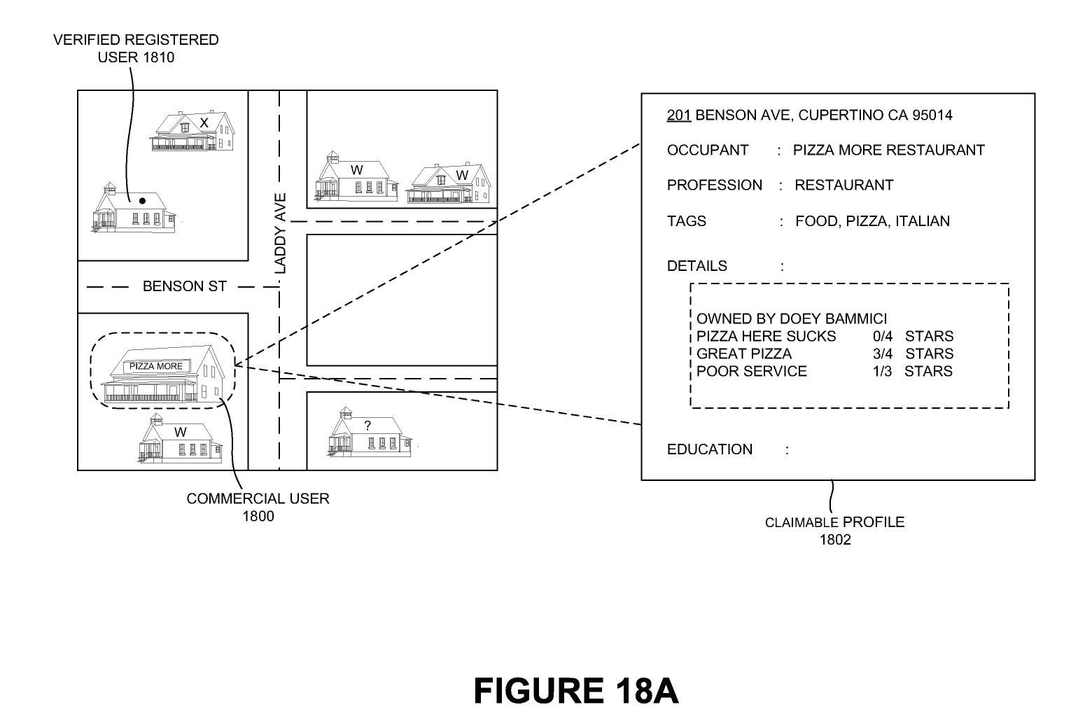

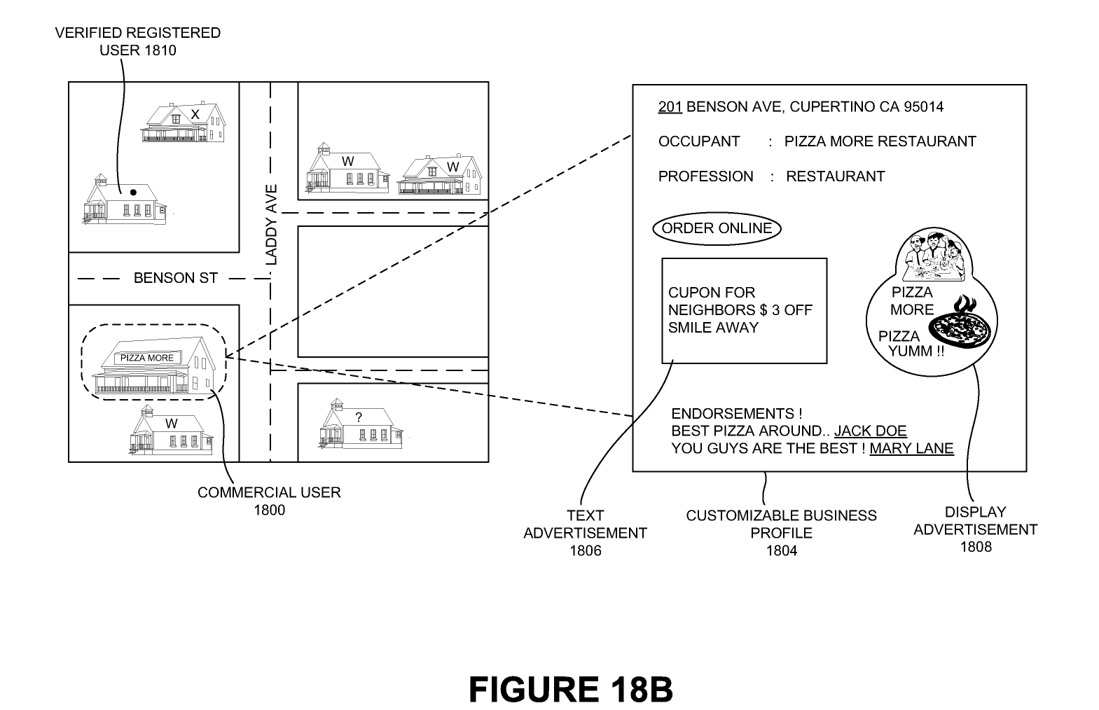

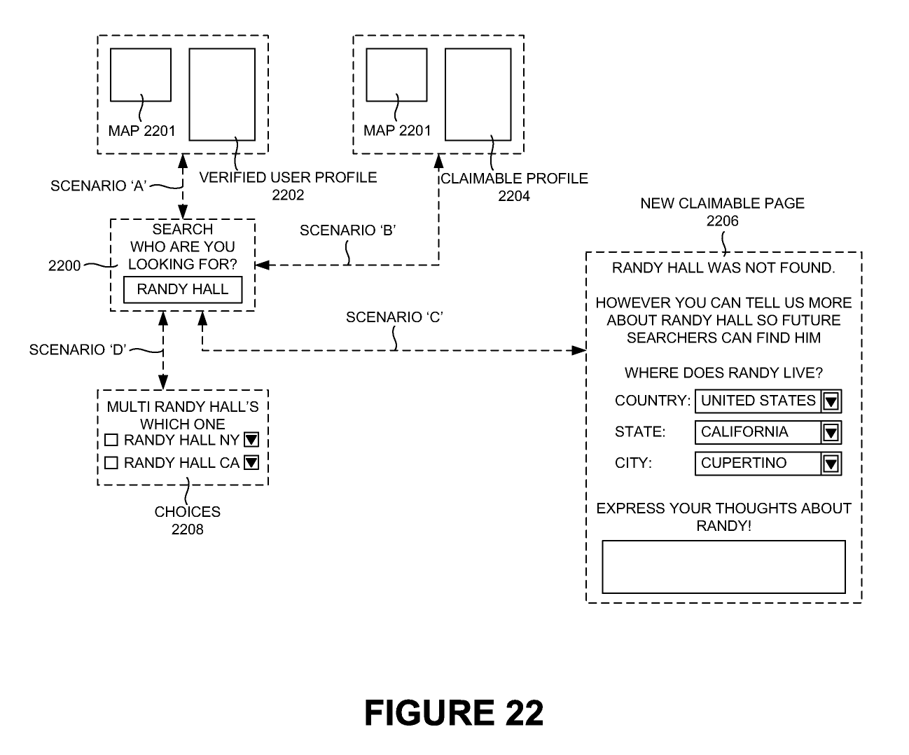

The global neighborhood environment 600 may include any number of neighborhoods having registered users and/or unregistered users. The neighborhood(s) 602 may be a geographically localized community in a larger city, town, and/or suburb. The network 604 may be search engines, blogs, social networks, professional networks and static website that may unite individuals, groups and/or community. The social community algorithm 606 may generate a building creator in which the registered users may create and/or modify empty claimable profiles (e.g., a claimable profile 1706 of FIG. 17A-17B, a claimable profile 1802 of FIG. 18A, a claimable profile 2204 of FIG. 22). The search algorithm 608 may include searching of information of an individual, group and/or community.

The claimable algorithm 610 may enable the registered users to create and/or update their information. A ‘claimable’ (e.g., may be enabled through the claimable algorithm 610) can be defined as a perpetual collective work of many authors. Similar to a blog in structure and logic, a claimable may allow anyone to edit, delete or modify content that has been placed on the Web site using a browser interface, including the work of previous authors. In contrast, a blog (e.g., or a social network page), typically authored by an individual, may not allow visitors to change the original posted material, only may add comments to the original content. The term claimable refers to either the web site or the software used to create the site. The term ‘claimable’ also implies fast creation, ease of creation, and community approval in many software contexts (e.g., claimable means “quick” in Hawaiian).

The commerce algorithm 612 may provide an advertisement system to a business that may enable the users to purchase location in the neighborhood(s) 602. The map algorithm 614 may be indulged in study, practice, representing and/or generating maps, or globes. The user 616 may be an individual(s) and/or household(s) that may purchase and/or use goods and services and/or be an active member of any group or community and/or resident and/or a part of any neighborhood(s) 602. The residence 61 8 may be a house, a place to live and/or like a nursing home in a neighborhood(s) 602.

The community center 630 may be public locations where members of a community may gather for group activities, social support, public information, and other purposes. The business 622 may be a customer service, finance, sales, production, communications/public relations and/or marketing organization that may be located in the neighborhood(s) 602. The advertiser(s) 624 may be an individual and/or a firm drawing public who may be responsible in encouraging the people attention to goods and/or services by promoting businesses, and/or may perform through a variety of media. The global map data 626 may contain the details/maps of any area, region and/or neighborhood.

In example embodiment illustrated in FIG. 6, the social community algorithm 606 of the global neighborhood environment 600 may communicate with the neighborhood(s) 602 through the network 604 and/or the search algorithm 608. The social community algorithm 606 of the global neighborhood environment 600 may communicate with the advertiser(s) 624 through the commerce algorithm, the occupant data 628 and/or global map data 626 through the map algorithm 614, as illustrated in example embodiment of FIG. 6.

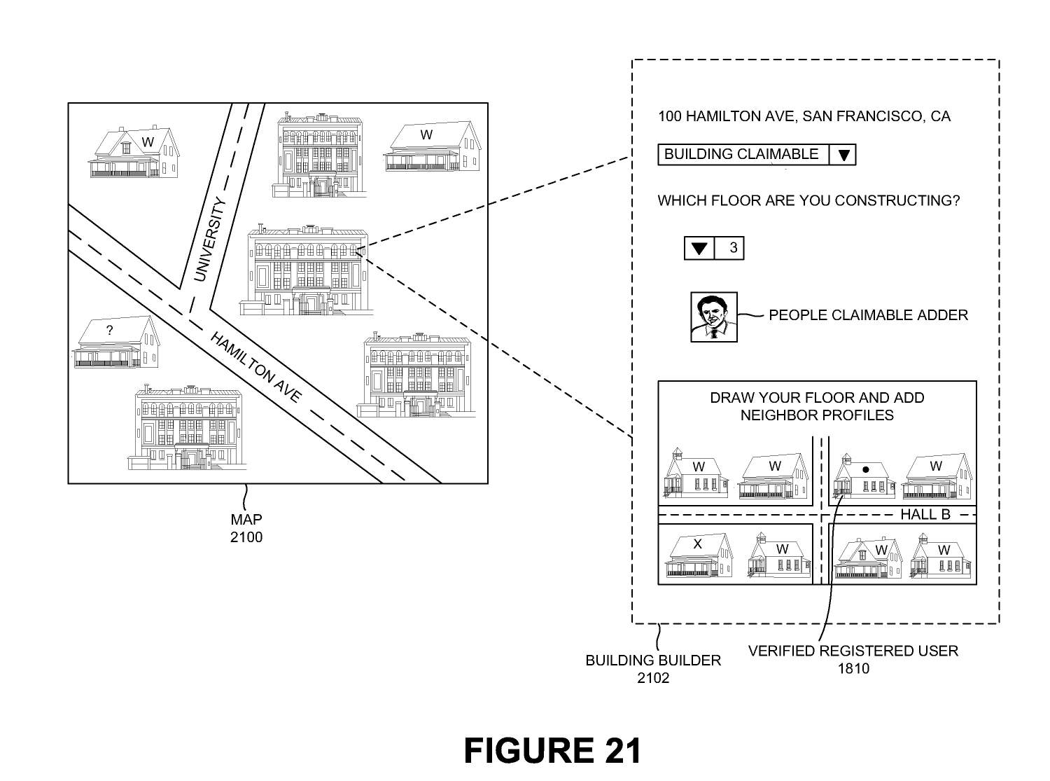

For example, the neighborhoods 602A-N may have registered users and/or unregistered users of a global neighborhood environment 600. Also, the social community algorithm 606 of the global neighborhood environment 600 may generate a building creator (e.g., building builder 2102 of FIG. 21) in which the registered users may create and/or modify empty claimable profiles, building layouts, social network pages, and/or floor levels structures housing residents and/or businesses in the neighborhood.

In addition, the claimable algorithm 610 of the global neighborhood environment 600 may enable the registered users to create a social network page of themselves, and/or may edit information associated with the unregistered users identifiable through a viewing of physical properties in which, the unregistered users reside when the registered users have knowledge of characteristics associated with the unregistered users.

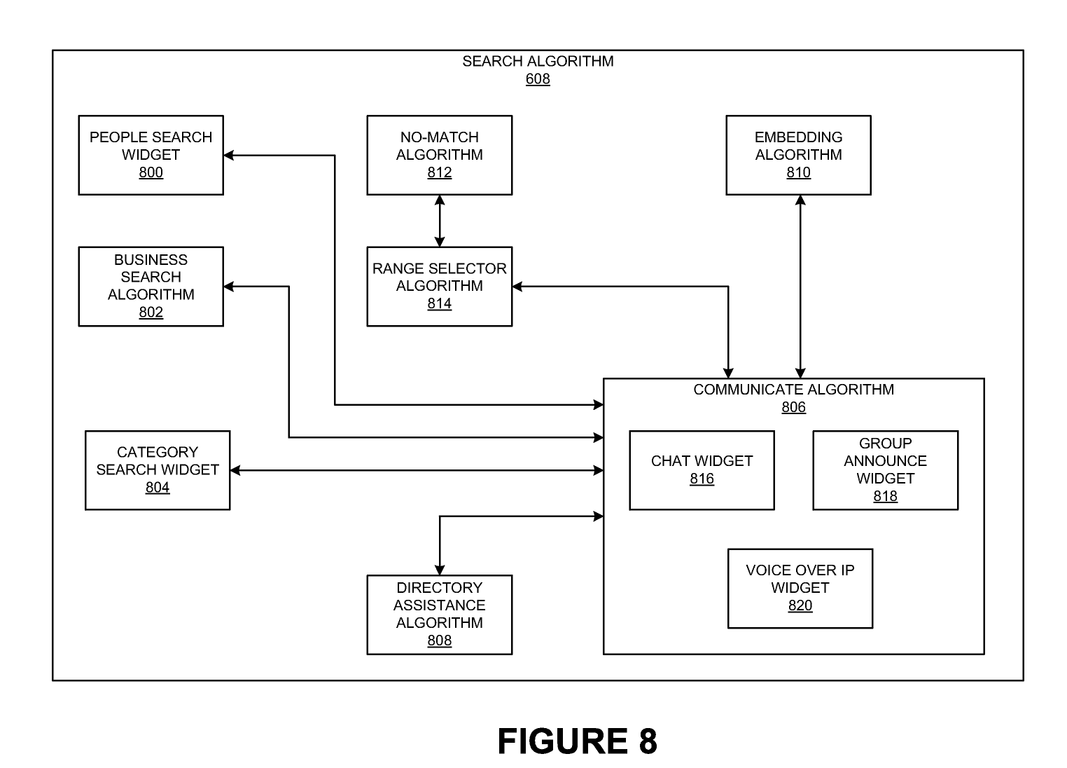

Furthermore, the search algorithm 608 of the global neighborhood environment 600 may enable a people search (e.g., the people search widget 800 of FIG. 8), a business search (e.g., the business search algorithm 802 of FIG. 8), and/or a category search (e.g., the category search widget 804 of FIG. 8) of any data in the social community algorithm 606 and/or may enable embedding of any content in the global neighborhood environment 600 in other search engines, blogs, social networks, professional networks and/or static websites.

The commerce algorithm 61′2 of the global neighborhood environment 600 may provide an advertisement system to a business who purchase their location in the global neighborhood environment 600 in which the advertisement may be viewable concurrently with a map indicating a location of the business, and/or in which revenue may be attributed to the global neighborhood environment 600 when the registered users and/or the unregistered users click-in on a simultaneously displayed data of the advertisement along with the map indicating a location of the business.

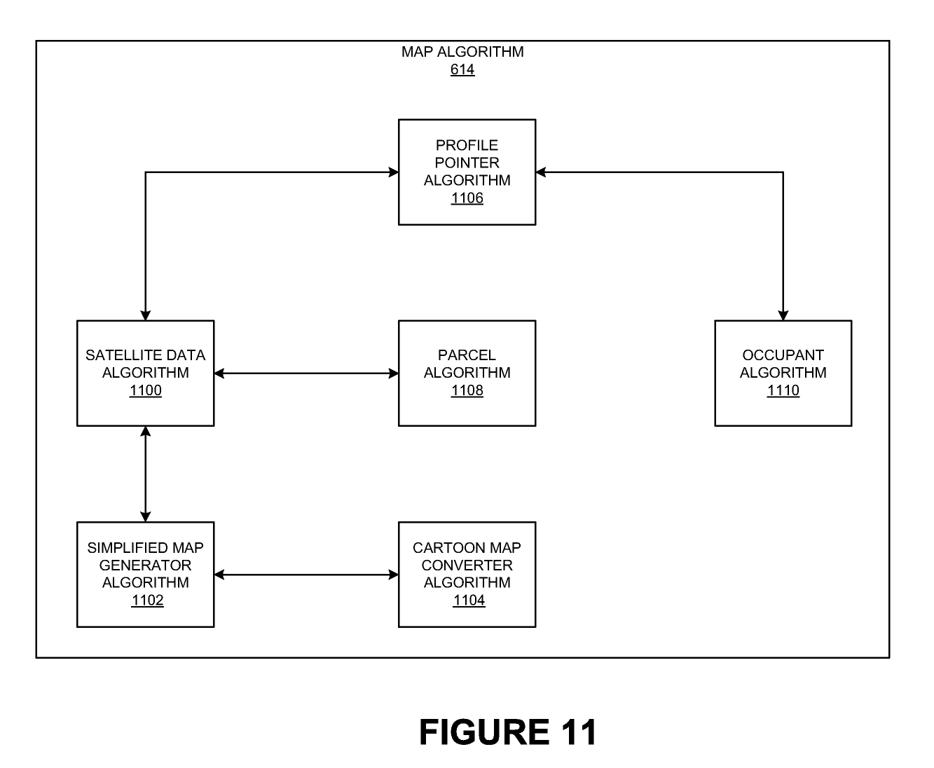

Moreover, a map algorithm 614 of the global neighborhood environment 600 may include a map data associated with a satellite data (e.g., generated by the satellite data algorithm 11 00 of FIG. 11) which may serve as a basis of rendering the map in the global neighborhood environment 600 and/or which includes a simplified map generator which may transform the map to a fewer color and/or location complex form using a parcel data which identifies some residence, civic, and/or business locations in the satellite data.

In addition, a first instruction set may enable a social network to reside above a map data, in which the social network may be associated with specific geographical locations identifiable in the map data. Also, a second instruction set integrated with the first instruction set may enable users of the social network to create profiles of other people through a forum which provides a free form of expression of the users sharing information about any entities and/or people residing in any geographical location identifiable in the satellite map data, and/or to provide a technique of each of the users to claim a geographic location (e.g., a geographic location 1704 of FIG. 17A) to control content in their respective claimed geographic locations (e.g., a geographic location 1704 of FIG. 17A).

Furthermore, a third instruction set integrated with the first instruction set and the second instruction set may enable searching of people in the global neighborhood environment 600 by indexing each of the data shared by the user 61 6 of any of the people and/or the entities residing in any geographic location (e.g., a geographic location 1704 of FIG. 17A). A fourth instruction set may provide a moderation of content about each other posted of the user 616 through trusted users of the global neighborhood environment 600 who have an ability to ban specific users and/or delete any offensive and libelous content in the global neighborhood environment 600.

Also, a fifth instruction set may enable an insertion of any content generated in the global neighborhood environment 600 in other search engines through a syndication and/or advertising relationship between the global neighborhood environment 600 and/or other internet commerce and search portals.

Moreover, a sixth instruction set may grow the social network through neighborhood groups, local politicians, block watch communities, issue activism groups, and neighbor(s) 620 who invite other known parties and/or members to share profiles of themselves and/or learn characteristics and information about other supporters and/or residents in a geographic area of interest through the global neighborhood environment 600.

Also, a seventh instruction set may determine quantify an effect on at least one of a desirability of a location, a popularity of a location, and a market value of a location based on an algorithm that may consider a number of demographic and social characteristics of a region surrounding the location through a reviews algorithm.

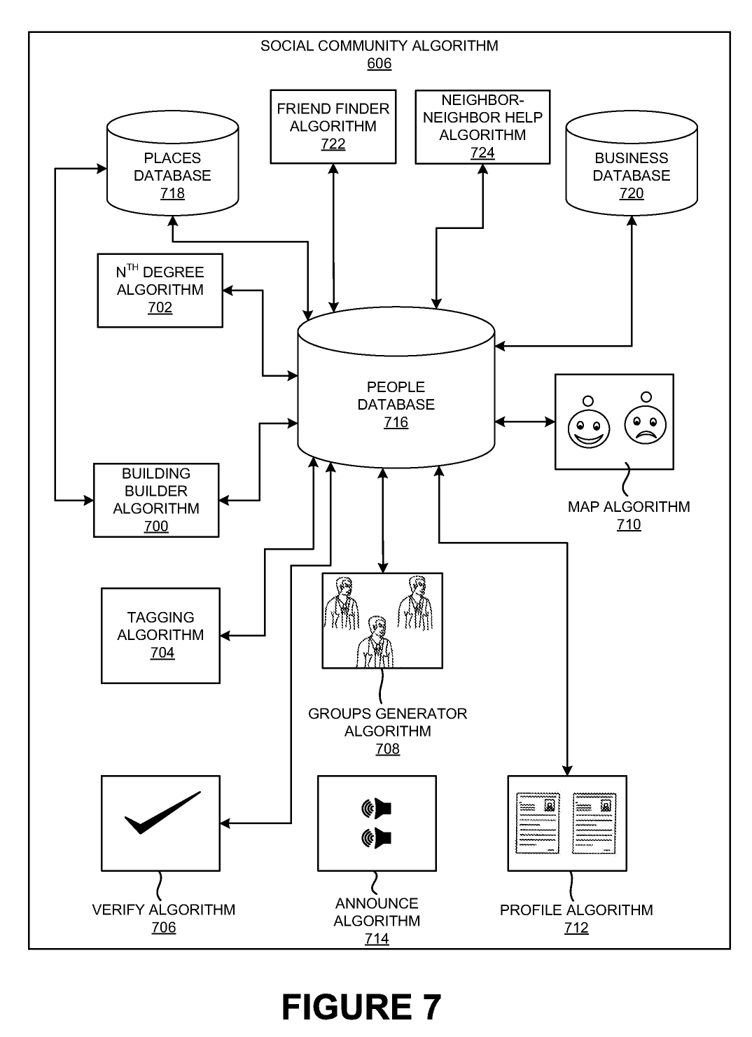

FIG. 7 is an exploded view of the social community algorithm 606 of FIG. 6, according to one embodiment. Particularly FIG. 7 illustrates a building builder algorithm 700, an N′ ˜de gree algorithm 702, a tagging algorithm 704, a verify algorithm 706, a groups generator algorithm 708, a map algorithm 7 10, a profile algorithm 7 12, an announce algorithm 714, a people database 716, a places database 7 1 8, a business database 720, a friend finder algorithm 722 and a neighbor-neighbor help algorithm 724, according to one embodiment.

The N˜˜ degree algorithm 702 may enable the particular registered user to communicate with an unknown registered user through a common registered user who may be a friend and/or a member of a common community. The tagging algorithm 704 may enable the user 616 to leave brief comments on each of the claimable profiles (e.g., the claimable profile 1706 of FIG. 17A-17B, the claimable profile 1802 of FIG. 18A, the claimable profile 2204 of FIG. 22) and social network pages in the global neighborhood environment (e.g., the global neighborhood environment 600 of FIG. 6).

The verify algorithm 706 may validate the data, profiles and/or email addresses received from various registered user(s) before any changes may be included. The groups generator algorithm 708 may enable the registered users to form groups may be depending on common interest, culture, style, hobbies and/or caste. The map algorithm 710 may generate customized indicators of different types of users, locations, and interests directly in the map. The profile algorithm 712 may enable the user to create a set of profiles of the registered users and to submit media content of themselves, identifiable through a map.

The announce algorithm 714 may distribute a message in a specified range of distance away from the registered users when a registered user purchases a message to communicate to certain ones of the registered users surrounding a geographic vicinity adjacent to the particular registered user originating the message. The people database 716 may keep records of the visitor/users (e-g., a user 616 of FIG. 6). The places database 71 8 may manage the data related to the location of the user (e.g., address of the registered user). The business database 720 may manage an extensive list of leading information related to business. The friend finder algorithm 722 may match the profile of the registered user with common interest and/or help the registered user to get in touch with new friends or acquaintances.

For example, the verify algorithm 706 of the social community algorithm 606 of FIG. 6 may authenticate an email address of a registered user prior to enabling the registered user to edit information associated with the unregistered users through an email response and/or a digital signature technique. The groups generator algorithm 708 of the social community algorithm (e.g., the social community algorithm 606 of FIG. 6) may enable the registered users to form groups with each other surrounding at least one of a common neighborhood (e.g., a neighborhood 602A-N of FIG. 6), political, cultural, educational, professional and/or social interest.

In addition, the tagging algorithm 704 of the social community algorithm (e.g., the social community algorithm 606 of FIG. 6) may enable the registered users and/or the unregistered users to leave brief comments on each of the claimable profiles (e-g., the claimable profile 1706 of FIG. 17A-17B, the claimable profile 1802 of FIG. 18A, the claimable profile 2204 of FIG. 22) and/or social network pages in the global neighborhood environment (e.g., the global neighborhood environment 600 of FIG. 6), in which the brief comments may be simultaneously displayed when a pointing device rolls over a pushpin indicating a physical property associated with any of the registered users and/or the unregistered users. Also, the map algorithm 710 of the social community algorithm 606 of FIG. 6 may be generating customized indicators of different types of users, locations, and/or interests directly in the map.

Further, the announce algorithm 714 of the social community algorithm 606 of FIG. 6 may distribute a message in a specified range of distance away from the registered users when a registered user purchases a message to communicate to certain ones of the registered users surrounding a geographic vicinity adjacent to the particular registered user originating the message, wherein the particular registered user purchases the message through a governmental currency and/or a number of tokens collected by the particular user (e.g., the user 616 of FIG. 6) through a creation of content in the global neighborhood environment (e.g., the global neighborhood environment 600 of FIG. 6).

In addition, the N^{TH} degree algorithm 702 of the social community algorithm 606 of FIG. 6 may enable the particular registered user to communicate with an unknown registered user through a common registered user known by the particular registered user and/or the unknown registered user that is an N^{TH} degree of separation away from the particular registered user and/or the unknown registered user.

Moreover, the profile algorithm 712 of the social community algorithm 606 of FIG. 6 may create a set of profiles of each one of the registered users and to enable each one of the registered users to submit media content of themselves, other registered users, and unregistered users identifiable through the map.

FIG. 8 is an exploded view of the search algorithm 608 of FIG. 6, according to one embodiment. Particularly FIG. 8 illustrates a people search widget 800, a business search algorithm 802, a category search widget 804, a communicate algorithm 806, a directory assistance algorithm 808, an embedding algorithm 8 10, a no-match algorithm 8 12, a range selector algorithm 8 14, a chat widget 8 16, a group announce widget 8 18, a Voice Over IP widget 820, according to one embodiment.

The people search widget 800 may help in getting the information like the address, phone number and/or e-mail id of the people of particular interest from a group and/or community. The business search algorithm 802 may help the users (e.g., the user 616 of FIG. 6) to find the companies, products, services, and/or business related information they need to know about.

The category search widget 804 may narrow down searches from a broader scope (e.g., if one is interested in information from a particular center, one can go to the category under the center and enter one's query there and it will return results from that particular category only). The communicate algorithm 806 may provide/facilitate multiple options by which one can choose to communicate, choose people to communicate with, and subjects to communicate about among different members of the global neighborhood environment (e.g., the global neighborhood environment 600 of FIG. 6).

The directory assistance algorithm 808 may provide voice response assistance to users (e.g., the user 616 of FIG. 6) assessable through a web and telephony interface of any category, business and search queries of user's of any search engine contents. The embedding algorithm 8 10 may automatically extract address and/or contact info from other social networks, search engines, and content providers.

The no-match algorithm 812 may request additional information from a verified registered user (e.g., a verified registered user 1810 of FIG. 18A-B) a verified registered user 1810 of FIG. 21) about a person, place, and business having no listing in the global neighborhood environment (e.g., the global neighborhood environment 600 of FIG. 6) when no matches are found in a search query of the verified registered user (e.g., a verified registered user 1810 of FIG. 18A-B, a verified registered user 1810 of FIG. 21).

The chat widget 816 may provide people to chat online, which is a way of communicating by broadcasting messages to people on the same site in real time. The group announce widget 8 18 may communicate with a group and/or community may be by Usenet, Mailing list, calling and/or E-mail message sent to notify subscribers. The Voice over IP widget 820 may help in routing of voice conversations over the Internet and/or through any other IP-based network. The communicate algorithm 806 may communicate directly with the people search widget 800, the business search algorithm 802, the category search widget 804, the directory assistance algorithm 808, the embedding algorithm 810 may communicate with the no-match algorithm 812 through the range selector algorithm 814.

For example, a search algorithm 608 of the global neighborhood environment (e.g., the global neighborhood environment 600 of FIG. 6) may enable the people search, the business search, and the category search of any data in the social community algorithm (e.g., the social community algorithm 606 of FIG. 6) and/or may enable embedding of any content in the global neighborhood environment (e.g., the global neighborhood environment 600 of FIG. 6) in other search engines, blogs, social networks, professional networks and/or static websites.

In addition, the communicate algorithm 806 of the search algorithm 608 may enable voice over internet, live chat, and/or group announcement functionality in the global neighborhood environment (e.g., the global neighborhood environment 600 of FIG. 6) among different members of the global neighborhood environment (e.g., the global neighborhood environment 600 of FIG. 6).

Also, the directory assistance algorithm 808 of the search algorithm 608 may provide voice response assistance to users (e.g., the user 61 6 of FIG. 6) assessable through a web and/or telephony interface of any category, business, community, and residence search queries of users (e.g., the user 61 6 of FIG. 6) of any search engine embedding content of the global neighborhood environment (e.g., the global neighborhood environment 600 of FIG. 6).

The embedding algorithm 810 of the search algorithm 608 may automatically extract address and/or contact info from other social networks, search engines, and content providers, and/or to enable automatic extraction of group lists from contact databases of instant messaging platforms.

Furthermore, the no-match algorithm 812 of the search algorithm 608 may request additional information from the verified registered user (e.g., the verified registered user 1810 of FIG. 18A-B) about a person, place, and/or business having no listing in the global neighborhood environment (e.g., the global neighborhood environment 600 of FIG. 6) when no matches are found in a search query of the verified registered user

(e.g., the verified registered user 1810 of FIG. 18A-B, the verified registered user 1810 of FIG. 21) and may create a new claimable page based on a response of the verified registered user (e.g., the verified registered user 1810 of FIG. 18A-B) the verified registered user 1810 of FIG. 21) about the at least one person, place, and/or business not previously indexed in the global neighborhood environment (e.g., the global neighborhood environment 600 of FIG. 6).

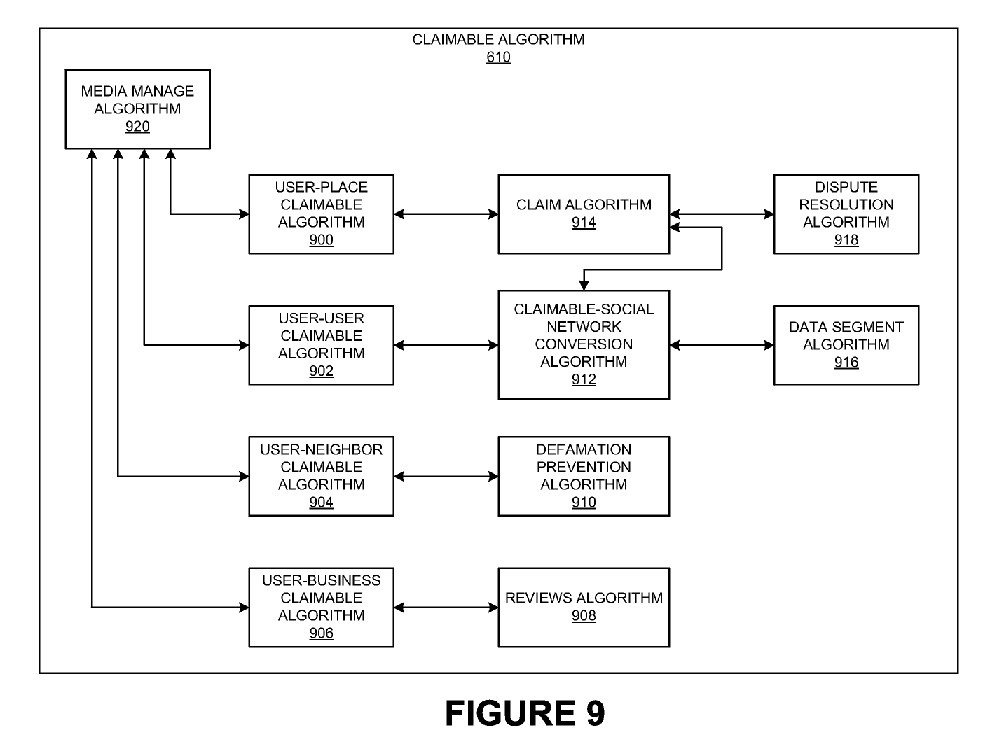

FIG. 9 is an exploded view of the claimable algorithm 610 of FIG. 6, according to one embodiment. Particularly FIG. 9 illustrates a user-place claimable algorithm 900, a user-user claimable algorithm 902, a user-neighbor claimable algorithm 904, a user-business claimable algorithm 906, a reviews algorithm 908, a defamation prevention algorithm 910, a claimable-social network conversion algorithm 912, a claim algorithm 914, a data segment algorithm 916, a dispute resolution algorithm 918 and a media manage algorithm 920, according to one embodiment.

The user-place claimable algorithm 900 may manage the information of the user (e.g., the user 616 of FIG. 6) location in the global neighborhood environment (e.g., the global neighborhood environment 600 of FIG. 6). The user-user claimable algorithm 902 may manage the user (e.g., the user 616 of FIG. 6) to view a profile of another user and geographical location in the neighborhood. The user-neighbor claimable algorithm 904 may manage the user (e.g., the users 616 of FIG. 6) to view the profile of the registered neighbor and/or may trace the geographical location of the user in the global neighborhood environment (e.g., the global neighborhood environment 600 of FIG. 6). The user-business claimable algorithm 906 may manage the profile of the user (e.g., the user 616 of FIG. 6) managing a commercial business in the neighborhood environment. The reviews algorithm 908 may provide remarks, local reviews and/or ratings of various businesses as contributed by the users (e.g., the user 6 16 of FIG. 6) of the global neighborhood environment (e.g., the global neighborhood environment 600 of FIG. 6). The defamation prevention algorithm 910 may enable the registered users to modify the information associated with the unregistered users identifiable through the viewing of the physical properties.

The claimable-social network conversion algorithm 912 of the claimable algorithm 610 of FIG. 6 may transform the claimable profiles (e.g., the claimable profile 1706 of FIG. 17A-17B, the claimable profile 1802 of FIG. 18A, the claimable profile 2204 of FIG. 22) to social network profiles when the registered users claim the claimable profiles (e.g., the claimable profile 1706 of FIG. 17A-17B, the claimable profile 1802 of FIG. 18A, the claimable profile 2204 of FIG. 22).

The claim algorithm 914 may enable the unregistered users to claim the physical properties associated with their residence (e.g., the residence 618 of FIG. 6). The dispute resolution algorithm 91 8 may determine a legitimate user among different unregistered users who claim a same physical property. The media manage algorithm 920 may allows users (e.g., the user 616 of FIG. 6) to manage and/or review a list any product from product catalog using a fully integrated, simple to use interface.

The media manage algorithm 920 may communicate with the user-place claimable algorithm 900, user-user claimable algorithm 902, the user-neighbor claimable algorithm 904 and the reviews algorithm 908 through user-business claimable algorithm 906. The user-place claimable algorithm 900 may communicate with the dispute resolution algorithm 91 8 through the claim algorithm 914. The user-user claimable algorithm 902 may communicate with the data segment algorithm 916 through the claimable-social network conversion algorithm 912. The user-neighbor claimable algorithm 904 may communicate with the defamation prevention algorithm 910. The user-business claimable algorithm 906 may communicate with the reviews algorithm 908. The claimable-social network conversion algorithm 912 may communicate with the claim algorithm 914.

For example, the claimable algorithm 610 of the global neighborhood environment (e.g., the global neighborhood environment 600 of FIG. 6) may enable the registered users to create the social network page of themselves, and may edit information associated with the unregistered users identifiable through a viewing of physical properties in which the unregistered users reside when the registered users have knowledge of characteristics associated with the unregistered users.

Furthermore, the dispute resolution algorithm 918 of the claimable algorithm 610 may determine a legitimate user of different unregistered users who claim a same physical property. The defamation prevention algorithm 910 of the claimable algorithm 610 may enable the registered users to modify the information associated with the unregistered users identifiable through the viewing of the physical properties, and/or to enable registered user voting of an accuracy of the information associated with the unregistered users.

Moreover, the reviews algorithm of the claimable algorithm 610 may provide comments, local reviews and/or ratings of various businesses as contributed by the registered users and/or unregistered users of the global network environment (e.g., the global neighborhood environment 600 of FIG. 6). The claimable-social network conversion algorithm 912 of the claimable algorithm 610 of FIG. 6 may transform the claimable profiles (e.g., the claimable profile 1706 of FIG. 17A-17B, the claimable profile 1802 of FIG. 18A, the claimable profile 2204 of FIG. 22) to social network profiles when the registered users claim the claimable profiles (e.g., the claimable profile 1706 of FIG. 17A-17B, the claimable profile 1802 of FIG. 18A, the claimable profile 2204 of FIG. 22).

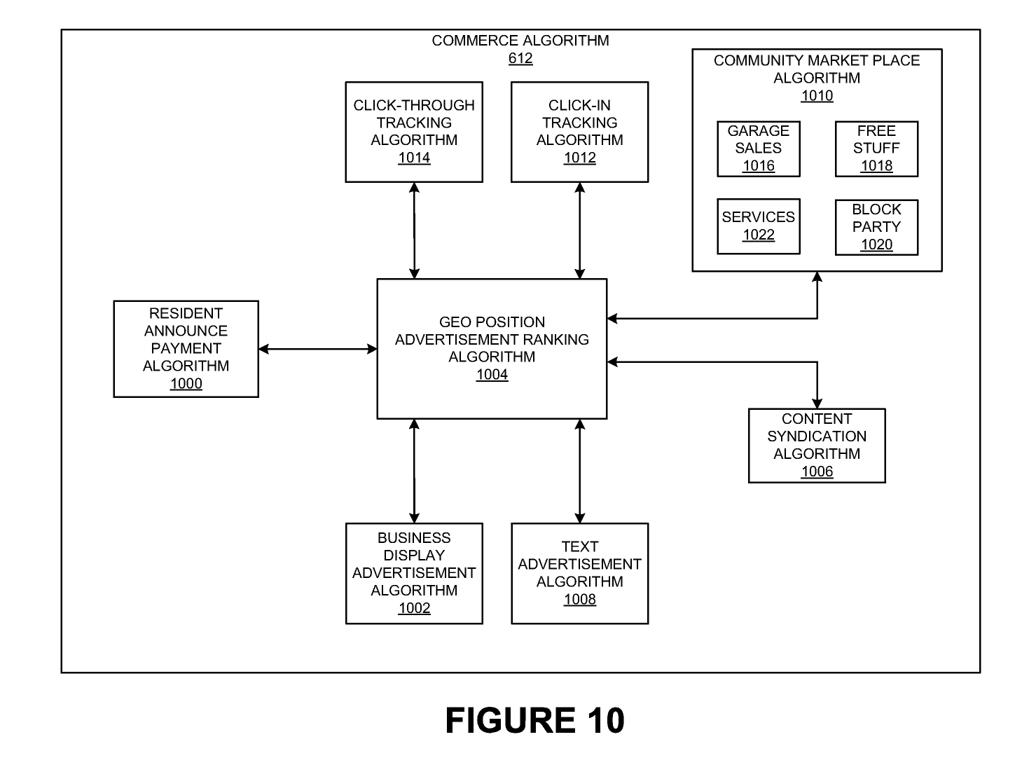

FIG. 10 is an exploded view of the commerce algorithm 612 of FIG. 6, according to one embodiment. Particularly FIG. 10 illustrates a resident announce payment algorithm 1000, a business display advertisement algorithm 1002, a geo position advertisement ranking algorithm 1004, a content syndication algorithm 1006, a text advertisement algorithm 1008, a community marketplace algorithm 1010, a click-in tracking algorithm 101 2, a click-through tracking algorithm 1014, according to one embodiment.

The community marketplace algorithm 10 10 may contain garage sales 1016, a free stuff 101 8, a block party 1020 and services 1022, according to one embodiment. The geo-position advertisement ranking algorithm 1004 may determine an order of the advertisement in a series of other advertisements provided in the global neighborhood environment (e.g., the global neighborhood environment 600 of FIG. 6) by other advertisers. The click-through tracking algorithm 1014 may determine a number of click-through from the advertisement to a primary website of the business.

A click-in tracking algorithm 1012 may determine a number of user (e.g., the user 616 of FIG. 6) who clicked in to the advertisement simultaneously. The community marketplace algorithm 101 0 may provide a forum in which the registered users can trade and/or announce messages of trading events with at least each other. The content syndication algorithm 1006 may enable any data in the commerce algorithm (e.g., the commerce algorithm 612 of FIG. 6) to be syndicated to other network based trading platforms.

The business display advertisement algorithm 1002 may impart advertisements related to business (e.g., the business 622 of FIG. 6), public relations, personal selling, and/or sales promotion to promote commercial goods and services. The text advertisement algorithm 1008 may enable visibility of showing advertisements in the form of text in all dynamically created pages in the directory. The resident announce payment algorithm 1000 may take part as component in a broader and complex process, like a purchase, a contract, etc.

The block party 1020 may be a large public celebration in which many members of a single neighborhood (e.g., the neighborhood 602A-N of FIG. 6) congregate to observe a positive event of some importance. The free stuff 10 18 may be the free services (e.g., advertisement, links etc.) available on the net. The garage sales 1016 may be services that may be designed to make the process of advertising and/or may find a garage sale more efficient and effective. The services 1022 may be non-material equivalent of a good designed to provide a list of services that may be available for the user (e.g., the user 616 of FIG. 6).

The geo position advertisement ranking algorithm 1004 may communicate with the resident announce payment algorithm 1000, the business display advertisement algorithm 1002, the content syndication algorithm 1006, the text advertisement algorithm 1008, the community marketplace algorithm 101 0, the click-in tracking algorithm 1012 and the click-through tracking algorithm 1014.

For example, the commerce algorithm 612 of the global neighborhood environment (e.g., the global neighborhood environment 600 of FIG. 6) may provide an advertisement system to a business which may purchase their location in the global neighborhood environment (e.g., the global neighborhood environment 600 of FIG. 6) in which the advertisement may be viewable concurrently with a map indicating a location of the business, and/or in which revenue may be attributed to the global neighborhood environment (e.g., the global neighborhood environment 600 of FIG. 6) when the registered users and/or the unregistered users click-in on a simultaneously displayed data of the advertisement along with the map indicating a location of the business.

Also, the geo-position advertisement ranking algorithm 1004 of the commerce algorithm 612 may determine an order of the advertisement in a series of other advertisements provided in the global neighborhood environment (e.g., the global neighborhood environment 600 of FIG. 6) by other advertisers, wherein the advertisement may be a display advertisement, a text advertisement, and/or an employment recruiting portal associated with the business that may be simultaneously displayed with the map indicating the location of the business.

Moreover, the click-through tracking algorithm 1014 of the commerce algorithm 612 of FIG. 6 may determine a number of click-through from the advertisement to a primary website of the business. In addition, the click-in tracking algorithm 1012 of the commerce algorithm 612 may determine the number of users (e.g., the user 61 6 of FIG. 6) who clicked in to the advertisement simultaneously displayed with the map indicating the location of the business.

The community marketplace algorithm 101 0 of the commerce algorithm 612 of FIG. 6 may provide a forum in which the registered users may trade and/or announce messages of trading events with certain registered users in geographic proximity from each other. Also, the content syndication algorithm 1006 of the commerce algorithm 612 of the FIG. 6 may enable any data in the commerce algorithm 612 to be syndicated to other network based trading platforms.

FIG. 11 is an exploded view of a map algorithm 614 of FIG. 6, according to one embodiment. Particularly FIG. 11 may include a satellite data algorithm 11 00, a simplified map generator algorithm 1102, a cartoon map converter algorithm 1104, a profile pointer algorithm 1106, a parcel algorithm 1108 and occupant algorithm 11 10, according to one embodiment. The satellite data algorithm 1100 may help in mass broadcasting (e.g., maps) and/or as telecommunications relays in the map algorithm 614 of FIG. 6.

The simplified map generator algorithm 1102 may receive the data (e.g., maps) from the satellite data algorithm 1100 and/or may convert this complex map into a simplified map with fewer colors. The cartoon map converter algorithm 1104 may apply a filter to the satellite data (e.g., data generated by the satellite data algorithm 1100 of FIG. 11) into a simplified polygon based representation.

The parcel algorithm 1108 may identify some residence, civic, and business locations in the satellite data (e.g., the satellite data algorithm 1100 of FIG. 11). The occupant algorithm 1110 may detect the geographical location of the registered user in the global neighborhood environment (e.g., the global neighborhood environment 600 of FIG. 6). The profile pointer algorithm 1106 may detect the profiles of the registered user via the data received from the satellite. The cartoon map converter algorithm 1104 may communicate with, the satellite data algorithm 1100, the simplified map generator algorithm 1102, the profile pointer algorithm 1106 and the occupant algorithm 1110. The parcel algorithm 1108 may communicate with the satellite data algorithm 1100.

For example, a map algorithm 614 of the global neighborhood environment (e.g., the global neighborhood environment 600 of FIG. 6) may include a map data associated with a satellite data (e.g., data generated by the satellite data algorithm 1100 of FIG. 11) which serves as a basis of rendering the map in the global neighborhood environment (e.g., the global neighborhood environment 600 of FIG. 6) and/or which includes a simplified map generator (e.g., the simplified map generator algorithm 1102 of FIG. 11) which may transform the map to a fewer color and location complex form using a parcel data which identifies residence, civic, and business locations in the satellite data.

Also, the cartoon map converter algorithm 1104 in the map algorithm 614 may apply a filter to the satellite data (e.g., data generated by the satellite data algorithm 1100 of FIG. 11) to transform the satellite data into a simplified polygon based representation using a Bezier curve algorithm that converts point data of the satellite data to a simplified form.

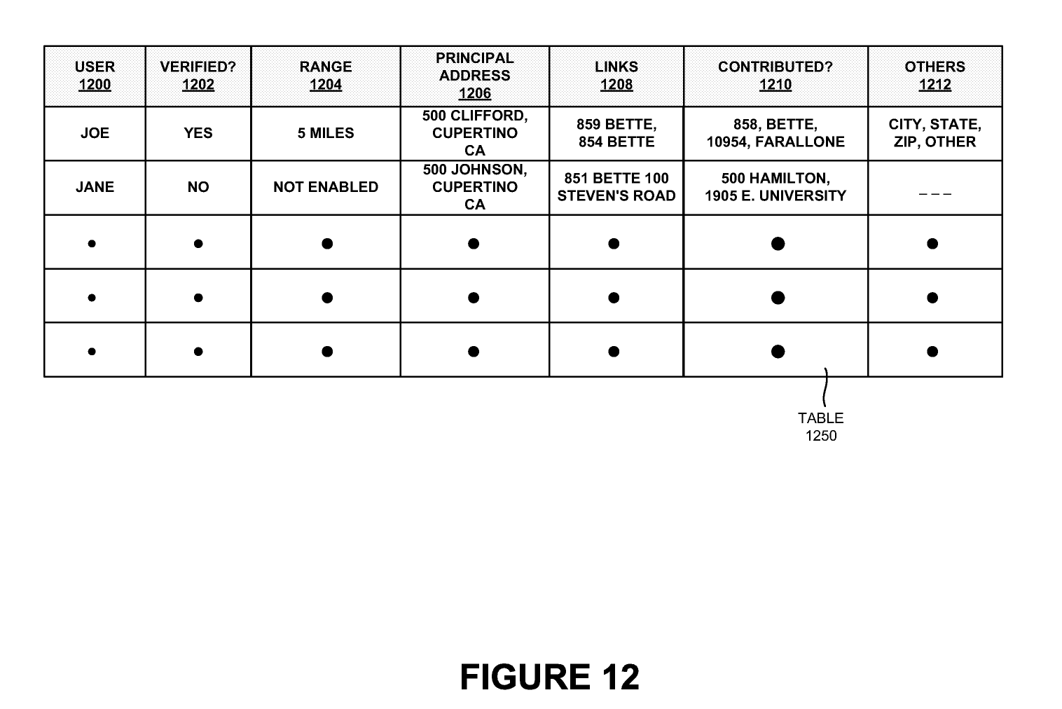

FIG. 12 is a table view of user address details, according to one embodiment. Particularly the table 1250 of FIG. 12 illustrates a user field 1200, a verified field? 1202, a range field 1204, a principal address field 1206, a links field 1208, a contributed? field 121 0 and an other field(s) 1212, according to one embodiment. The table 1250 may include the information related to the address verification of the user (e-g., the user 616 of FIG. 6). The user field 1200 may include information such as the names of the registered users in a global neighborhood environment (e.g., a global neighborhood environment 600 of FIG. 6).

The verified? field 1202 may indicate the status whether the data, profiles and/or email address received from various registered user are validated or not. The range field 1204 may correspond to the distance of a particular registered user geographical location in the global neighborhood environment (e.g., the global neighborhood environment 600 of FIG. 6).

The principal address field 1206 may display primary address of the registered user in the global neighborhood environment (e.g., the global neighborhood environment 600 of FIG. 6). The links field 1208 may further give more accurate details and/or links of the address of the user (e.g., the user 616 of FIG. 6). The contributed? Field 1210 may provide the user with the details of another individual and/or users contribution towards the neighborhood environment (e.g., the global neighborhood environment 600 of FIG. 6). The other(s) field 1212 may display the details like the state, city, zip and/or others of the user's location in the global neighborhood environment (e.g., the global neighborhood environment 600 of FIG. 6).

The user field 1200 displays “Joe” in the first row and “Jane” in the second row of the user field 1200 column of the table 1250 illustrated in FIG. 12. The verified field? 1202 displays “Yes” in the first row and “No” in the second row of the verified? field 1202 column of the table 1250 illustrated in FIG. 12. The range field 1204 displays “5 miles” in the first row and “Not enabled” in the second row of the range field 1204 column of the table 1250 illustrated in FIG. 12. The principal address field 1206 displays “500 Clifford Cupertino, Calif.” in the first row and “500 Johnson Cupertino, Calif.” in the second row of the principal address field 1206 column of the table 1250 illustrated in FIG. 12. The links field 1208 displays “859 Bette, 854 Bette” in the first row and “851 Bette 100 Steven's Road” in the second row of the links field 1208 column of the table 1250 illustrated in FIG. 12.

The contributed? field 1210 displays “858 Bette, 10954, Farallone” in the first row and “500 Hamilton, 1905E University” in the second row of the contributed field 1210 column of the table 1250 illustrated in FIG. 12. The other(s) field 12 12 displays “City, State, Zip, other” in the first row of the other(s) field 1212 column of the table 1250 illustrated in FIG. 12.

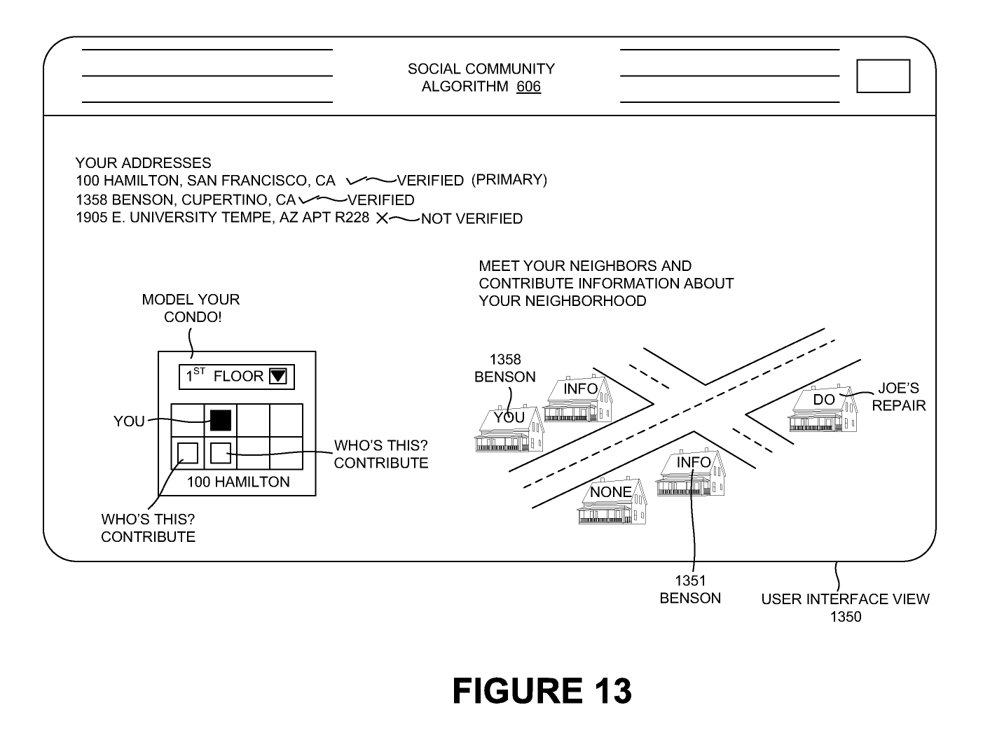

FIG. 13 is a user interface view of the social community algorithm 606, according to one embodiment. The user interface view 1350 may display the information associated with the social community algorithm (e.g., the social community algorithm 606 of FIG. 6). The user interface view 1350 may display map of the specific geographic location associated with the user profile of the social community algorithm (e.g., the social community algorithm 606 of FIG. 6). The user interface view 1350 may display the map based geographic location associated with the user profile (e.g., the user profile 1700 of FIG. 17A) only after verifying the address of the registered user of the global neighborhood environment (e.g., the global neighborhood environment 600 of FIG. 6).

In addition, the user interface view 1350 may provide a building creator (e.g., the building builder 2102 of FIG. 21), in which the registered users of the global neighborhood environment (e.g., the global neighborhood environment 600 of FIG. 6) may create and/or modify empty claimable profiles (e.g., a claimable profile 1706 of FIG. 17A-17B, a claimable profile 1802 of FIG. 18A, a claimable profile 2204 of FIG. 22), building layouts, social network pages, etc. The user interface view 1350 of the social community algorithm 606 may enable access to the user (e.g., the user 616 of FIG. 6) to model a condo on any floor (e.g., basement, ground floor, first floor, etc.) selected through the drop down box by the registered user of the global neighborhood environment (e.g., the global neighborhood environment 600 of FIG. 6). The user interface view 1350 of the social community algorithm (e.g., the social community algorithm 606 of FIG. 6) may enable the registered user of the global neighborhood environment (e.g., the global neighborhood environment 600 of FIG. 6) to contribute information about their neighbors (e.g., the neighbor 620 of FIG. 6).

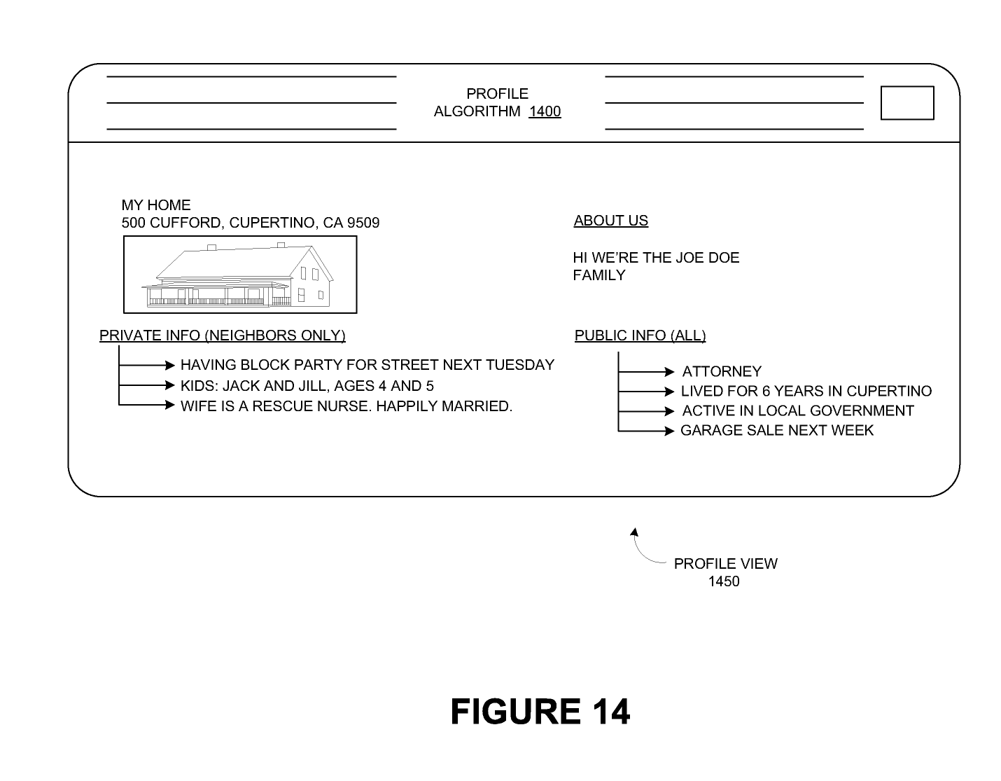

FIG. 14 is a profile view 1450 of a profile algorithm 1400, according to one embodiment. The profile view 1450 of profile algorithm 1400 may offer the registered user to access the profile about the neighbors (e-g., the neighbor 620 of FIG. 6). The profile view 1450 of profile algorithm 1400 may indicate the information associated with the profile of the registered user of the global neighborhood environment (e.g., the global neighborhood environment 600 of FIG. 6). The profile view 1450 may display the address of the registered user. The profile view 1450 may also display events organized by the neighbors (e.g., the neighbor 620 of FIG. 6), history of the neighbors (e.g., the neighbor 620 of FIG. 6), and/or may also offer the information (e.g., public, private, etc.) associated with the family of the neighbors (e.g., the neighbor 620 of FIG. 6) located in the locality of the user (e.g., the user(s) 616 of FIG. 6) of the global neighborhood environment (e.g., the global neighborhood environment 600 of FIG. 6).

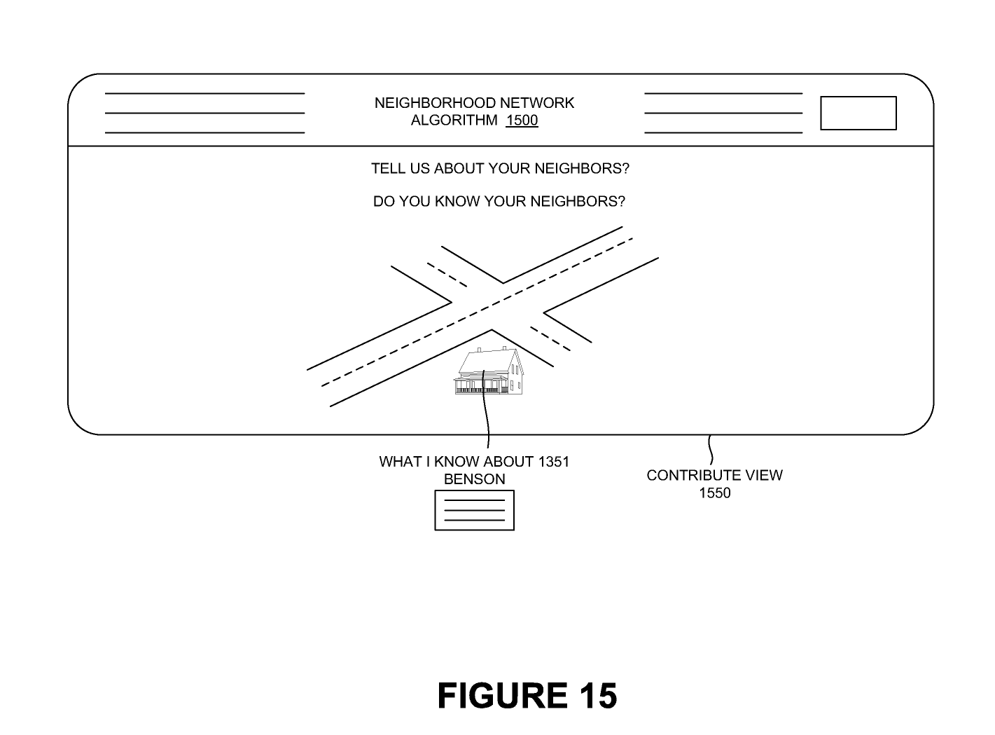

FIG. 15 is a contribute view 1550 of a neighborhood network algorithm 1500, according to one embodiment. The contribute view 1550 of the neighborhood network algorithm 1500 may enable the registered user of the global neighborhood environment (e.g., the global neighborhood environment 600 of FIG. 6) to add information about their neighbors in the neighborhood network. The contribute view 1550 of the neighborhood network algorithm 1500 may offer registered user of the global neighborhood environment (e.g., the global neighborhood environment 600 of FIG. 6) to add valuable notes associated with the family, events, private information, etc.

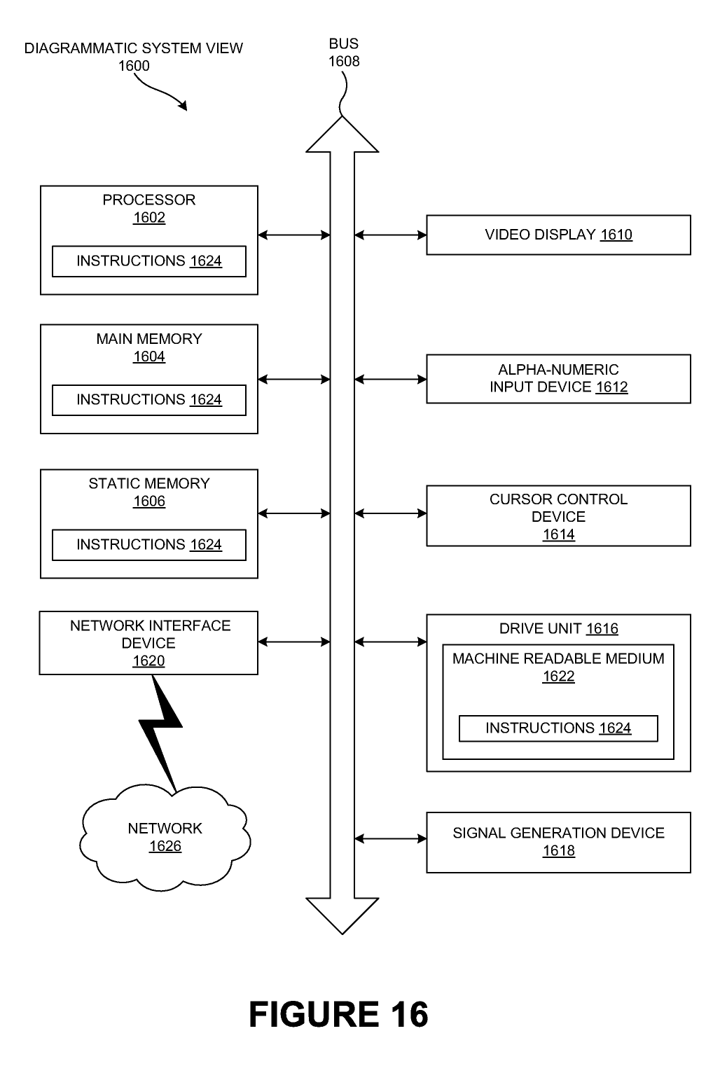

FIG. 16 is a diagrammatic system view, according to one embodiment. FIG. 16 is a diagrammatic system view 1600 of a data processing system in which any of the embodiments disclosed herein may be performed, according to one embodiment. Particularly, the diagrammatic system view 1600 of FIG. 16 illustrates a processor 1602, a main memory 1604, a static memory 1606, a bus 1608, a video display 1610, an alpha-numeric input device 1612, a cursor control device 1614, a drive unit 1616, a signal generation device 1618, a machine readable medium 1622, instructions 1624, and a network 1626, according to one embodiment.

The diagrammatic system view 1600 may indicate a personal computer and/or a data processing system in which one or more operations disclosed herein are performed. The processor 1602 may be microprocessor, a state machine, an application specific integrated circuit, a field programmable gate array, etc. (e.g., Intel® Pentium® processor). The main memory 1604 may be a dynamic random access memory and/or a primary memory of a computer system.

The static memory 1606 may be a hard drive, a flash drive, and/or other memory information associated with the data processing system. The bus 1608 may be an interconnection between various circuits and/or structures of the data processing system. The video display 1610 may provide graphical representation of information on the data processing system. The alpha-numeric input device 1612 may be a keypad, keyboard and/or any other input device of text (e.g., a special device to aid the physically handicapped). The cursor control device 1614 may be a pointing device such as a mouse.

The drive unit 1616 may be a hard drive, a storage system, and/or other longer term storage subsystem. The signal generation device 1618 may be a bios and/or a functional operating system of the data processing system. The machine readable medium 1622 may provide instructions on which any of the methods disclosed herein may be performed. The instructions 1624 may provide source code and/or data code to the processor 1602 to enable any one/or more operations disclosed herein.

FIG. 17A is a user interface view of mapping a user profile 1700 of the geographic location 1704, according to one embodiment. In the example embodiment illustrated in FIG. 17A, the user profile 1700 may contain the information associated with the geographic location 1704. The user profile 1700 may contain the information associated with the registered user. The user profile 1700 may contain information such as address user of the specific geographic location, name of the occupant, profession of the occupant, details, phone number, educational qualification, etc.

The map 1702 may indicate the global neighborhood environment (e.g., the global neighborhood environment 600 of FIG. 6) of the geographical location 1704, a claimable profile 1706 (e.g., the claimable profile 1802 of FIG. 18A, the claimable profile 2204 of FIG. 22), and a de-listed profile 1708. The geographical location 1704 may be associated with the user profile 1700. The claimable profile 1706 may be the claimable profile 1706 associated with the neighboring property surrounding the geographic location 1704. The de-listed profile 1708 illustrated in example embodiment of FIG. 17A, may be the claimable profile 1706 that may be delisted when the registered user claims the physical property. The block 1710 illustrated in the example embodiment of FIG. 17A may be associated with hobbies, personal likes, etc. The block 1716 may be associated with events, requirements, etc. that may be displayed by the members of the global neighborhood environment (e.g., the global neighborhood environment 600 of FIG. 6).

For example, a verified registered user (e.g., a verified registered user 1810 of FIG. 18A-B, a verified registered user 1810 of FIG. 21) may be associated with a user profile 1700. The user profile 1700 may be associated with a specific geographic location. A map concurrently displaying the user profile 1700 and the specific geographic location 1704 may be generated. Also, the claimable profiles 1706 associated with different geographic locations surrounding the specific geographic location associated with the user profile 1700 may be simultaneously generated in the map. In addition, a query of the user profile 1700 and/or the specific geographic location may be processed.

Similarly, a tag data (e.g., the tags 1710 of FIG. 17A) associated with the specific geographic locations, a particular geographic location, and the delisted geographic location may be processed. A frequent one of the tag data (e.g., the tags 1710 of FIG. 17A) may be displayed when the specific geographic location and/or the particular geographic location is made active, but not when a geographic location is delisted.

FIG. 17B is a user interface view of mapping of the claimable profile 1706, according to one embodiment. In the example embodiment illustrated in FIG. 17B, the map 1702 may indicate the geographic locations in the global neighborhood environment (e.g., the global neighborhood environment 600 of FIG. 6) and/or may also indicate the geographic location of the claimable profile 1706. The claimable profile 1706 may display the information associated with the registered user of the global neighborhood environment (e.g., the global neighborhood environment 600 of FIG. 6). The link claim this profile 1712 may enable the registered user to claim the claimable profile 1706 and/or may also allow the verified registered user (e.g., the verified registered user 1810 of FIG. 18) to edit any information in the claimable profiles 1706. The block 1714 may display the information posted by any of the verified registered users (e.g., the verified registered user 1810 of FIG. 18A-B, the verified registered user 1810 of FIG. 21) of the global neighborhood environment (e.g., the global neighborhood environment 600 of FIG. 6).

For example, a particular claimable profile (e.g., the particular claimable profile may be associated with a neighboring property to the specific property in the neighborhood) of the claimable profiles (e.g., the claimable profile 1802 of FIG. 18A, the claimable profile 2204 of FIG. 22) may be converted to another user profile (e.g., the user profile may be tied to a specific property in a neighborhood) when a different registered user (e.g., the user 616 of FIG. 6) claims a particular geographic location to the specific geographic location associated with the particular claimable profile.

In addition, a certain claimable profile of the claimable profiles may be de-listed when a private registered user claims a certain geographic location (e.g., the geographical location 1704 of FIG. 17A) adjacent to the specific geographic location and/or the particular geographic location. Also, the certain claimable profile in the map 1702 may be masked when the certain claimable profile is de-listed through the request of the private registered user.

Furthermore, a tag data (e.g., the tags 1710 of FIG. 17A) associated with the specific geographic location, the particular geographic location, and the de-listed geographic location may be processed. A frequent one of the tag data may be displayed when the specific geographic location and/or the particular geographic location are made active, but not when a geographic location is de-listed.

Moreover, the verified registered user (e.g., the verified registered user 1810 of FIG. 18A-B, the verified registered user 1810 of FIG. 21) may be permitted to edit any information in the claimable profiles 1706 including the particular claimable profile 1706 and/or the certain claimable profile until the certain claimable profile may be claimed by the different registered user and/or the private registered user. In addition, a claimant of any claimable profile 1706 may be enabled to control what information is displayed on their user profile. Also, the claimant may be allowed to segregate certain information on their user profile 1700 such that only other registered users directly connected to the claimant are able to view data on their user profile 1700.

FIG. 18A is a user interface view of mapping of a claimable profile 1802 of the commercial user 1800, according to one embodiment. In the example embodiment illustrated in FIG. 18A, the commercial user 1800 may be associated with the customizable business profile 1804 located in the commercial geographical location. The claimable profile 1802 may contain the information associated with the commercial user 1800. The claimable profile 1802 may contain the information such as address, name, profession, tag, details (e.g., ratings), and educational qualification etc. of the commercial user 1800. The verified registered user 1810 may be user associated with the global neighborhood environment (e.g., the global neighborhood environment 600 of FIG. 6) and may communicate a message to the neighborhood commercial user 1800. For example, a payment of the commercial user 1800 and the verified registered user 1810 may be processed.

FIG. 18B is a user interface view of mapping of customizable business profile 1804 of the commercial user 1800, according to one embodiment. In the example embodiment illustrated in FIG. 18B, the commercial user 1800 may be associated with the customizable business profile 1804. The customizable business profile 1804 may be profile of any business firm (e.g., restaurant, hotels, supermarket, etc.) that may contain information such as address, occupant name, profession of the customizable business. The customizable business profile 1804 may also enable the verified registered user 1810 to place online order for the products.

For example, the commercial user 1800 may be permitted to purchase a customizable business profile 1804 associated with a commercial geographic location. Also, the verified registered user 1810 may be enabled to communicate a message to the global neighborhood environment (e.g., the global neighborhood environment 600 of FIG. 6) based on a selectable distance range away from the specific geographic location. In addition, a payment of the commercial user 1800 and/or the verified registered user 1810 may be processed.

A text advertisement 1806 may display the information associated with the offers and/or events of the customizable business. The display advertisement 1808 may display ads of the products of the customizable business that may be displayed to urge the verified registered user 1810 to buy the products of the customizable business. The verified registered user 1810 may be user associated with the global neighborhood environment (e.g., the global neighborhood environment 600 of FIG. 6) that may communicate a message to the commercial user 1800 and/or may be interested in buying the products of the customizable business.

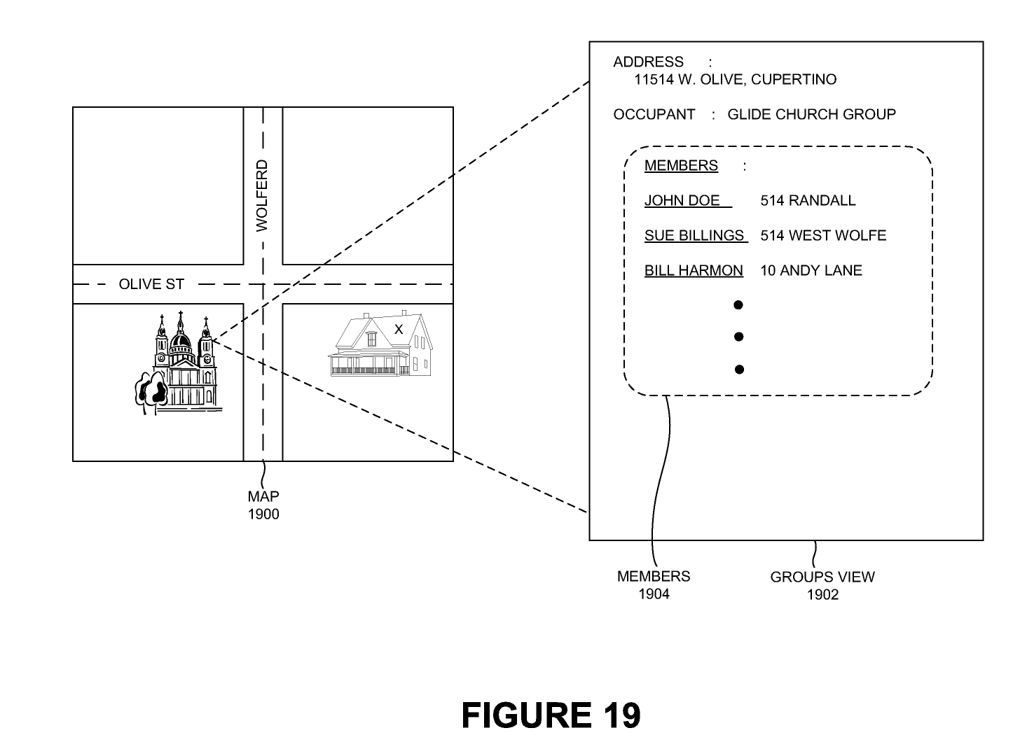

FIG. 19 is a user interface view of a groups view 1902 associated with particular geographical location, according to one embodiment. Particularly FIG. 19 illustrates, a map 1900, a groups view 1902, according to one embodiment. In the example embodiment illustrated in FIG. 19, the map view 1900 may display map view of the geographical location of the specific group of the global neighborhood environment (e.g., the global neighborhood environment 600 of FIG. 6). The groups view 1902 may contain the information (e.g., address, occupant, etc.) associated with the particular group of the specific geographical location (e.g., the geographical location displayed in the map 1900) of the global neighborhood environment (e.g., the global neighborhood environment 600 of FIG. 6). The members 1904 may contain the information about the members associated with the group (e.g., the group associated with geographical location displayed in the map) of the global neighborhood environment (e.g., the global neighborhood environment 600 of FIG. 6).

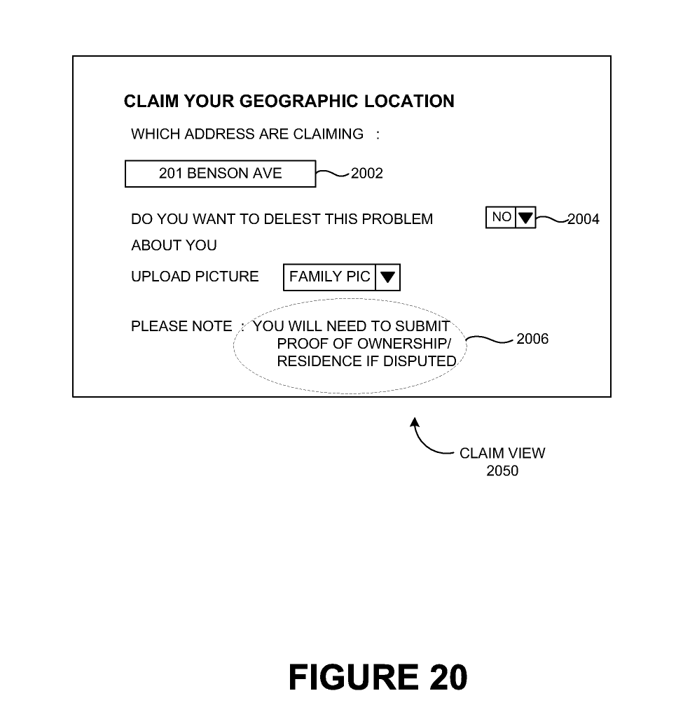

FIG. 20 is a user interface view of claim view 2050, according to one embodiment. The claim view 2050 may enable the user to claim the geographical location of the registered user. Also, the claim view 2050 may facilitate the user of the global neighborhood environment (e.g., the global neighborhood environment 600 of FIG. 6) to claim the geographical location of property under dispute.

In the example embodiment illustrated in FIG. 20, the operation 2002 may allow the registered user of the global neighborhood environment (e.g., the global neighborhood environment 600 of FIG. 6) to claim the address of the geographic location claimed by the registered user. The operation 2004 illustrated in example embodiment of FIG. 20, may enable the user to de-list the claim of the geographical location. The operation 2006 may offer information associated with the document to be submitted by the registered users of the global neighborhood environment (e.g., the global neighborhood environment 600 of FIG. 6) to claim the geographical location.

FIG. 21 is a user interface view of a building builder 2102, according to one embodiment. Particularly the FIG. 21 illustrates, a map 2100, a building builder 2102, according to one embodiment. The map 2100 may display the geographical location in which the verified registered user (e.g., the verified registered user 1810 of FIG. 18AB) may create and/or modify empty claimable profiles (e.g., the claimable profile 1706 of FIG. 17A-17B, the claimable profile 1802 of FIG. 18A, the claimable profile 2204 of FIG. 22), building layouts, social network pages, and floor levels structures housing residents and businesses in the neighborhood (e.g., the neighborhood 602A-N of FIG. 6). The building builder 2 102 may enable the verified registered users (e.g., the verified registered user 1810 of FIG. 18A-B) of the global neighborhood environment (e.g., the global neighborhood environment 600 of FIG. 6) to draw floor level structures, add neighbor's profiles and/or may also enable to select the floor number, claimable type, etc. as illustrated in example embodiment of FIG. 21.

The verified registered user 1810 may be verified registered user of the global neighborhood environment (e.g., the global neighborhood environment 600 of FIG. 6) interested in creating and/or modifying claimable profiles (e.g., the claimable profile 1706 of FIG. 17A-17B, the claimable profile 1802 of FIG. 18A, the claimable profile 2204 of FIG. 22), building layouts, social network pages, and floor level structure housing residents and businesses in the neighborhood (e.g., the neighborhood 602A-N of FIG. 6) in the building builder 2102.

For example, a social community algorithm (e.g., a social community algorithm 606 of FIG. 6) of the global neighborhood environment (e.g., the global neighborhood environment 600 of FIG. 6) may generate a building creator (e.g., the building builder 2102 of FIG. 21) in which the registered users may create and/or modify empty claimable profiles (e.g., the claimable profile 1706 of FIG. 17A-17B, the claimable profile 1802 of FIG. 18A, the claimable profile 2204 of FIG. 22), building layouts, social network pages, and floor levels structures housing residents and/or businesses in the neighborhood (e.g., the neighborhood 602A-N of FIG. 6).

FIG. 22 is a systematic view of communication of claimable data, according to one embodiment. Particularly FIG. 22 illustrates a map 2201, verified user profile 2202, choices 2208 and a new claimable page 2206, according to one embodiment. The map 2201 may locate the details of the address of the registered user of the global neighborhood environment (e.g., the global neighborhood environment 600 of FIG. 6). The verified user profile 2202 may store the profiles of the verified user of the global neighborhood environment (e.g., the global neighborhood environment 600 of FIG. 6. The claimable profile 2204 may be the profiles of the registered user who may claim them in the global neighborhood environment (e.g., the global neighborhood environment 600 of FIG. 6).

In operation 2200 the search for the user profile (e.g., the user profile 1700 of FIG. 17A) may be carried out by the registered user. The new claimable page 2206 may solicit for the details of a user whom the registered user is searching for in the global neighborhood environment (e.g., the global neighborhood environment 600 of FIG. 6). The choices 2208 may ask whether the requested search is any among the displayed names. The new claimable page 2206 may request for the details of location such as country, state and/or city. The operation 2200 may communicate with the choices 2208, and the new claimable page 2206.

For example, a no-match algorithm (e.g., a no-match algorithm 812 of FIG. 8) of the search algorithm (e.g., the search algorithm 608 of FIG. 6)to request additional information from the verified registered user about a person, place, and business having no listing in the global neighborhood environment (e.g., the global neighborhood environment 600 of FIG. 6) when no matches are found in a search query of the verified registered user (e.g., the verified registered user 1810 of FIG. 18A-B), and to create a new claimable page 2206 based on a response of the verified registered user 2202 about the at least one person, place, and business not previously indexed in the global neighborhood environment (e.g., the global neighborhood environment 600 of FIG. 6).

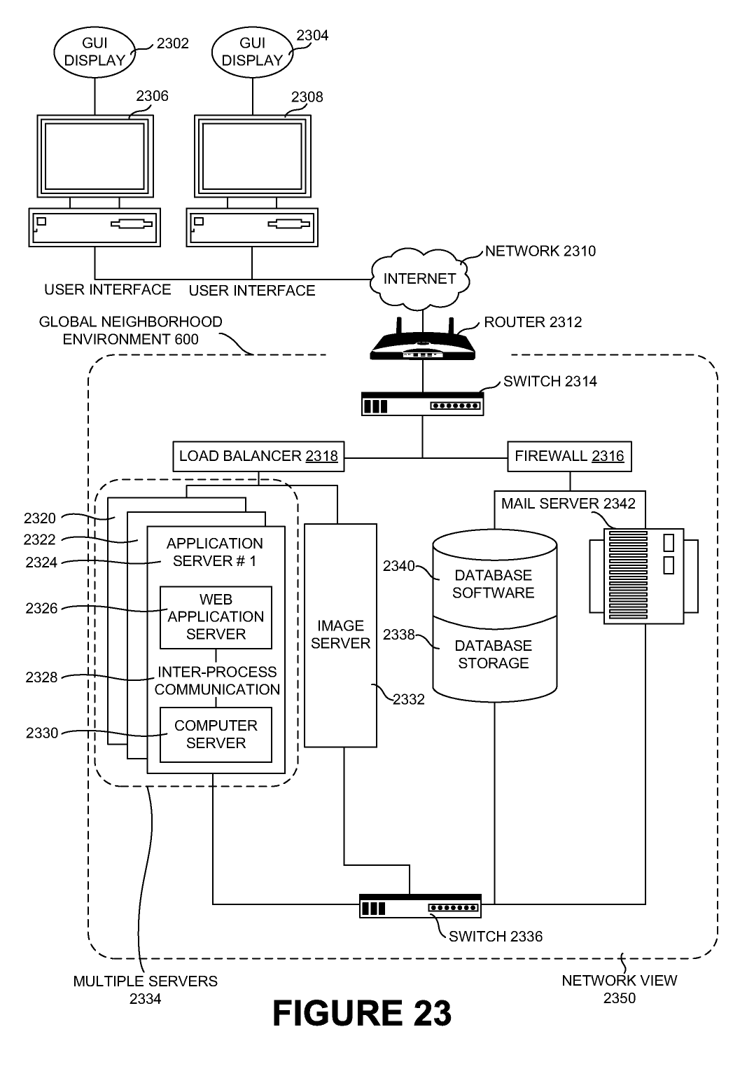

FIG. 23 is a systematic view of a network view 2350, according to one embodiment. Particularly it may include a GUI display 2302, a GUI display 2304, user interface 2306, a user interface 2308, a network 2310, a router 2312, a switch 2314, a firewall 2316, a load balancer 2318, an application server #3 2320, an application server #2 2322, an application server #1 2324, a web application server 2326, an inter-process communication 2328, a computer server 2330, an image server 2332, a multiple servers 2334, a switch 2336, a database storage 2338, database software 2340 and a mail sewer 2342, according to one embodiment.

The GUI display 2302 and GUI display 2304 may display particular case of user interface for interacting with a device capable of representing data (e.g., computer, cellular telephones, television sets etc.) which employs graphical images and widgets in addition to text to represent the information and actions available to the user (e.g., the user 616 of FIG. 6). The user interface 2306 and user interface 2308 may be any device capable of presenting data (e.g., computer, cellular telephones, television sets etc.). The network 2310 may be any collection of networks (e.g., internet, private networks, university social system, private network of a company etc.) that may transfer any data to the user (e.g., the user 616 of FIG. 6) and the global neighborhood environment (e.g., the global neighborhood environment 600 of FIG. 6).

The router 2312 may forward packets between networks and/or information packets between the global neighborhood environment (e.g., the global neighborhood environment 600 of FIG. 6) and registered user over the network (e.g., internet). The switch 2314 may act as a gatekeeper to and from the network (e.g., internet) and the device. The firewall 2316 may provides protection (e.g., permit, deny or proxydata connections) from unauthorized access to the global neighborhood environment (e.g., the global neighborhood environment 600 of FIG. 6. The load balancer 2318 may balance the traffic load across multiple mirrored servers in the global neighborhood environment (e.g., the global neighborhood environment 600 of FIG. 6) and may be used to increase the capacity of a server farm beyond that of a single server and/or may allow the service to continue even in the face of server down time due to server failure and/or server maintenance.

The application server 2322 may be server computer on a computer network dedicated to running certain software applications of the global neighborhood environment (e.g., the global neighborhood environment 600 of FIG. 6). The web application server 2326 may be server holding all the web pages associated with the global neighborhood environment (e.g., the global neighborhood environment 600 of FIG. 6). The inter-process communication 2328 may be set of rules for organizing and un-organizing factors and results regarding the global neighborhood environment (e.g., the global neighborhood environment 600 of FIG. 6). The computer server 2330 may serve as the application layer in the multiple servers of the global neighborhood environment (e.g., the global neighborhood environment 600 of FIG. 6) and/or may include a central processing unit (CPU), a random access memory (RAM) temporary storage of information, and/or a read only memory (ROM) for permanent storage of information regarding the global neighborhood environment (e.g., the global neighborhood environment 600 of FIG. 6).

The image server 2332 may store and provide digital images of the registered user of the global neighborhood environment (e.g., the global neighborhood environment 600 of FIG. 6). The multiple servers 2334 may be multiple computers or devices on a network that may manage network resources connecting the registered user and the global neighborhood environment (e.g., the global neighborhood environment 600 of FIG. 6). The database storage 2338 may store software, descriptive data, digital images, system data and any other data item that may be related to the user (e.g., the user 616 of FIG. 6) of the global neighborhood environment (e.g., the global neighborhood environment 600 of FIG. 6). The database software 2340 may be provided a database management system that may support the global neighborhood environment (e.g., the global neighborhood environment 600 of FIG. 6). The mail server 2342 may be provided for sending, receiving and storing mails. The user interface 2306 and 2308 may communicate with the GUI display(s) 2302 and 2304, the router 2312 through the network 2310 and the global neighborhood environment (e.g., the global neighborhood environment 600 of FIG. 6).

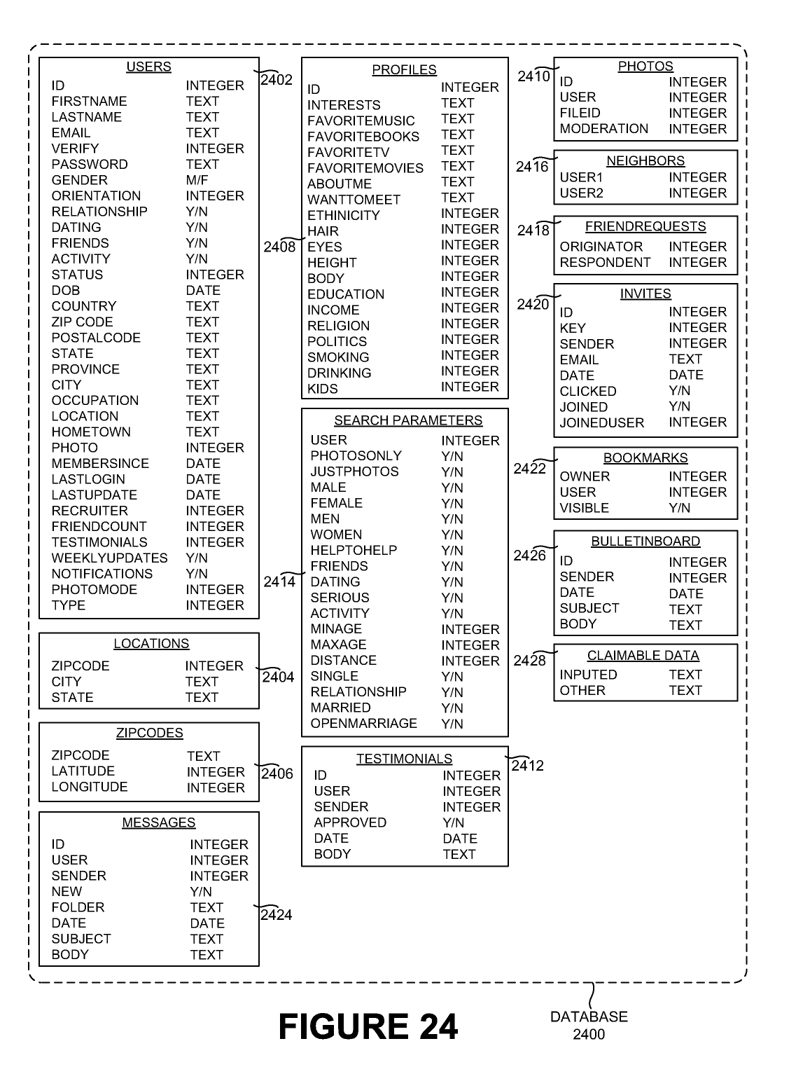

FIG. 24 is a block diagram of a database, according to one embodiment. Particularly the block diagram of the database 2400 of FIG. 24 illustrates a user data 2402, a location data, a zip codes data 2406, a profiles data 2408, a photos data 2410, a testimonials data 24 12, a search parameters data 241 4, a neighbor's data 24 16, a friends requests data 24 18, a invites data 2420, a bookmarks data 2422, a message data 2424 and a bulletin board data 2426, and a claimable data 2428, according to one embodiment.

The database 2400 be may include descriptive data, preference data, relationship data, and/or other data items regarding the registered user of the global neighborhood environment (e.g., the global neighborhood environment 600 of FIG. 6.

The user data 2402 maybe a descriptive data referring to information that may describe a user (e.g., the user 616 of FIG. 6). It may include elements in a certain format for example Id may be formatted as integer, Firstname may be in text, Lastname may be in text, Email may be in text, Verify may be in integer, Password may be in text, Gender may be in mlf, Orientation may be in integer, Relationship may be in y/n, Dating may be in y/n, Friends may be in y/n, Activity may be in y/n, Status may be in integer, Dob may be in date, Country may be in text, Zipcode may be in text, Postalcode may be in text, State may be in text, Province may be in text, City may be in text, Occupation may be in text, Location may be in text, Hometown may be in text, Photo may be in integer, Membersince may be in date, Lastlogin may be in date, Lastupdate may be in date, Recruiter may be in integer, Friendcount may be in integer, Testimonials may be in integer, Weeklypdates may be in y/n, Notifications may be in y/n, Photomode may be in integer and/or Type may be in integer.

The locations data 2404 may clarify the location details in formatted approach. For example Zip code may be formatted as integer, City may be in text and/or State may be in text. The zip codes data 2406 may provide information of a user location in formatted manner. For example Zip code may be formatted as text, Latitude may be in integer and/or Longitude may be in integer. The profiles data 2408 may clutch personnel descriptive data that may be formatted.

For examples ID may be formatted as integer, Interests may be in text, Favoritemusic may be in text, Favaoritebooks may be in text, Favoritetv may be in text, Favoritemovies may be in text, Aboutme may be in text, Wanttomeet may be in text, Ethnicity may be in integer, Hair may be in integer, Eyes may be in integer, Height may be in integer, Body may be in integer, Education may be in integer, Income may be in integer, Religion may be in integer, Politics may be in integer Smoking may be in integer, Drinking may be in integer and/or Kids may be in integer.

The photos data 2410 may represent a digital image and/or a photograph of the user formatted in certain approach. For example Id may be formatted as integer, User may be in integer, Fileid may be in integer and/or Moderation may be in integer. The testimonials data 24 12 may allow users to write “testimonials” 24 12, or comments, about each other and in these testimonials, users may describe their relationship to an individual and their comments about that individual. For example the user might write a testimonial that states “Rohan has been a friend of mine since graduation days. He is smart, intelligent, and a talented person.” The elements of testimonials data 24 12 may be formatted as Id may be in integer, User may be in integer, Sender may be integer, Approved may be in yln, Date may be in date and/or Body may be formatted in text.

The search parameters data 24 14 may be preference data referring to the data that may describe preferences one user has with respect to another (For example, the user may indicate that he is looking for a female who is seeking a male for a serious relationship). The elements of the search parameters data 2414 may be formatted as User data 2402 may be in integer, Photosonly may be in y/n, Justphotos may be in y/n, Male may be in y/n, Female may be in y/n, Men may be in y/n, Women may be in y/n, Helptohelp may be in y/n, Friends may be in y/n, Dating may be in y/n, Serious may be in y/n, Activity may be in y/n, Minage may be in integer, Maxage may be in integer, Distance may be in integer, Single may be in yln, Relationship may be in y/n, Married may be in y/n and/or Openmarriage may be in y/n.

The neighbor's data 2416 may generally refer to relationships among registered users of the global neighborhood environment (e.g., the global neighborhood environment 600 of FIG. 6) that have been verified and the user has requested another individual to join the system as neighbor's data 2416, and the request may be accepted. The elements of the neighbor's data 241 6 may be formatted as user1 may be in integer and/or user2 may be in integer. The friend requests data 2418 may tracks requests by users within the neighborhood (e.g., the neighborhood 602A-N of FIG. 6) to other individuals, which requests have not yet been accepted and may contain elements originator and/or respondent formatted in integer. The invites data 2420 may describe the status of a request by the user to invite an individual outside the neighborhood (e.g., the neighborhood 602A-N of FIG. 6) to join the neighborhood (e.g., the neighborhood 602A-N of FIG. 6) and clarify either the request has been accepted, ignored and/or pending.

The elements of the invites data 2420 may be formatted as Id may be in integer, Key may be in integer, Sender may be in integer, Email may be in text, Date may be in date format, Clicked may be in y/n, Joined may be in y/n and/or Joineduser may be in integer. The bookmarks data 2422 may provide the data for a process allowed wherein a registered user of the global neighborhood environment (e.g., the global neighborhood environment 600 of FIG. 6) may indicate an interest in the profile of another registered user. The bookmarks data 2422 elements may be formatted as Owner may be in integer, User may be in integer and/or Visible may be in y/n. The message data 2424 may allow the users to send one another private messages.

The message data 2424 may be formatted as Id may be in integer, (e.g., User may be in integer, Sender may be in integer, New may be in y/n, Folder may be in text, Date may be in date format, Subject may be in text and/or Body may be in text format) The bulletin board data 2426 may support the function of a bulletin board that users may use to conduct online discussions, conversation and/or debate. The claimable data 2428 may share the user profiles (e.g., the user profile 1700 of FIG. 17A) in the neighborhood (e.g., the neighborhood 602A-N of FIG. 6) and its elements may be formatted as claimables inputted and/or others may be in text format.

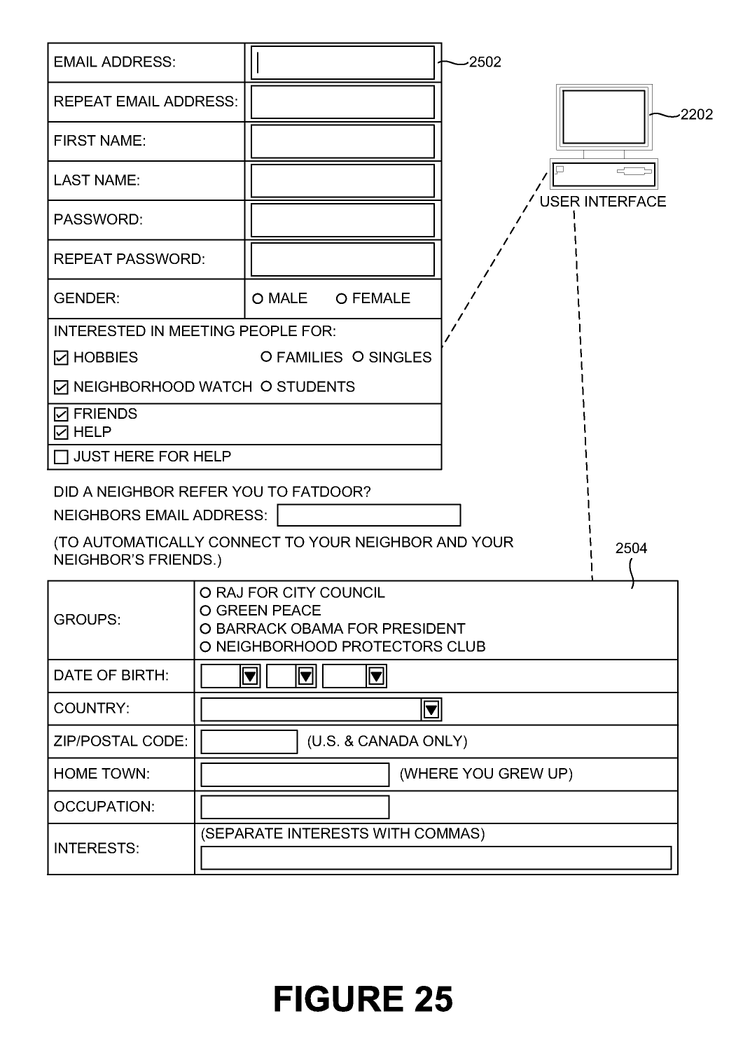

FIG. 25 is an exemplary graphical user interface view for data collection, according to one embodiment. Particularly FIG. 25 illustrates exemplary screens 2502, 2504 that may be provided to the user (e.g., the user 616 of FIG. 6) through an interface may be through the network (e.g., Internet), to obtain user descriptive data. The screen 2502 may collect data allowing the user (e.g., the user 616 of FIG. 6) to login securely and be identified by the neighborhood (e.g., the neighborhood 602A-N of FIG. 1). This screen 2502 may allow the user to identify the reason he/she is joining the neighborhood. For example, a user may be joining the neighborhood for “neighborhood watch”. The screen 2504 may show example of how further groups may be joined. For example, the user (e.g., the user 61 6 of FIG. 6) may be willing to join a group “Raj for city council”. It may also enclose the data concerning Dob, country, zip/postal code, hometown, occupation and/or interest.

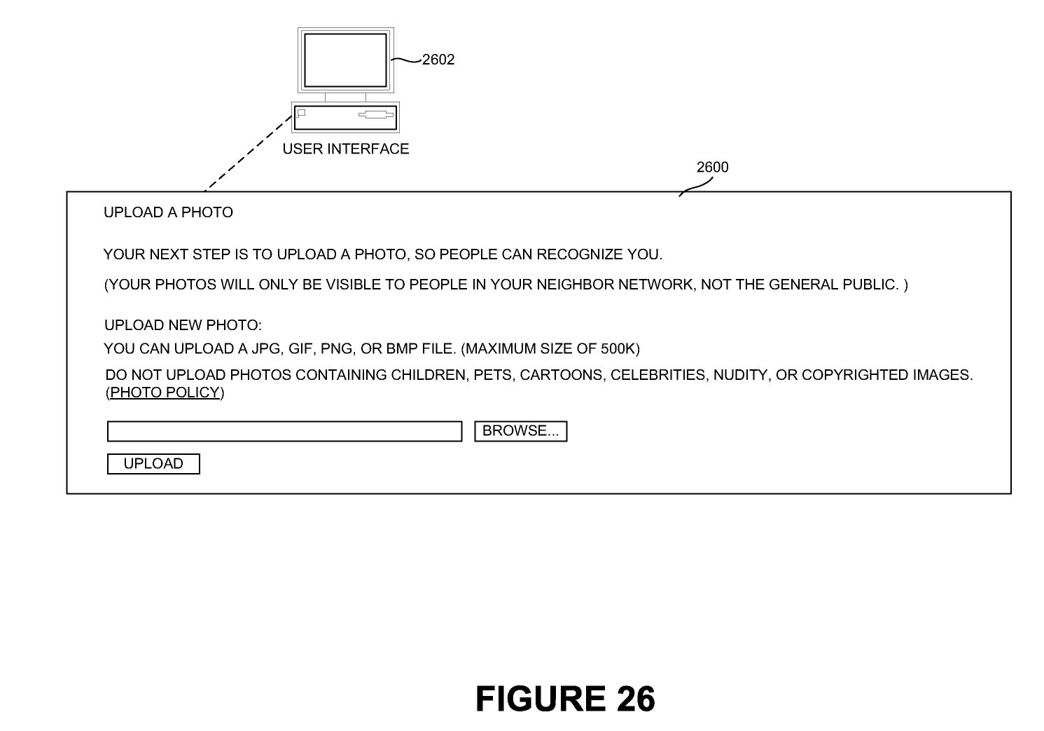

FIG. 26 is an exemplary graphical user interface view of image collection, according to one embodiment. A screen 2600 may be interface provided to the user (e.g., the user 616 of FIG. 6) over the network (e.g., internet) may be to obtain digital images from system user. The interface 2602 may allow the user (e.g., the user 616 of FIG. 6) to browse files on his/her computer, select them, and then upload them to the neighborhood (e.g., the neighborhood 602A-N of FIG. 6). The user (e.g., the user 616 of FIG. 6) may upload the digital images and/or photo that may be visible to people in the neighbor (e.g., the neighbor 620 of FIG. 6) network and not the general public. The user may be able to upload a JPG, GIF, PNG and/or BMP file in the screen 2600.

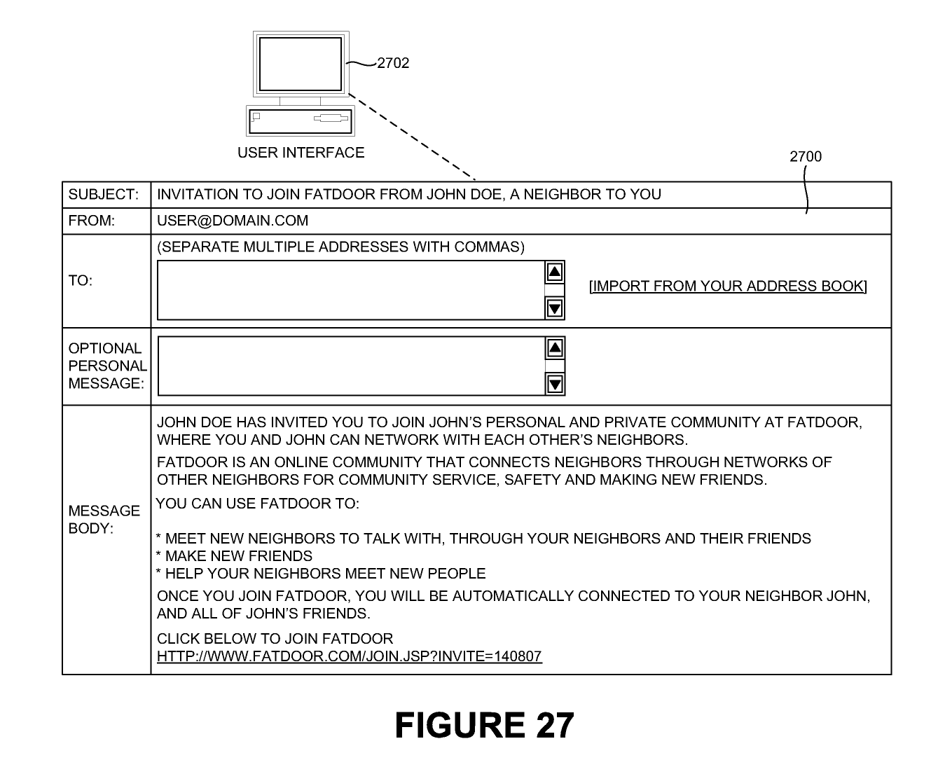

FIG. 27 is an exemplary graphical user interface view of an invitation, according to one embodiment. An exemplary screen 2700 may be provided to a user through a user interface 2702 may be over the network (e.g., internet) to allow users to invite neighbor or acquaintances to join the neighborhood (e.g., the neighborhood 602AN of FIG. 6). The user interface 2702 may allow the user (e.g., the user 616 of FIG. 6) to enter one or a plurality of e-mail addresses for friends they may like to invite to the neighborhood (e.g., the neighborhood 602A-N of FIG. 6). The exemplary screen 2700 may include the “subject”, “From”, “To”, “Optional personnel message”, and/or “Message body” sections. In the “Subject” section a standard language text may be included for joining the neighborhood (e.g., Invitation to join Fatdoor from John Doe, a neighborhood.).

The “From” section may include the senders email id (e.g., user@domain.com). The “To” section may be provided to add the email id of the person whom the sender may want to join the neighborhood (e.g., the neighborhood 602A-N of FIG. 6). The message that may be sent to the friends and/or acquaintances may include standard language describing the present neighborhood, the benefits of joining and the steps required to join the neighborhood (e.g., the neighborhood 602A-N of FIG. 6). The user (e.g., the user 616 of FIG. 6) may choose to include a personal message, along with the standard invitation in the “Optional personal message” section. In the “Message body” section the invited friend or acquaintance may initiate the process to join the system by clicking directly on an HTML link included in the e-mail message (e.g., http://www.fatdoor.com/join.jsp? Invite=140807). In one embodiment, the user (e.g., the user 616 of FIG. 6) may import e-mail addresses from a standard computerized address book. The system may further notify the inviting user when her invitee accepts or declines the invitation to join the neighborhood (e.g., the neighborhood 602A-N of FIG. 6).

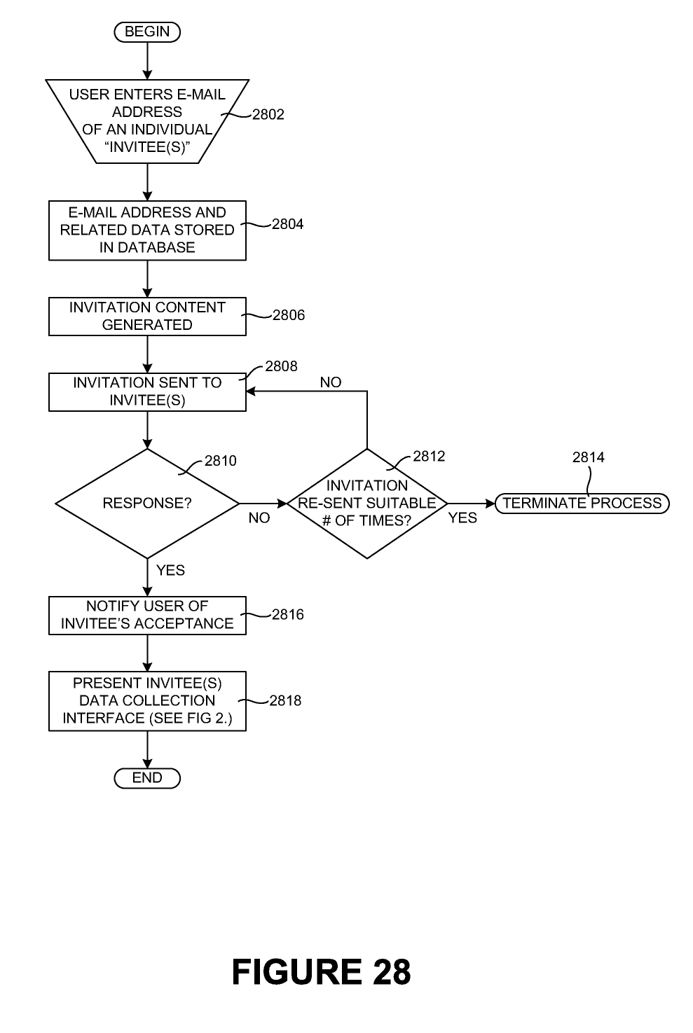

FIG. 28 is a flowchart of inviting the invitee(s) by the registered user, notifying the registered user upon the acceptance of the invitation by the invitee(s) and, processing and storing the input data associated with the user (e.g., the user 616 of FIG. 6) in the database, according to one embodiment. In operation 2802, the verified registered user (e.g., the verified registered user 1810 of FIG. 18A-B, the verified registered user 1810 of FIG. 21) willing to invite the individual enters the email addresses of an individual “invitee”. In operation 2804, the email address and the related data of the invitee may be stored in the database. In operation 2806, the invitation content for inviting the invitee may be generated from the data stored in the database. In operation 2808, the registered user sends invitation to the invitee(s).

In operation 2810, response from the user (e.g., the user 616 of FIG. 6) may be determined. In operation 2812, if the invitee doesn't respond to invitation sent by the registered user then registered user may resend the invitation for a predefined number of times. In operation 28 14, if the registered user resends the invitation to the same invitee for predefined number of times and if the invitee still doesn't respond to the invitation the process may be terminated automatically.

In operation 2816, if the invitee accepts the invitation sent by the registered user then system may notify the registered user that the invitee has accepted the invitation. In operation 2818, the input from the present invitee(s) that may contain the descriptive data about the friend (e.g., registered user) may be processed and stored in the database.

For example, each registered user associated e-mail addresses of individuals who are not registered users may be stored and identified by each registered user as neighbors. An invitation to become a new user (e.g., the user 616 of FIG. 6) may be communicated out to neighbor (e.g., the neighbors neighbor of FIG. 6) of the particular user. An acceptance of the neighbor (e.g., the neighbor 620 of FIG. 6) to whom the invitation was sent may be processed.

The neighbor (e.g., the neighbor 620 of FIG. 6) may be added to a database and/or storing of the neighbor (e.g., the neighbor 620 of FIG. 6), a user ID and a set of user IDS of registered users who are directly connected to the neighbor (e.g., the neighbor 620 of FIG. 6), the set of user IDS stored of the neighbor (e.g., the neighbor 620 of FIG. 6) including at least the user ID of the verified registered user (e.g., the verified registered user 1810 of FIG. 18A-B, the verified registered user 1810 of FIG. 21). Furthermore, the verified registered user may be notified that the invitation to the neighbor (e.g., the neighbor 620 of FIG. 6) has been accepted when an acceptance is processed. Also, inputs from the neighbor (e.g., the neighbor 620 of FIG. 6) having descriptive data about the friend may be processed and the inputs in the database may be stored.

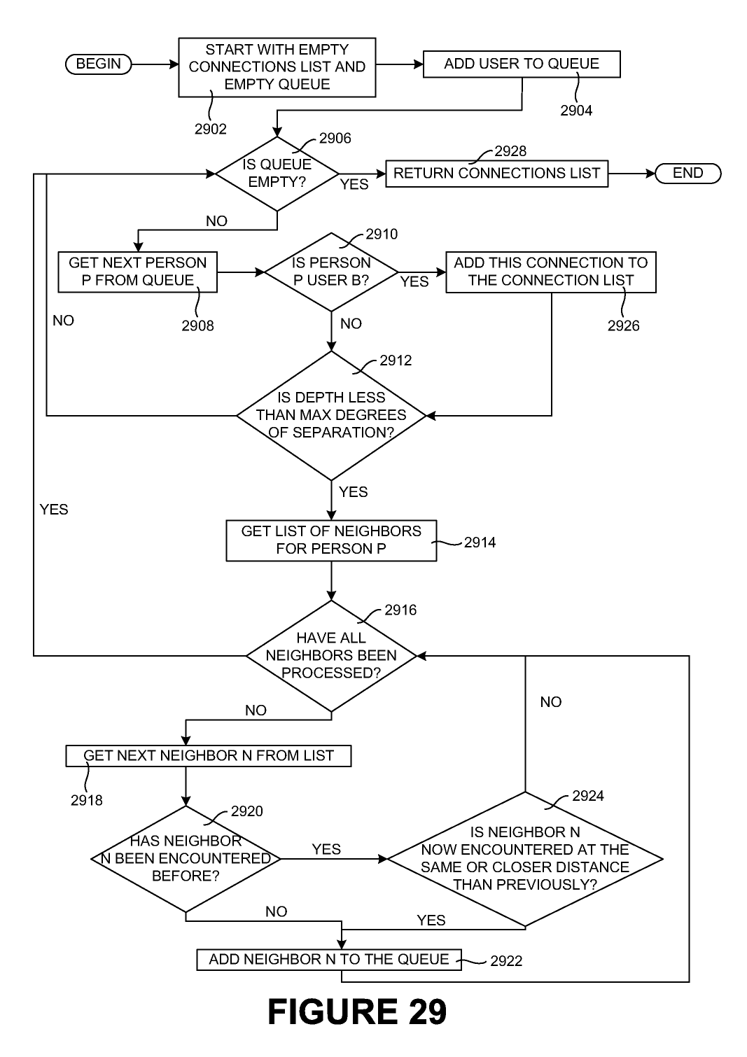

FIG. 29 is a flowchart of adding the neighbor (e.g., the neighbor 620 of FIG. 6) to the queue, according to one embodiment. In operation 2902, the system may start with the empty connection list and empty queue. In operation 2904, the user may be added to the queue. In operation 2906, it is determined whether the queue is empty. In operation 2908, if it is determined that the queue is not empty then the next person P may be taken from the queue. In operation 291 0, it may be determined whether the person P from the queue is user B or not. In operation 2912, if the person P is not user B then it may be determined whether the depth of the geographical location is less than maximum degrees of separation.

If it is determined that depth is more than maximum allowable degrees of separation then it may repeat the operation 2906. In operation 2914, it may be determined that the depth of the geographical location (e.g., the geographical location 1704 of FIG. 12A) is less than maximum degrees of separation then the neighbors (e.g., the neighbor 620 of FIG. 6) list for person P may be processed. In operation 2916, it may be determined whether all the neighbors (e.g., the neighbor 620 of FIG. 6) in the neighborhood (e.g., the neighborhood 602A-N of FIG. 6) have been processed or not. If all the friends are processed it may be determined the queue is empty.

In operation 291 8, if all the neighbors (e.g., the neighbor 620 of FIG. 6) for person P are not processed then next neighbor N may be taken from the list. In operation 2920, it may be determined whether the neighbor N (e.g., the neighbor 620 of FIG. 6) has encountered before or not. In operation 2922, if the neighbor (e.g., the neighbor 620 of FIG. 6) has not been encountered before then the neighbor may be added to the queue. In operation 2924, if the neighbor N has been encountered before it may be further determined whether the geographical location (e.g., the geographical location 1704 of FIG. 17A) from where the neighbor (e.g., the neighbor 620 of FIG. 6) has encountered previously is the same place or closer to that place.

If it is determined that the neighbor (e.g., the neighbor 620 of FIG. 6) has encountered at the same or closer place then the friend may be added to the queue. If it may be determined that friend is not encountered at the same place or closer to that place then it may be again checked that all the friends have processed. In operation 2926, if it is determined that the person P is user B than the connection may be added to the connection list and after adding the connection to connection list it follows the operation 2912. In operation 2928, if it may be determined that queue is empty then the operation may return the connections list.

For example, a first user ID with the verified registered user (e.g., the verified registered user 1810 of FIG. 18A-B, the verified registered user 1810 of FIG. 21) and a second user ID may be applied to the different registered user. The verified registered user (e.g., the verified registered user 1810 of FIG. 18A-B, the verified registered user 1810 of FIG. 21) with the different registered user may be connected with each other through at least one of a geo-positioning data associated with the first user ID and the second user ID. In addition, a maximum degree of separation (Nmax) of at least two that is allowed for connecting any two registered users, (e.g., the two registered users who may be directly connected may be deemed to be separated by one degree of separation and two registered users who may be connected through no less than one other registered user may be deemed to be separated by two degrees of separation and two registered users who may be connected through not less than N other registered users may be deemed to be separated by N+1 degrees of separation).

Furthermore, the user ID of the different registered user may be searched (e.g., the method limits the searching of the different registered user in the sets of user IDS that may be stored as registered users who are less than Nmax degrees of separation away from the verified registered user such that the verified registered user and the different registered user who may be separated by more than Nmax degrees of separation are not found and connected.) in a set of user IDS that may be stored of registered users who are less than Nmax degrees of separation away from the verified registered user and not in the sets of user IDS that may be stored for registered users who are greater than or equal to Nmax degrees of separation away from the verified registered user, until the user ID of the different registered user may be found in one of the searched sets. Also, the verified registered user (e.g., the verified registered user 1810 of FIG. 18A-B, the verified registered user 1810 of FIG. 21) may be connected to the different registered user if the user ID of the different registered user may be found in one of the searched sets.

Moreover, the sets of user IDS that may be stored of registered users may be searched initially who are directly connected to the verified registered user (e.g., the verified registered user 1810 of FIG. 18A-B, the verified registered user 1810 of FIG. 21). A profile of the different registered user may be communicated to the verified registered user (e.g., the verified registered user 1810 of FIG. 18A-B, the verified registered user 1810 of FIG. 21) to display through a marker associating the verified registered user (e.g., the verified registered user 1810 of FIG. 18A-B, the verified registered user 1810 of FIG. 21) with the different registered user. A connection path between the verified registered user (e.g., the verified registered user 1810 of FIG. 18A-B, the verified registered user 1810 of FIG. 21) and the different registered user, the connection path indicating at least one other registered user may be stored through whom the connection path between the verified registered user (e.g., the verified registered user 1810 of FIG. 18A-B, the verified registered user 1810 of FIG. 21) and the different registered user is made.

In addition, the connection path between the verified registered user (e.g., the verified registered user 1810 of FIG. 18A-B, the verified registered user 1810 of FIG. 21) and the different registered user may be communicated to the verified registered user to display. A hyperlink in the connection path of each of the at least one registered users may be embedded through whom the connection path between the verified registered user (e.g., the verified registered user 1810 of FIG. 18A-B, the verified registered user 1810 of FIG. 21) and the different registered user is made.

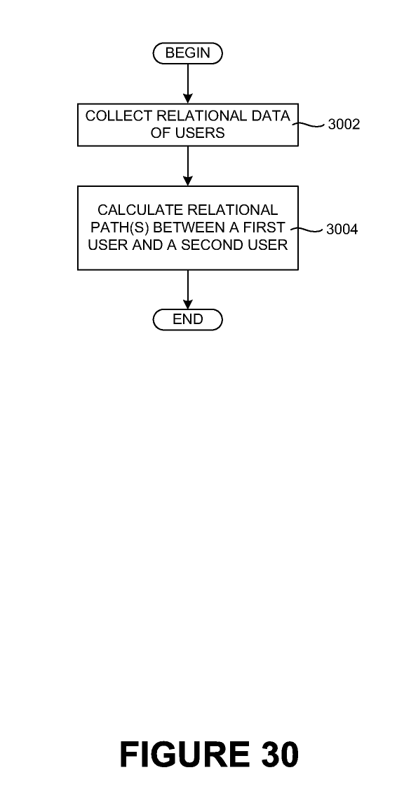

FIG. 30 is a flowchart of communicating brief profiles of the registered users, processing a hyperlink selection from the verified registered user (e.g., the verified registered user 1810 of FIG. 18A-B) the verified registered user 1810 of FIG. 21) and calculating and ensuring the Nmax degree of separation of the registered users away from verified registered users (e.g., the verified registered user 1810 of FIG. 18A-B, the verified registered user 1810 of FIG. 21), according to one embodiment. In operation 3002, the data of the registered users may be collected from the database. In operation 3004, the relational path between the first user and the second user may be calculated (e.g., the Nmax degree of separation between verified registered user (e.g., the verified registered user 1810 of FIG. 18A-B, the verified registered user 1810 of FIG. 21) and the registered user).

For example, the brief profiles of registered users, including a brief profile of the different registered user, to the verified registered user (e.g., the verified registered user 1810 of FIG. 18A-B, the verified registered user 1810 of FIG. 21) for display, each of the brief profiles including a hyperlink to a corresponding full profile may be communicated.

Furthermore, the hyperlink selection from the verified registered user (e.g., the verified registered user 1810 of FIG. 18A-B, the verified registered user 1810 of FIG. 21) may be processed (e.g., upon processing the hyperlink selection of the full profile of the different registered user, the full profile of the different registered user may be communicated to the verified registered user (e.g., the verified registered user 1810 of FIG. 18A-B, the verified registered user 1810 of FIG. 21) for display). In addition, the brief profiles of those registered users may be ensured who are more than Nmax degrees of separation away from the verified registered user (e.g., the verified registered user 1810 of FIG. 18A-B, the verified registered user 1810 of FIG. 21) are not communicated to the verified registered user (e.g., the verified registered user 1810 of FIG. 18A-B, the verified registered user 1810 of FIG. 21) for display.

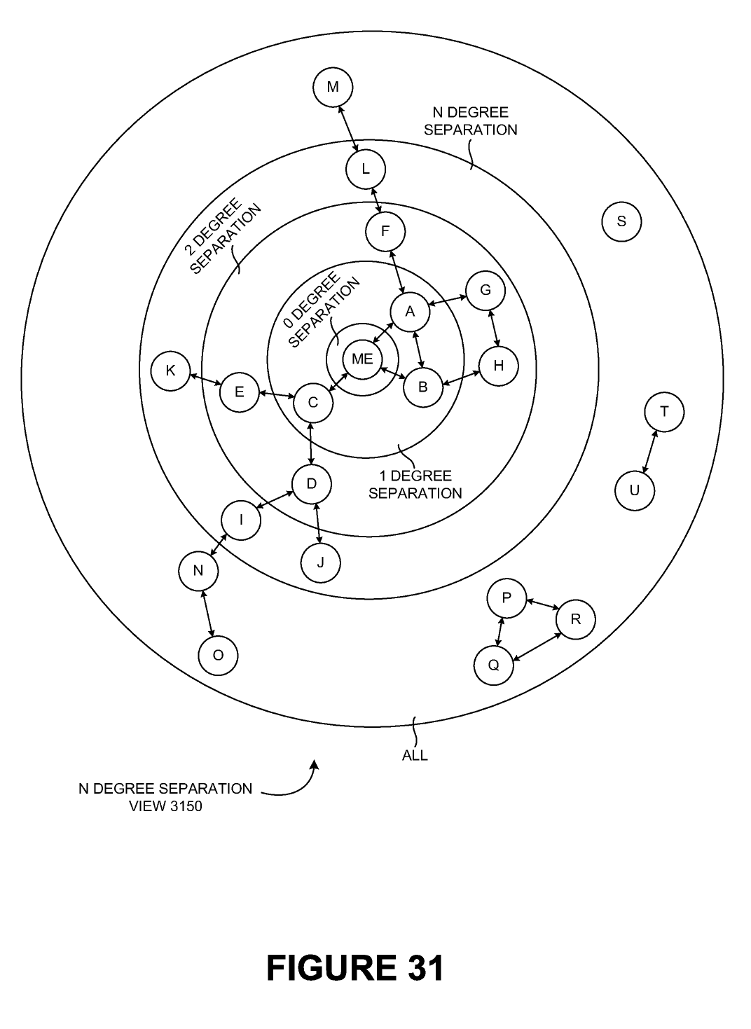

FIG. 31 is an N degree separation view 3150, according to one embodiment. ME may be a verified registered user (e.g., the verified registered user 1810 of FIG. 18A-B, the verified registered user 1810 of FIG. 21) of the global neighborhood environment (e.g., the global neighborhood environment 600 of FIG. 6) centered in the neighborhood network. A, B, C, D, E, F, G, H, I, J, K, L, M, N, O, P, Q, R, S, T, and/or U may be the other registered user of the neighborhood network. The member of the neighborhood network may be separated from the centered verified registered user (e.g., the verified registered user 1810 of FIG. 18A-B, the verified registered user 1810 of FIG. 21) ME of the neighborhood network by certain degree of separation. The registered user A, B and C may be directly connected and may be deemed to be separated by one degree of separation from verified registered user (e.g., the verified registered user 1810 of FIG. 18A-B, the verified registered user 1810 of FIG. 21) ME. The registered user D, E, F, G, and H may be connected through no less than one other registered user may be deemed to be separated by two degree of separation from verified registered user (e.g., the verified registered user 1810 of FIG. 18A-B) the verified registered user 1810 of FIG. 21) ME. The registered user I, J, K, and L may be connected through no less than N−1 other registered user and may be deemed to be separated by N degree of separation from verified registered user (e.g., the verified registered user 1810 of FIG. 18A-B, the verified registered user 1810 of FIG. 21) ME. The registered user M, N, O, P, Q, R S, T and U may be all registered user.

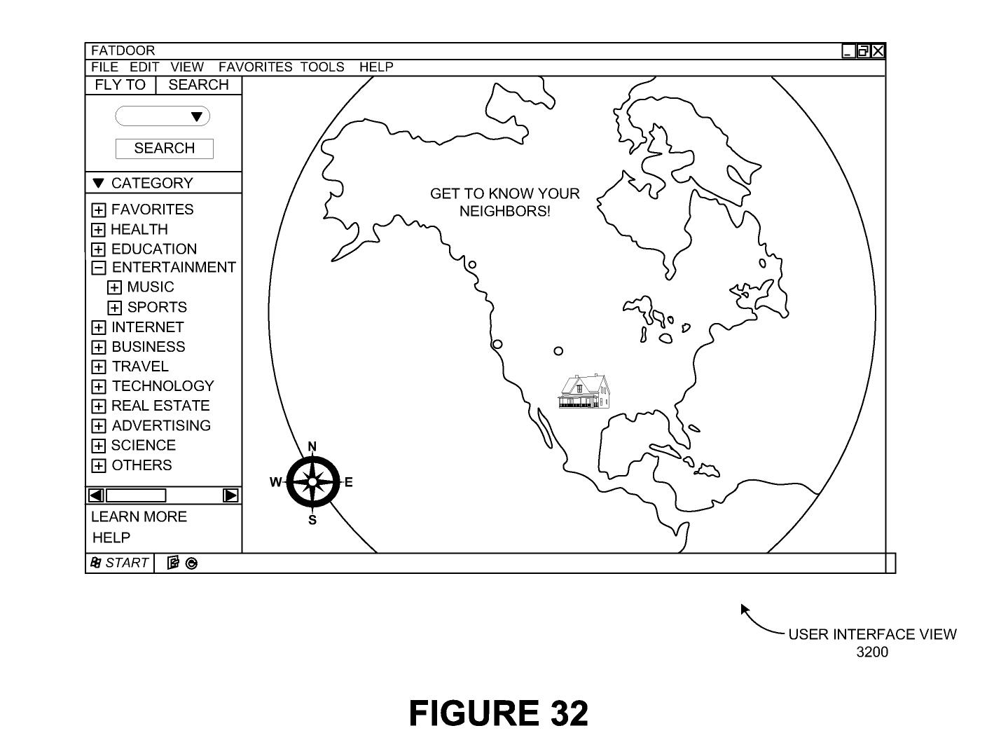

FIG. 32 is a user interface view 3200 showing a map, according to one embodiment. Particularly FIG. 32 illustrates a satellite photo of a physical world. The registered user of the global neighborhood environment (e.g., the global neighborhood environment 600 of FIG. 6) may use this for exploring the geographical location (e.g., the geographical location 1704 of FIG. 17A) of the neighbors (e.g., the neighbor 620 of FIG. 6). The registered user (e.g., the verified registered user 1810 of FIG. 18A-B, the verified registered user 1810 of FIG. 21) may navigate, zoom, explore and quickly find particular desired geographical locations of the desired neighbors (e.g., the neighbor 620 of FIG. 6). This may help the registered user to read the map and/or plot the route of the neighbors (e.g., the neighbor 620 of FIG. 6) on the world map.

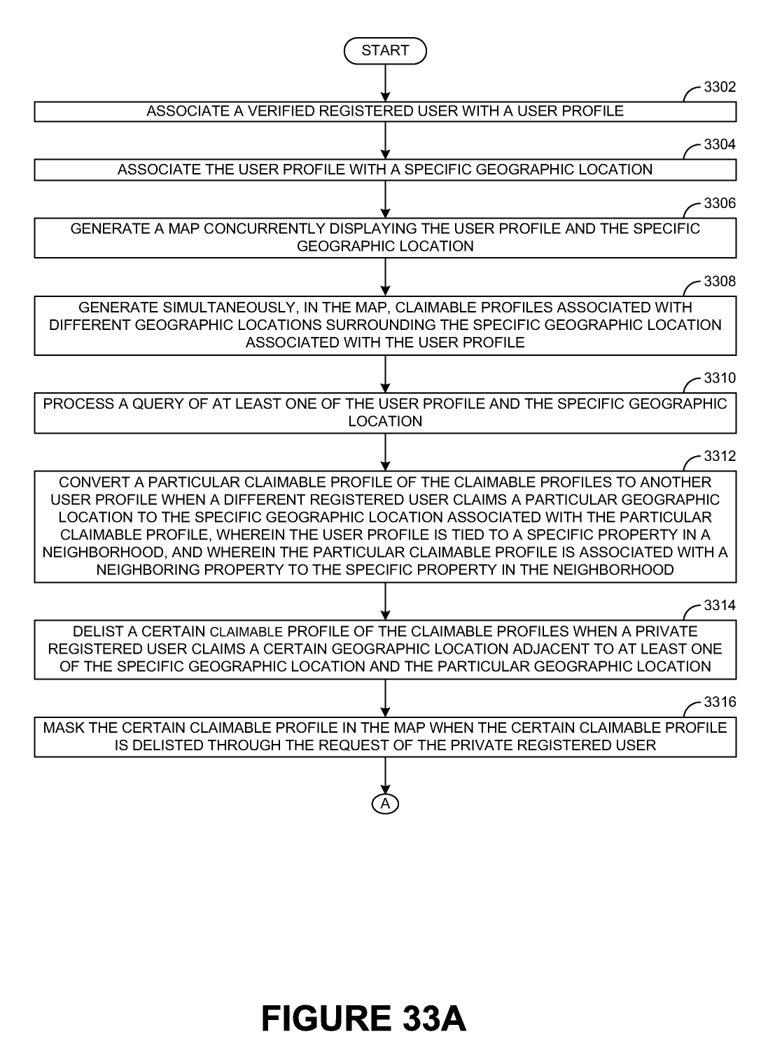

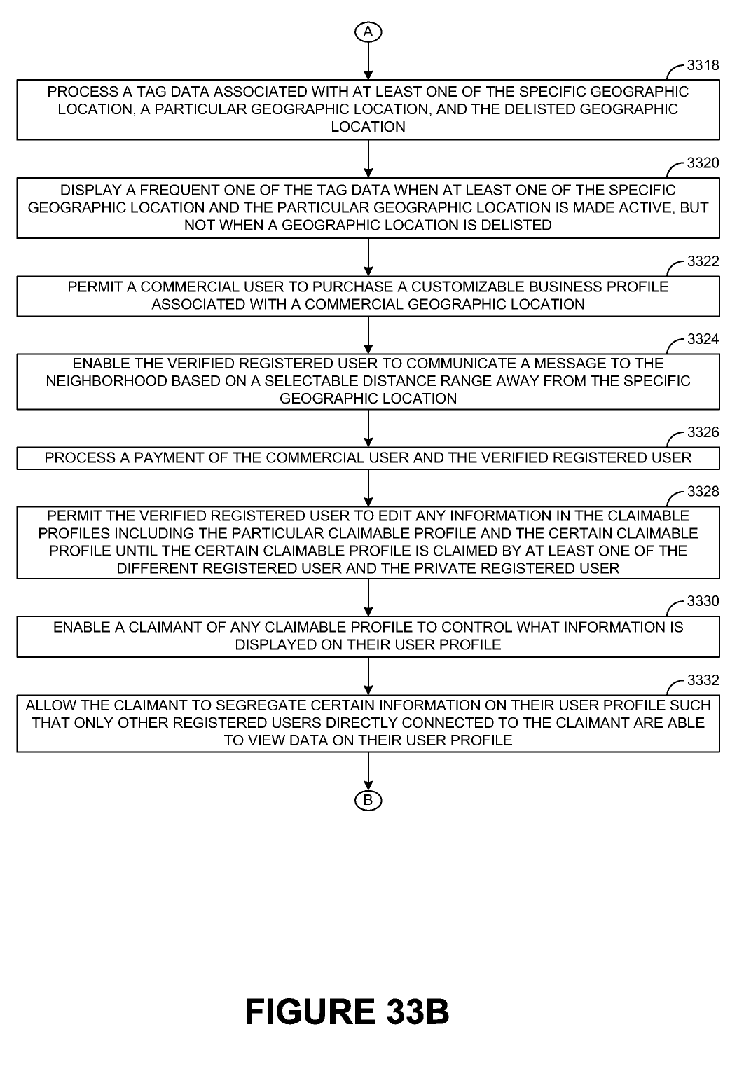

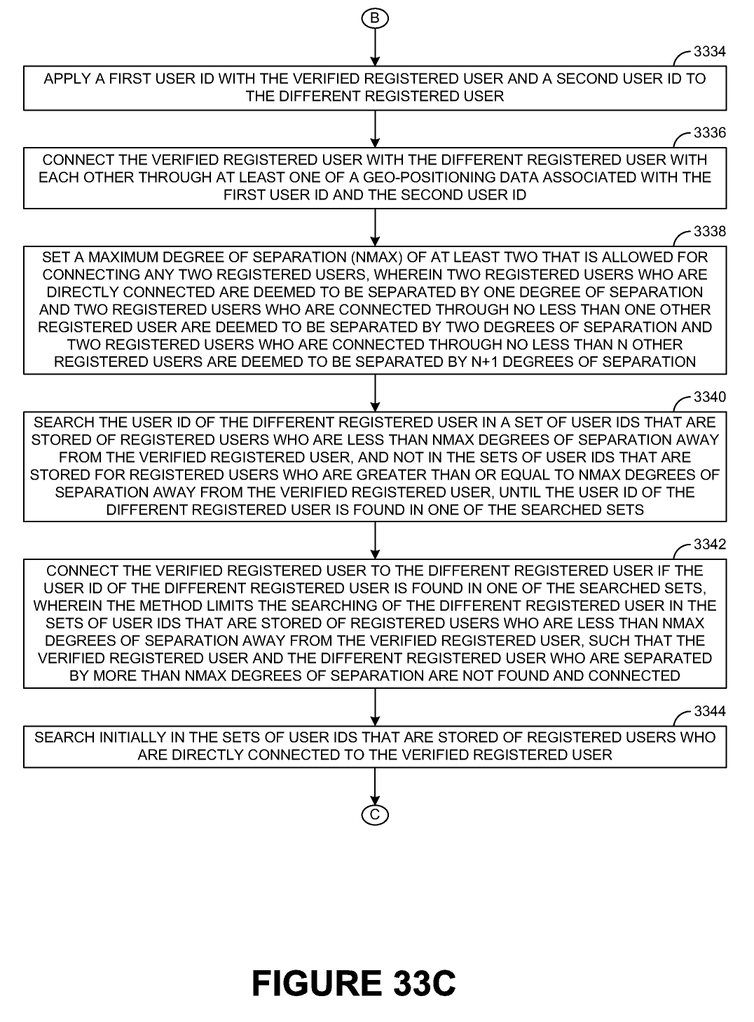

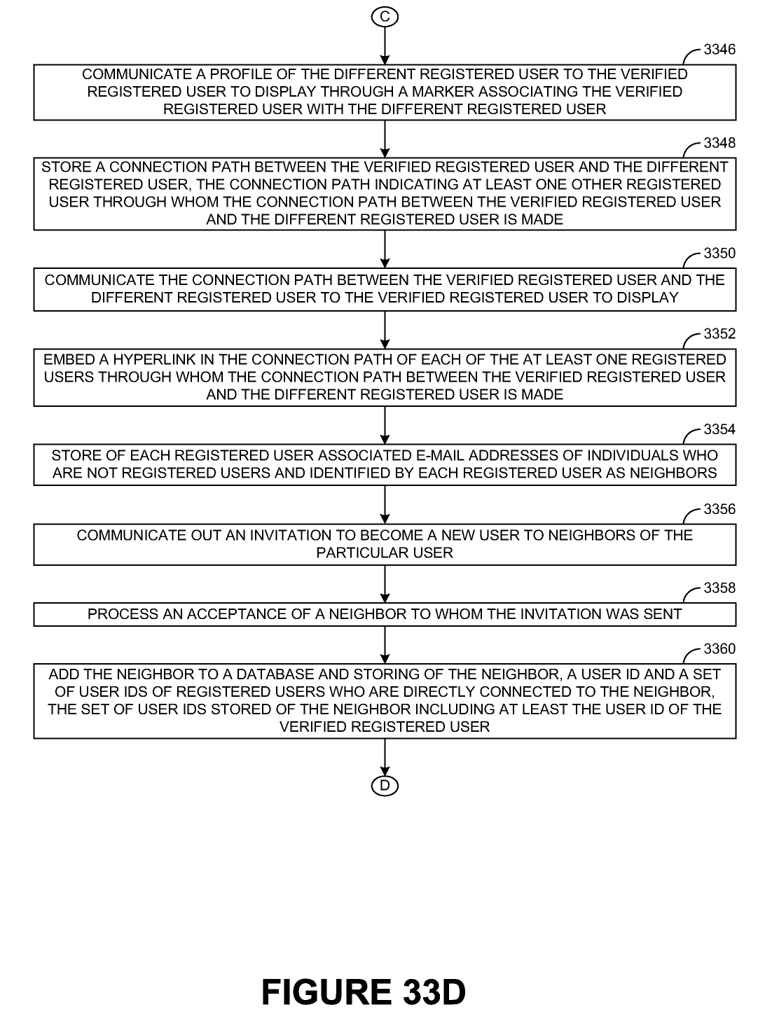

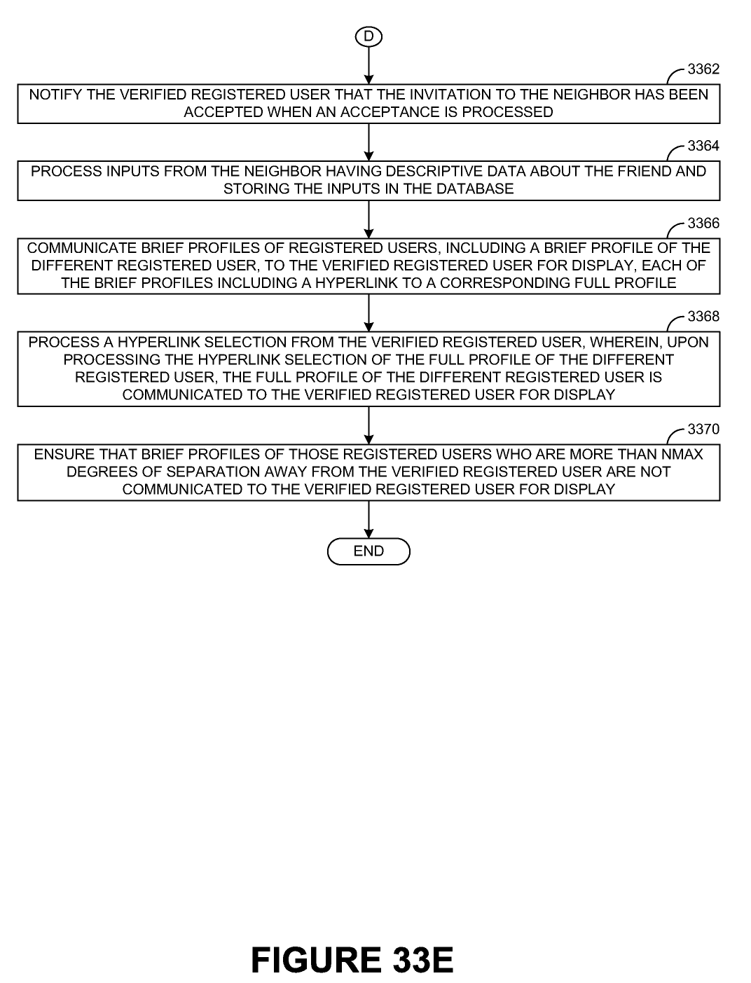

FIG. 33A is a process flow of searching map based community and neighborhood contribution, according to one embodiment. In operation 3302, a verified registered user (e.g., a verified registered user 1810 of FIG. 18A-18B, a verified registered user 1810 of FIG. 21) may be associated with a user profile (e.g., a user profile 1700 of FIG. 17A). In operation 3304, the user profile (e.g., the user profile 1700 of FIG. 17A) may be associated with a specific geographic location (e.g., a geographic location 1704 of FIG. 17A).

In operation 3306, a map (e.g., a map 1702 of FIG. 17A-17B, a map 1900 of FIG. 19, a map 2100 of FIG. 21, a map 2201 of FIG. 22) may be generated concurrently displaying the user profile (e.g., the user profile 1700 of FIG. 17A) and the specific geographic location (e.g., the geographic location 1704 of FIG. 17A). In operation, 3308, in the map, claimable profiles (e.g., a claimable profile 1706 of FIG. 17A-B, a claimable profile 1802 of FIG. 18A, a claimable profile 2204 of FIG. 22) associated with different geographic locations may be simultaneously generated surrounding the specific geographic location (e.g., the geographic location 1704 of FIG. 17A) associated with the user profile (e.g., the user profile 1700 of FIG. 17A).

In operation 3310, a query of at least one of the user profile (e.g., the user profile 1700 of FIG. 17A) and the specific geographic location (e.g., the geographic location 1704 of FIG. 17A) may be processed. In operation 3312, a particular claimable profile of the claimable profiles (e.g., the claimable profile 1706 of FIG. 17A-B, the claimable profile 1802 of FIG. 18A, the claimable profile 2204 of FIG. 22) may be converted to another user profile (e.g., the user profile 1700 of FIG. 17A) when a different registered user claims a particular geographic location to the specific geographic location (e.g., the geographic location 1704 of FIG. 17A) associated with the particular claimable profile (e.g., the claimable profile 1706 of FIG. 17A-B, the claimable profile 1802 of FIG. 18A, the claimable profile 2204 of FIG. 22), wherein the user profile (e.g., the user profile 1700 of FIG. 17A) may be tied to a specific property in a neighborhood (e.g., a neighborhood 602A-602N of FIG. 6), and wherein the particular claimable profile (e.g., the claimable profile 1706 of

FIG. 17A-17B, the claimable profile 1802 of FIG. 18A, the claimable profile 2204 of FIG. 22) may be associated with a neighboring property to the specific property in the neighborhood (e.g., the neighborhood 620A-620N of FIG. 6).

In operation 3314, a certain claimable profile (e.g., the claimable profile 1706 of FIG. 17A-17B, the claimable profile 1802 of FIG. 18A, the claimable profile 2204 of FIG. 22) of the claimable profiles (e.g., the claimable profile 1706 of FIG. 17A-B, the claimable profile 1802 of FIG. 18A, the claimable profile 2204 of FIG. 22) may be delisted when a private registered user claims a certain geographic location (e.g., the geographic location 1704 of FIG. 17A) adjacent to at least one of the specific geographic location and the particular geographic location (e.g., the geographic location 1704 of FIG. 17A).

In operation 3316, the certain claimable profile (e.g., the claimable profile 1706 of FIG. 17A-B, the claimable profile 1802 of FIG. 18A, the claimable profile 2204 of FIG. 22) in the map (e.g., the map 1702 of FIG. 17A-B, the map 1900 of FIG. 19, the map 2100 of FIG. 21, the map 2201 of FIG. 22) when the certain claimable profile may be delisted and/or be masked through the request of the private registered user.

FIG. 33B is a continuation of process flow of FIG. 33A showing additional processes, according to one embodiment. In operation 3318, a tag data associated with at least one of the specific geographic location, the particular geographic location (e.g., the geographic location 1704 of FIG. 17A), and the delisted geographic location may be processed. In operation 3320, a frequent one of the tag data may be displayed when at least one of the specific geographic location and the particular geographic location (e.g., the geographic location 1704 of FIG. 17A) may be made active, but not when the geographic location (e.g., the geographic location 1704 of FIG. 17A) may be delisted.

In operation 3322, a commercial user (e.g., a commercial user 1800 of FIG. 18A-B) may be permitted to purchase a customizable business profile (e.g., a customizable business profile 1804 of FIG. 18B) associated with a commercial geographic location. In operation 3324, the verified registered user (e.g., the verified registered user 1810 of FIG. 18A-B, the verified registered user 1810 of FIG. 21) to communicate a message to the neighborhood (e.g., the neighborhood 602A-602N of FIG. 6) may be enabled based on a selectable distance range away from the specific geographic location.

In operation 3326, a payment of the commercial user (e.g., the commercial user 1800 of FIG. 18A-B) and the verified registered user (e.g., the verified registered user 1810 of FIG. 18A-B, the verified registered user 1810 of FIG. 21) may be processed. In operation 3328, the verified registered user (e.g., the verified registered user 1810 of FIG. 18A-B, the verified registered user 1810 of FIG. 21) may be permitted to edit any information in the claimable profiles (e.g., the claimable profile 1706 of FIG. 17A-B, the claimable profile 1802 of FIG. 18A, the claimable profile 2204 of FIG. 22) including the particular claimable profile and the certain claimable profile until the certain claimable profile may be claimed by at least one of the different registered user and the private registered user.

In operation 3330, a claimant of any claimable profile (e.g., the claimable profile 1706 of FIG. 17A-B, the claimable profile 1802 of FIG. 18A, the claimable profile 2204 of FIG. 22) may be enabled to control what information is displayed on their user profile (e.g., the user profile 1700 of FIG. 17A). In operation 3332, the claimant to segregate certain information on their user profile (e.g., the user profile 1700 of FIG. 17A) may be allowed such that only other registered users directly connected to the claimant are able to view data on their user profile (e.g., the user profile 1700 of FIG. 17A).

FIG. 33C is a continuation of process flow of FIG. 33B showing additional processes, according to one embodiment. In operation 3334, a first user ID with the verified registered user (e.g., the verified registered user 1810 of FIG. 18A-B, the verified registered user 1810 of FIG. 21) and a second user ID to the different registered user may be applied. In operation 3336, the verified registered user (e.g., the verified registered user 1810 of FIG. 18A-B, the verified registered user 1810 of FIG. 21) with the different registered user with each other may be connected through at least one of Geo-positioning data associated with the first user ID and the second user ID.

In operation 3338, a maximum degree of separation (Nmax) of at least two may be set that is allowed for connecting any two registered users, wherein two registered users who are directly connected may be deemed to be separated by one degree of separation and two registered users who are connected through no less than one other registered user may be deemed to be separated by two degrees of separation and two registered users who may be connected through no less than N other registered users are deemed to be separated by N+1 degrees of separation. In operation 3340, the user ID of the different registered user may be searched in a set of user IDS that are stored of registered users who are less than Nmax degrees of separation away from the verified registered user (e.g., the verified registered user 1810 of FIG. 18A-B, the verified registered user 1810 of FIG. 21), and not in the sets of user IDS that may be stored for registered users who may be greater than or equal to Nmax degrees of separation away from the verified registered user (e.g., the verified registered user 1810 of FIG. 18A-B, the verified registered user 1810 of FIG. 21), until the user ID of the different registered user may be found in one of the searched sets.

In operation 3342, the verified registered user (e.g., the verified registered user 1810 of FIG. 18A-B, the verified registered user 1810 of FIG. 21) may be connected to the different registered user if the user ID of the different registered user may be found in one of the searched sets, wherein the method limits the searching of the different registered user in the sets of user IDS that may be stored of registered users who may be less than Nmax degrees of separation away from the verified registered user (e.g., the verified registered user 1810 of FIG. 18A-B, the verified registered user 1810 of FIG. 21), such that the verified registered user (e.g., the verified registered user 181 0 of FIG. 18A-B, the verified registered user 1810 of FIG. 21) and the different registered user who may be separated by more than Nmax degrees of separation are not found and connected. In operation 3344, initially in the sets of user IDS that are stored of registered users who may be directly connected to the verified registered user (e.g., the verified registered user 1810 of FIG. 18A-B, the verified registered user 1810 of FIG. 21) may be initially searched.

FIG. 33D is a continuation of process flow of FIG. 33C showing additional processes, according to one embodiment. In operation 3346, a profile of the different registered user to the verified registered user (e.g., the verified registered user 1810 of FIG. 18A-B, the verified registered user 1810 of FIG. 21) may display information that may be communicated through a marker associating the verified registered user (e.g., the verified registered user 1810 of FIG. 18A-B, the verified registered user 1810 of FIG. 21) with the different registered user.

In operation 3348, a connection path between the verified registered user (e.g., the verified registered user 1810 of FIG. 18A-B, the verified registered user 1810 of FIG. 21) and the different registered user, the connection path indicating at least one other registered user may be stored through whom the connection path between the verified registered user (e.g., the verified registered user 1810 of FIG. 18A-B, the verified registered user 1810 of FIG. 21) and the different registered user may be made.

In operation 3350, the connection path between the verified registered user (e.g., the verified registered user 1810 of FIG. 18A-B, the verified registered user 1810 of FIG. 21) and the different registered user to the verified registered user (e.g., the verified registered user 1810 of FIG. 18A-B, the verified registered user 1810 of FIG. 21) may be communicated to display.

In operation 3352, a hyperlink in the connection path of each of the at least one registered users may be embedded through whom the connection path between the verified registered user (e.g., the verified registered user 1810 of FIG. 18A-B, the verified registered user 1810 of FIG. 21) and the different registered user may be made. In operation 3354, each registered user associated e-mail addresses of individuals who are not registered users may be stored and identified by each registered user as neighbors (e.g., a neighbor 620 of FIG. 6).

In operation 3356, an invitation may be communicated to become a new user (e.g., a user 616 of FIG. 6) to neighbors (e.g., the neighbor 620 of FIG. 6) of the particular user. In operation 3358, an acceptance of the neighbor (e.g., the neighbor 620 of FIG. 6) to whom the invitation was sent may be processed. In operation 3360, the neighbor (e.g., the neighbor 620 of FIG. 6) to a database and storing of the neighbor (e.g., the neighbor 620 of FIG. 6), a user ID and the set of user IDS of registered users may be added who are directly connected to the neighbor (e.g., the neighbor 620 of FIG. 6), the set of user IDS stored of the neighbor (e.g., the neighbor 620 of FIG. 6) including at least the user ID of the verified registered user (e.g., the verified registered user 1810 of FIG. 18A-B, the verified registered user 1810 of FIG. 21).

FIG. 33E is a continuation of process flow of FIG. 33D showing additional processes, according to one embodiment. In operation 3362, the verified registered user (e.g., the verified registered user 1810 of FIG. 18A-B, the verified registered user 1810 of FIG. 21) that the invitation to the neighbor (e.g., the neighbor 620 of FIG. 6) has been accepted may be notified when the acceptance is processed.

In operation 3364, inputs from the neighbor (e.g., the neighbor 620 of FIG. 6) having descriptive data about the friend and storing the inputs in the database may be processed. In operation 3366, brief profiles of registered users, including a brief profile of the different registered user may be communicated, to the verified registered user (e.g., the verified registered user 1810 of FIG. 18A-B, the verified registered user 1810 of FIG. 21) for display, each of the brief profiles including the hyperlink to a corresponding full profile.

In operation 3368, the hyperlink selection from the verified registered user (e.g., the verified registered user 1810 of FIG. 18A-B, the verified registered user 1810 of FIG. 21) may be processed, wherein, upon processing the hyperlink selection of the full profile of the different registered user, the full profile of the different registered user is communicated to the verified registered user (e.g., the verified registered user 1810 of FIG. 18A-B, the verified registered user 1810 of FIG. 21) for display.

In operation 3370, brief profiles of those registered users who may be more than Nmax degrees of separation away from the verified registered user (e.g., the verified registered user 1810 of FIG. 18A-B, the verified registered user 1810 of FIG. 21) may not communicated to the verified registered user (e.g., the verified registered user 1810 of FIG. 18A-B, the verified registered user 1810 of FIG. 21) may be ensured for display.

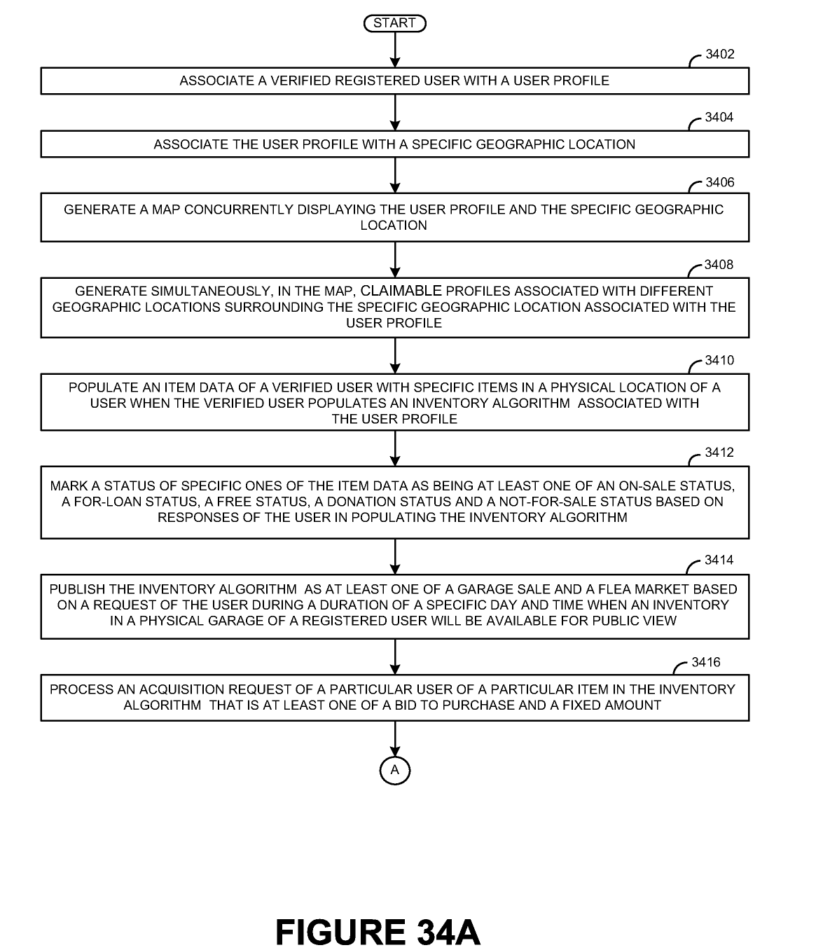

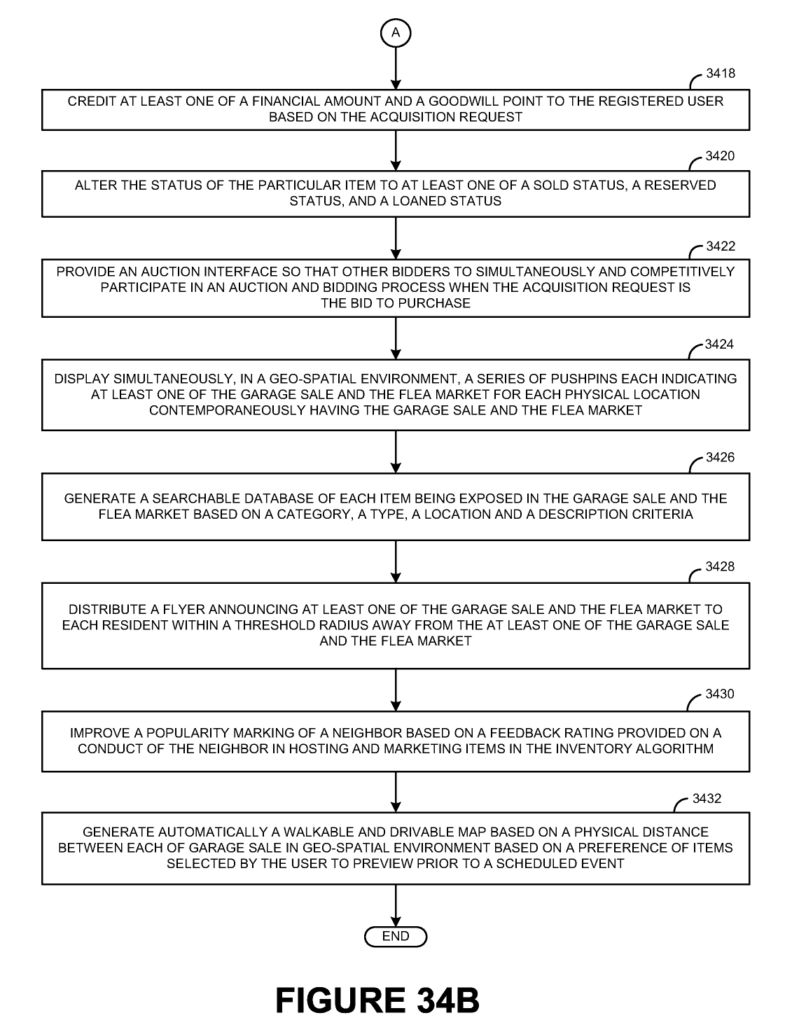

FIG. 34A is a process flow of garage sale and flea market in the geo-spatial environment, according to one embodiment. In operation 3402, a verified registered user (e.g., the user 416 of FIG. 4) may be associated with a user profile. In operation 3404, the user profile may be associated with a specific geographic location. In operation 3406, a map concurrently displaying the user profile and the specific geographic location may be generated. In operation 3408, claimable profiles associated with different geographic locations surrounding the specific geographic location associated with the user profile may be simultaneously generated in the map.

In operation 3410, an item data of a verified user may be populated with specific items in a physical location of a user when the verified user populates an inventory algorithm (e.g., the inventory algorithm 434 of FIG. 4) associated with the user profile. In operation 3412, a status of specific ones of the item data may be marked as being an on-sale status, a for-loan status, a free status, a donation status and/or a not-for-sale status based on responses of the user in populating the inventory algorithm.

In operation 3414, the inventory algorithm may be published (e.g., through the publish link 118 of FIG. 1) as a garage sale (e.g., the garage sale 202A-N of FIG. 2) and/or a flea market (e.g., the flea market 208 of FIG. 2) based on a request of the user (e.g., the user 416 of FIG. 4) during duration of a specific day and time when an inventory in a physical garage of a registered user will be available for public view. In operation 3416, an acquisition request of a particular user of a particular item may be processed (e.g., processed through acquisition algorithm 414 of FIG. 4) in the inventory algorithm that is a bid to purchase and/or a fixed amount.

FIG. 34B is a continuation of process flow of FIG. 34A showing additional processes, according to one embodiment. In operation 341 8, a financial amount and/or a goodwill point may be credited to the registered user based on the acquisition request. In operation 3420, the status of the particular item may be altered to any one of a sold status, a reserved status, and/or a loaned status. In operation 3422, an auction interface may be provided so that other bidders to simultaneously and/or competitively participate in an auction and bidding process when the acquisition request is the bid to purchase.

In operation 3424, a series of pushpins each indicating the garage sale and/or the flea market may be simultaneously displayed in a geo-spatial environment for each physical location contemporaneously having the garage sale and/or the flea market. In operation 3426, a searchable database of each item being exposed in the garage sale (e.g., the garage sale 202A-N of FIG. 2) and/or the flea market (e.g., the flea market 208 of FIG. 2) may be generated based on a category, a type, a location and/or a description criteria. In operation 3428, a flyer announcing the garage sale and/or the flea market may be distributed to each resident within a threshold radius away from the garage sale and/or the flea market.

In operation 3430, a popularity marking of a neighbor (e.g., the neighbor 420 of FIG. 4) may be improved based on a feedback rating provided on a conduct of the neighbor in hosting and marketing items in the inventory algorithm. In operation 3432, a walkable and/or drivable map may be generated automatically (e.g., generated automatically through map algorithm 200 of FIG. 2) based on a physical distance between each of garage sale in geo-spatial environment based on a preference of items selected by the user to preview prior to a scheduled event.

In one aspect, a method includes associating a verified registered user 1810 with a user profile 1700, associating the user profile 1700 with a specific geographic location, and generating a map concurrently displaying the user profile 1700 and the specific geographic location. Claimable profiles associated with different geographic locations surrounding the specific geographic location associated with the user profile 1700 are simultaneously generated in the map. An item data of a verified user is populated with specific items in a physical location of a user when the verified user populates an inventory algorithm 434 associated with the user profile 1700. The method includes marking a status of specific ones of the item data as being at least one of an on-sale status, a for-loan status, a free status, a donation status and a not-for-sale status based on responses of the user in populating the inventory algorithm 434, and publishing the inventory algorithm 434 as at least one of a garage sale 202 and a flea market 208 based on a request of the user during a duration of a specific day and time when an inventory in a physical garage of a registered user will be available for public view.

A flyer acquisition request of a particular user of a particular item in the inventory algorithm 434 that is at least one of a bid to purchase and/or a fixed amount may be processed. A financial amount and/or a goodwill point may be credited to the registered user based on the acquisition request. The status of the particular item may be alerted to a sold status, a reserved status, and/or a loaned status. An auction interface may be provided so that other bidders to simultaneously and/or competitively participate in an auction and/or bidding process when the acquisition request is the bid to purchase. A series of pushpins each indicating the garage sale 202 and/or the flea market 208 may be simultaneously displayed in a geospatial environment 300 for each physical location contemporaneously having the garage sale 202 and/or the flea market 208.

A searchable database of each item being exposed in the garage sale 202 and/or the flea market 208 may be generated based on a category, a type, a location and/or a description criteria. A flyer announcing the garage sale 202 and/or the flea market 208 may be distributed to each resident within a threshold radius away from the garage sale 202 and/or the flea market 208. The distributing the flyer may be conducted through an electronic communications and/or through a direct postal mail communication automatically generated based on a content, day and/or time of the one garage sale 202 and/or the flea market 208.

A popularity marking of a neighbor may be improved based on a feedback rating provided on a conduct of the neighbor in hosting and/or marketing items in the inventory algorithm 434. A walkable and/or drivable map may be automatically generated based on a physical distance between each of garage sale 202 in a geo-spatial environment based on a preference of items selected by the user to preview prior to a scheduled event. The method may be in a form of a machine-readable medium embodying a set of instructions that, when executed by a machine, causes the machine to perform the method.

In another aspect, a method includes associating a verified registered user 1810 with a user profile 1700, associating the user profile 1700 with a specific geographic location, generating a map concurrently displaying the user profile 1700 and/or the specific geographic location. Claimable profiles associated with different geographic locations surrounding the specific geographic location associated with the user profile 1700 are simultaneously generated in the map. An item data of a verified user with specific items may be populated in a physical location of a user when the verified user populates an inventory algorithm 434 associated with the user profile 1700. An acquisition request of a particular user of a particular item in the inventory algorithm 434 that is a bid to purchase and/or a fixed amount may be processed. A financial amount and/or a goodwill point may be credited to a registered user based on the acquisition request. A status of the particular item may be alerted to a sold status, a reserved status, and/or a loaned status.

The status of specific ones of the item data may be marked as being an on-sale status, a for-loan status, a free status, a donation status and/or a not-for-sale status based on responses of the user in populating the inventory algorithm 434. The inventory algorithm 434 may be published as a garage sale 202 and/or a flea market 208 based on a request of the user during a duration of a specific day and/or time when an inventory in a physical garage of the registered user will be available for public view. An auction interface may be provided so that other bidders to simultaneously and/or competitively participate in an auction and/or bidding process when the acquisition request is the bid to purchase. A series of pushpins each indicating at least one of the garage sale 202 and/or the flea market 208 for each physical location contemporaneously having the garage sale 202 and/or the flea market 208 may be simultaneously displayed in a geospatial environment 300.

A searchable database of each item being exposed in the garage sale 202 and/or the flea market 208 may be generated based on a category, a type, a location and/or a description criteria. A flyer announcing the garage sale 202 and/or the flea market 208 may be distributed to each resident within a threshold radius away from the garage sale 202 and/or the flea market 208. The distributing the flyer may be conducted through an electronic communications and/or through a direct postal mail communication automatically generated based on a content, day and/or time of the one garage sale 202 and/or the flea market 208. A popularity marking of a neighbor may be improved based on a feedback rating provided on a conduct of the neighbor in hosting and/or marketing items in the inventory algorithm 434. A walkable and/or drivable map may be automatically generated based on a physical distance between each of garage sale 202 in a geo-spatial environment based on a preference of items selected by the user to preview prior to a scheduled event. The method may be in a form of a machine-readable medium embodying a set of instructions that, when executed by a machine, causes the machine to perform the method.

In yet another aspect, a method includes associating a verified registered user 1810 with a user profile 1700, associating the user profile 1700 with a specific geographic location, and generating a map concurrently displaying the user profile 1700 and/or the specific geographic location. Claimable profiles associated with different geographic locations surrounding the specific geographic location associated with the user profile 1700 are simultaneously generated in the map. An item data of a verified user is populated with specific items in a physical location of a user when the verified user populates an inventory algorithm 434 associated with the user profile 1700. An acquisition request of a particular user of a particular item in the inventory algorithm 434 that is at least one of a bid to purchase and a fixed amount is processed. A status of the particular item is alerted to a sold status, a reserved status, and a loaned status. An auction interface is provided so that other bidders to simultaneously and competitively participate in an auction and bidding process when the acquisition request is the bid to purchase.

The status of specific ones of the item data may be marked as being an on-sale status, a for-loan status, a free status, a donation status and/or a not-for-sale status based on responses of the user in populating the inventory algorithm 434. The inventory algorithm 434 may be published as a garage sale 202 and/or a flea market 208 based on a request of the user during a duration of a specific day and/or time when an inventory in a physical garage of a registered user will be available for public view. A financial amount and/or a goodwill point may be credited to the registered user based on the acquisition request. A series of pushpins each indicating the garage sale 202 and/or the flea market 208 for each physical location contemporaneously having the garage sale 202 and/or the flea market 208 may be simultaneously displaying in a geospatial environment 300.

A searchable database may be generated of each item being exposed in the garage sale 202 and/or the flea market 208 based on a category, a type, a location and/or a description criteria. A flyer may be distributed announcing the garage sale 202 and/or the flea market 208 to each resident within a threshold radius away from the garage sale 202 and/or the flea market 208. The distributing the flyer may be conducted through an electronic communications and/or through a direct postal mail communication automatically generated based on a content, day and/or time of the garage sale 202 and/or the flea market 208. A popularity marking of a neighbor may be improved based on a feedback rating provided on a conduct of the neighbor in hosting and/or marketing items in the inventory algorithm 434. A walkable and/or drivable map may be automatically generated based on a physical distance between each of garage sale 202 in a geo-spatial environment based on a preference of items selected by the user to preview prior to a scheduled event. The method may be in a form of a machine-readable medium embodying a set of instructions that, when executed by a machine, causes the machine to perform the method.

An example embodiment will now be described. In one embodiment, Bob may amass a large quantity of items in his house. Bob may have no use for many of the items and/or may wish to sell the unneeded items. Bob may want to offer the items for sale to his neighbors and may want to have a garage sale and/or participate in a flea market. However, Bob may have trouble getting buyers to see his items for sale as his neighbors may not have knowledge of what items are for sale and may therefore not take the time to visit Bob's garage sale and/or flea market. Bob may be able to claim his profile on the global neighborhood environment 400 and/or populate an item data with specific items that Bob wishes to sell on the site (e.g., Fatdoor.com). Bob may publish items via the inventory algorithm and/or mark the items as for sale, for free, indicate a price, a condition, and/or other aspects of the item. Bob may be successful in selling his items as a result of the targeted publicity achieved through the site (e.g., Fatdoor.com). Bob's sale may be faster, easier, and/or more successful than it could have been through standard, less detailed advertising methods.

In another embodiment, Sara, a resident in Bob's neighborhood may be in need of a new toaster. She may not want to pay full price for a new toaster at a store and/or may not trust and/or have time to use other methods of attaining a used toaster (e.g., via Craigslist.com and/or Ebay.com). Sara may not want to purchase an appliance from a complete stranger. Sara may log onto her profile on the global neighborhood environment 400 and/or see that a sale (e.g., a garage sale and/or flea market) is occurring in her area. Sara may be able to view which items are for sale and at which prices. Sara may find that Bob is selling a toaster that is in good condition for a price that she can afford. Sara may be able to place a request for the item (e.g., an offer) directly on the site (e.g., Fatdoor.com) and/or contact Bob with further inquiries, and/or visit a physical sale to view the item. Sara may be able to procure a suitable toaster for a good price quickly and easily, avoiding needing to interact with strangers and/or wait for shipping.

The systems and methods described herein may also be applicable to other types of residential commerce. For example, estate sale may be a type of garage sale, yard sale and/or auction to dispose of the majority of the materials that may be owned by a deceased person. Estate sales may be usually conducted for a percentage of the take by specialists. This may be as the scope of the process may be usually overwhelming to the survivors, and for the specialist's experience with pricing antique items, his/her following of customers and/or the specialist's experience in disposing of unsold goods in an unsentimental manner after the run of the sale. Antique and collectible dealers may use estate sales as one of their more important wholesale sources and/or many estate sales have their first day reserved for dealers. Estate sales may be typically 3 to 4 days long with a price reduction toward the end. Unknowingly to the shopper, estate sales may be salted with goods left over from other sales and/or business ventures of the sale's conductor.

Where the survivors of the deceased may not agree to the disposition of tangible property, a court may order those goods to be sold in an estate sale with the proceeds to be divided between the survivors. Such a sale and division may also be mandated in the will of the deceased, and may be modeled in one or more of the embodiments disclosed herein.

Garage sale may be called as a yard sale and/or a tag sale. Garage sale may be an informal, irregularly scheduled marketplace of new and/or used household goods, typically sold by one and/or a few families. In some communities there may be designated days every year in which “block sales” may be allowed, so that people may not have to get the required permits and/or collect sales tax. Such events may be modeled in the neighborhood commerce geospatial environment as described in FIGS. 1-34b.

The goods in a garage sale may be unwanted items from the household conducting the sale. The goods may sometimes be new, like-new and/or just usable that may be offered for sale as the owner may not want and/or need the item, to minimize their possessions, and/or to raise funds. Popular motivations for a garage sale may be “Spring cleaning” and/or the owner's move to a new residence. The seller may display their wares to the passers-by, those responding to signs and/or newspaper ads. The sales venue may be usually the garage, the driveway, the front yard and/or porch. Some vendors, known as ‘squatters’, may set up in a highly trafficked area not on their own property.

Staples of garage sales may include old clothing, books, toys, household knickknacks, and board games. Larger items like furniture and/or occasionally appliances may be sold. Garage sales may occur most frequently in suburban areas on good-weather weekends, and/or may have designated hours for the sale. Sometimes, buyers may arrive before the hours of the sale to review the items. These buyers may be known as “Early Birds”, and/or are often professional restorers and/or resellers. Such sales may attract people who may be searching for bargains and/or for rare and/or unusual items. Bargaining on prices may be routine and/or an items may or may not have price labels affixed. Some people may buy goods from these sales to restore them for resale.

For example, some cities, such as Beverly Hills, Calif. may require that the homeowners apply and/or pay for a yard sale permit and/or even with those homeowners in Beverly Hills may only hold yard sales in the back of their homes. Such a process may be automated in the methods and systems disclosed herein. In some areas garage sales may have taken on a special meaning to a community and/or may have become events of special local significance. In these situations large areas of a community may hold a communal garage sale involving several families at the same time may be modeled in one or more of the embodiments disclosed herein, particularly in the embodiments of FIGS. 1-6. For example, the Great Glebe Garage Sale may be held every spring in The Glebe a district of Ottawa, Canada and the Hwy 127 Corridor Sale which may be held over 450 miles of Highway 127 in Jamestown, Tenn. These garage sales may be a part of local tradition and culture and attract thousands of shoppers for the event.

A Jumble sale or rummage sale may be a sale of second hand goods by an institution such as the local Scout Group and/or church, as a fundraising effort. They may typically ask local people to donate goods, which may be set out on tables in the same manner as car boot sales and/or sold to members of the general public, who may have paid a fee to enter the sale. Typically in the UK the entry fee may be somewhere between fifty pence and one pound fifty. (e.g., Rummage sales in the United States may generally do not charge an entrance fee, but may place a small jar near the cash register to collect additional donations.) Fundraising simulations may also be modeled in the various embodiments illustrated in FIGS. 1-34.

Jumble Sales in some countries (e.g., Britain) may have a reputation for being somewhat like a rugby scrum as people jostle for bargains. Jumble Sales may be becoming less prevalent in the UK, as car boot sales and/or the internet enable people to sell their unwanted goods rather than donate them to charity.

Car boot sales may be mainly British form of market in which private individuals may come together to sell household and/or garden goods. Although a small proportion of sellers may be professional traders selling new goods and/or seconds, the goods on sale may be often used and no longer wanted personal possession. Car boot sales may be a way of focusing a large group of people in one place to recycle useful but unwanted domestic items that previously may have been thrown away. In U.S. terms, a car boot sale may be considered somewhere between a garage sale and a swap meet. Though garage sales may be not unknown in the UK, car boot sales may be much more popular. Each one of these scenarios may also be modeled in the various embodiments illustrated in FIGS. 1-34.

They may be held in the grounds of schools, other community buildings, in grassy fields and/or car parks. They may take place on weekend mornings. Sellers may pay a nominal fee for their pitch and arrive with their goods in the boot (trunk) of their car. The items may then be unpacked onto folding trestle tables, a blanket, tarpaulin and/or simply on the ground. Entry to the general public may be sometimes free and/or sometimes a small charge may be made. Advertised opening times may often not strictly adhered to, and in many cases the nature of the venue itself may make it impossible to prevent keen bargain hunters from wandering in as soon as the first stallholders arrive.

Car boot sales may be used to sell unwanted household goods, ranging from old books, records, videos, toys, stamps, coins, through to radios, old computers, ornaments, tools, clocks, furniture, kitchenware and/or clothes. However, a number of commercial sellers may often make an appearance, selling plants, vegetables or new goods such as tools, toys, batteries, ornaments and fittings, paper, pens and/or stationery. Everything may be sold at a small fraction of the new price ranging from 10 p to 50 p for books, through to several pounds for the most expensive items. Haggling may be common at car boots.

Flea market, also known as a swap meet in the USA, may be a place where vendors come to sell and/or trade their goods. The goods may be usually inexpensive and/or range in quality depending on several factors which might include urban or rural location, part of the country and/or popularity/size of the flea market. Flea market shopping may be a popular pastime for many people in the Western world. The car boot sale may be similar to a flea market, but may be more popular in the United Kingdom.

The vast majority of flea markets in rural areas may sell goods that may be second hand. Larger selections of newer but inexpensive items may be found at some of the larger and/or more urban flea markets. They may also have sometime been used as an outlet for bootleg movies, music and/or counterfeit goods. The semi-spontaneous nature and/or vendor-oriented open-market layouts of flea markets may usually differentiate them from thrift stores. Some flea markets may offer concerts and/or carnival-type events to attract shoppers. Flea markets as described in various forms here may also be modeled in the various embodiments illustrated in FIGS. 1-34 and as described above

Flea markets may have analogous specialty counterparts in gun shows and hamfests, both of which may offer plenty of new merchandise as well as used goods for gun and/or ham radio enthusiasts. Like the general flea markets, gun shows and/or hamfests offer surplus goods.

Many television shows (starting in the late 1990s) focus on the appraisal of second hand goods often found at flea markets that may be worth far more than the buyer paid. In the United States the most popular of these shows may be Antiques Roadshow. The original flea market may likely to be the March6 aux puces of Saint-Ouen, Seine-Saint-Denis, in the northern suburbs of Paris. It may be a large, long-established outdoor bazaar, one of four in Paris. They might have earned their name from the flea-infested clothing and rags sold there. From the late 17th century, the makeshift open-air market in the town of Saint-Ouen might have begun as temporary stalls and/or benches among the fields and/or market gardens where ragpickers exchanged their findings for a small sum.

The other Paris Flea market may be Marche aux Puces de la Porte de Vanves. It retains its original charm and originality. A large selection of goods awaits on the sidewalks of the avenues of Marc Sangnier and Georges Lafenestre in the fourteenth arrondissement. In modern days the largest “flea market” for antiques may be still that at Saint-Ouen. In the United States, a popular monthly flea market may be First Monday Trade Days held in Canton, Tex., east of the Dallas-Fort Worth Metroplex. Flea Market Montgomery may have recently gained frame for the advertisements of owner Sammy Stephens and his subsequent appearance on Ellen.

The garage sale builder algorithm 100, the map algorithm 200, the search algorithm 408, the claimable algorithm 410, the popularity algorithm 412, the acquisition algorithm 414, the status algorithm 430, the map algorithm 432, the inventory algorithm 434, the credit algorithm 436, the loan algorithm 438, the flyer algorithm 440, the radius algorithm 444, the free/donation algorithm 446, the social community algorithm 606, the search algorithm 608, the claimable algorithm 610, the commerce algorithm 612, the map algorithm 61 4, the building builder algorithm 700, the N′ ˜de gree algorithm 702, the tagging algorithm 704, the verify algorithm 706, the groups generator algorithm 708, the map algorithm 71 0, the profile algorithm 71 2, the announce algorithm 714, the friend finder algorithm 722, the neighbor-neighbor help algorithm 724, the business search algorithm 802, the communicate algorithm 806, the directory assistance algorithm 808, the embedding algorithm 8 10, the no-match algorithm 8 12, the range selector algorithm 814, the user-place claimable algorithm 900, the user-user claimable algorithm 902, the user-neighbor claimable algorithm 904, the user-business claimable algorithm 906, the reviews algorithm 908, the defamation prevention algorithm 910, the claimable social network conversion algorithm 912, the claim algorithm 914, the data segment algorithm 916, the dispute resolution algorithm 91 8, the resident announce payment algorithm 1000, the business display advertisement algorithm 1002, the geo-position advertisement ranking algorithm 1004, the content syndication algorithm 1006, the text advertisement algorithm 1008, the community market place algorithm 1010, the click-in tracking algorithm 1012, the satellite data algorithm 1100, the cartoon map converter algorithm 1104, the profile pointer algorithm 1106, the parcel algorithm 1108 and the occupant algorithm 1110 of FIGS. 1-34 may be embodied through the garage sale builder circuit, the map circuit, the search circuit, the claimable circuit, the popularity circuit, the acquisition circuit, the status circuit, the pushpin circuit, the inventory circuit, the credit circuit, the loan circuit, the flyer circuit, the rummage circuit, the free/donation circuit, the social community circuit, the search circuit, the claimable circuit, the commerce circuit, the map circuit, the building builder circuit, the N′ ˜degree circuit, the tagging circuit, the verify circuit, the groups circuit, the pushpin circuit, the profile circuit, the announce circuit, the friends finder circuit, the neighbor-neighbor help circuit, the business search circuit, the communicate circuit, the embedding circuit, the no-match circuit, the range selector circuit, the user-place claimable circuit, the user-user claimable circuit, the user-neighbor claimable circuit, the user-business circuit, the reviews circuit, the defamation prevention circuit, the claimable social network conversion circuit, the claim circuit, the data segment circuit, the dispute resolution circuit, the resident announce payment circuit, the business display advertisement circuit, the geo-position advertisement ranking circuit, the content syndication circuit, the text advertisement circuit, the community market place circuit, the click-in tracking circuit, the satellite data circuit, the cartoon map converter circuit, the profile pointer circuit, the parcel circuit, the occupant circuit using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
associating a verified registered user with a user profile in a constrained online neighborhood community network that verifies all addresses of users;
permitting the verified registered user to mark their profile as private;
associating the user profile with a specific geographic location;
marking a status of specific ones of the item data as being at least one of an on-sale status, a for-loan status, a free status, a donation status and a not-for-sale status based on responses of the user in populating an inventory database; and
publishing the inventory database based on a request of the user during a duration of a specific day and time when an inventory is marketable.

2. The method of claim 1 further comprising:
generating a map concurrently displaying the user profile and the specific geographic location;
simultaneously generating, in the map, claimable profiles associated with different geographic locations surrounding the specific geographic location associated with the user profile;
populating an item data of a verified user with specific items in a physical location of a user when the verified user populates an inventory algorithm associated with the user profile;
processing an flyer acquisition request of a particular user of a particular item in the inventory algorithm that is at least one of a bid to purchase and a fixed amount;
crediting at least one a financial amount and a goodwill point to the registered user based on the acquisition request;
altering the status of the particular item to at least one of a sold status, a reserved status, and a loaned status; and
providing an auction interface so that other bidders to simultaneously and competitively participate in an auction and bidding process when the acquisition request is the bid to purchase.

3. The method of claim 1 further comprising simultaneously displaying, in a geospatial environment, a series of pushpins each indicating at least one of the garage sale and the flea market for each physical location contemporaneously having the garage sale and the flea market.

4. The method of claim 3 further comprising generating a searchable database of each item being exposed in the garage sale and the flea market based on a category, a type, a location and a description criteria.

5. The method of claim 4 further comprising distributing a flyer announcing at least one of the garage sale and the flea market to each resident within a threshold radius away from the at least one of the garage sale and the flea market, wherein the distributing the flyer is conducted through an electronic communications and/or through a direct postal mail communication automatically generated based on a content, day and time of the at least one garage sale and the flea market.

6. The method of claim 1 further comprising:
improving a popularity marking of a neighbor based on a feedback rating provided on a conduct of the neighbor in hosting and marketing items in the inventory algorithm; and
automatically generating a walkable and drivable map based on a physical distance between each of garage sale in a geo-spatial environment based on a preference of items selected by the user to preview prior to a scheduled event.

7. The method of claim 1 in a form of a machine-readable medium embodying a set of instructions that, when executed by a machine, causes the machine to perform the method of claim 1.

8. A method, comprising:
associating a verified registered user with a user profile;
associating the user profile with a specific geographic location;
generating a map concurrently displaying the user profile and the specific geographic location;
simultaneously generating, in the map, claimable profiles associated with different geographic locations surrounding the specific geographic location associated with the user profile;
populating an item data of a verified user with specific items in a physical location of a user when the verified user populates an inventory algorithm associated with the user profile;
processing an acquisition request of a particular user of a particular item in the inventory algorithm that is at least one of a bid to purchase and a fixed amount;
crediting at least one a financial amount and a goodwill point to a registered user based on the acquisition request; and
altering a status of the particular item to at least one of a sold status, a reserved status, and a loaned status.

9. The method of claim 8 further comprising:
marking the status of specific ones of the item data as being at least one of an on-sale status, a for-loan status, a free status, a donation status and a not-for-sale status based on responses of the user in populating the inventory algorithm; and
publishing the inventory algorithm as at least one of a garage sale and a flea market based on a request of the user during a duration of a specific day and time when an inventory in a physical garage of the registered user will be available for public view; and
providing an auction interface so that other bidders to simultaneously and competitively participate in an auction and bidding process when the acquisition request is the bid to purchase.

10. The method of claim 9 further comprising simultaneously displaying, in a geospatial environment, a series of pushpins each indicating at least one of the garage sale and the flea market for each physical location contemporaneously having the garage sale and the flea market.

11. The method of claim 10 further comprising generating a searchable database of each item being exposed in the garage sale and the flea market based on a category, a type, a location and a description criteria.

12. The method of claim 11 further comprising distributing a flyer announcing at least one of the garage sale and the flea market to each resident within a threshold radius away from the at least one of the garage sale and the flea market, wherein the distributing the flyer is conducted through an electronic communications and/or through a direct postal mail communication automatically generated based on a content, day and time of the at least one garage sale and the flea market.

13. The method of claim 8 further comprising:
improving a popularity marking of a neighbor based on a feedback rating provided on a conduct of the neighbor in hosting and marketing items in the inventory algorithm; and
automatically generating a walkable and drivable map based on a physical distance between each of garage sale in a geo-spatial environment based on a preference of items selected by the user to preview prior to a scheduled event.

14. The method of claim 8 in a form of a machine-readable medium embodying a set of instructions that, when executed by a machine, causes the machine to perform the method of claim 8.

15. A method, comprising:
associating a verified registered user with a user profile;
associating the user profile with a specific geographic location;
generating a map concurrently displaying the user profile and the specific geographic location;
simultaneously generating, in the map, claimable profiles associated with different geographic locations surrounding the specific geographic location associated with the user profile;
populating an item data of a verified user with specific items in a physical location of a user when the verified user populates an inventory algorithm associated with the user profile;
processing an acquisition request of a particular user of a particular item in the inventory algorithm that is at least one of a bid to purchase and a fixed amount;
altering a status of the particular item to at least one of a sold status, a reserved status, and a loaned status; and
providing an auction interface so that other bidders to simultaneously and competitively participate in an auction and bidding process when the acquisition request is the bid to purchase.

16. The method of claim 15 further comprising:
marking the status of specific ones of the item data as being at least one of an on-sale status, a for-loan status, a free status, a donation status and a not-for-sale status based on responses of the user in populating the inventory algorithm; and
publishing the inventory algorithm as at least one of a garage sale and a flea market based on a request of the user during a duration of a specific day and time when an inventory in a physical garage of a registered user will be available for public view; and
crediting at least one a financial amount and a goodwill point to the registered user based on the acquisition request.

17. The method of claim 16 further comprising simultaneously displaying, in a geospatial environment, a series of pushpins each indicating at least one of the garage sale and the flea market for each physical location contemporaneously having the garage sale and the flea market.

18. The method of claim 17 further comprising:
generating a searchable database of each item being exposed in the garage sale and the flea market based on a category, a type, a location and a description criteria; and
distributing a flyer announcing at least one of the garage sale and the flea market to each resident within a threshold radius away from the at least one of the garage sale and the flea market, wherein the distributing the flyer is conducted through an electronic communications and/or through a direct postal mail communication automatically generated based on a content, day and time of the at least one garage sale and the flea market.

19. The method of claim 18 further comprising:
improving a popularity marking of a neighbor based on a feedback rating provided on a conduct of the neighbor in hosting and marketing items in the inventory algorithm; and
automatically generating a walkable and drivable map based on a physical distance between each of garage sale in a geo-spatial environment based on a preference of items selected by the user to preview prior to a scheduled event.

20. The method of claim 15 in a form of a machine-readable medium embodying a set of instructions that, when executed by a machine, causes the machine to perform the method of claim 15.
